(19) United States
(12) Patent Application Publication
(10) Pub. No.: US 2023/0180810 A1
(43) Pub. Date: Jun. 15, 2023

(54) DOSAGE FORMS AND METHODS OF PREPARATION AND USE THEREOF

(71) Applicant: Willow Bark Brands, Inc., New York, NY (US)

(72) Inventor: Eric R. First, Morristown, NJ (US)

(21) Appl. No.: 18/079,816

(22) Filed: Dec. 12, 2022

Related U.S. Application Data
(60) Provisional application No. 63/288,628, filed on Dec. 12, 2021.

(51) Int. Cl. A23L 33/115; A23L 33/105; A23L 33/15; A23L 31/15

(52) U.S. Cl. CPC A23L 33/115; A23L 33/105; A23L 33/15; A23L 31/15

(57) ABSTRACT

Disclosed herein are embodiments of stress eating dosage forms and foods, stressed gut dosage forms and foods, and methods of preparation and use thereof. Stress eating dosage forms and foods can include at least one sensory disrupter including an aromatic oil and at least one functional food, including one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof.

### FIELD

Disclosed herein are dosage forms, functional foods, dietary supplements and methods of preparation and use thereof. The formulations and methods of use described herein help regulate a human body's response to stress, which can reduce stress-eating.

### BACKGROUND

There are many treatments for stress and anxiety including the use of benzodiazepines, anti-depressants and various herbs. However, prolonged use of benzodiazepines can lead to dependence, as well as unwanted effects such as drowsiness and foggy thinking. Anti-depressants may be helpful to some people to help stress and anxiety, but they are specifically intended for depression. Some anti-depressants, such as Selective Serotonin Reuptake Inhibitors (SSRIs) can have adverse effects such as agitation, weight gain and other side-effects. Various herbal supplements have been reported to modulate stress and anxiety; however, the intended targets typically include one or more targets within the central nervous system (CNS).

Experts have known about the effects of stress on the body and its impact on the immune system for some time, but recently researchers have been looking more deeply into what happens in the brain to cause stress, and the brain's function during a period of stress. Inflammation can damage the brain, just as it can damage other organs and systems, and studies have previously linked chronic stress to a higher risk of dementia and Alzheimer's in addition to anxiety and other mood disorders.

Stress can also impact how the brain functions. When an individual is in “fight-or-flight mode,” more energy, nutrients, and resources are funneled to parts of the brain associated with survival and dealing with threats. Meanwhile, other areas, including those responsible for creating memories and high-level cognitive processing, receive the bare minimum. If stuck in that survival mode long-term, the brain may actually rewire. A recent study in the journal Neurology reported on how damaging to the brain chronic stress can be. It examined cortisol levels, brain size and structure, plus memory and cognitive functioning in more than 2,000 people in their 40s and 50s. The researchers found that those with higher levels of cortisol in their systems had smaller brains, and they also scored worse on memory and cognitive tests—even though none of the participants exhibited noticeable symptoms of cognitive decline or memory problems. More specifically, changes and damage were seen in parts of the brain that move information between the right and left hemispheres as well as areas associated with thought, speech, emotion, and muscle function.

Stress also can lead to stress-eating. People sometimes eat to satisfy true hunger, that is, to fulfill a physical need to eat and survive. At other times, when a person stress-eats, s/he eats to satisfy an appetite, or a desire for a particular type of food, because the brain “believes” it will provide relief. This is a psychological or emotional phenomenon, that is, a need that generally has nothing to do with actual hunger. Emotional hunger, for example, is a driving response to overwhelming feelings and emotions. From one's own personal experience, comfort foods—those that mentally bring back a carefree time of childhood, and are often high in sugar, fat, salt or both—are what emotional overeaters usually crave when tensions rise, especially sugar. Psychological stress and “reward eating” are characterized by a lack of control over the types and amount of food eaten.

These findings indicate that a high-stress life can lead to unhealthy behavior such as stress-eating. Without being bound by any particular theory, it is believed that breaking a person's stress cycle can lead to more healthy behaviors such as a reduction in stress-eating.

### BRIEF DESCRIPTION OF DRAWINGS

The figures are not necessarily to scale, emphasis instead generally being placed upon illustrative principles. The figures are to be considered illustrative in all aspects and are not intended to limit the disclosure, the scope of which is defined only by the claims.

FIG. 1 illustratively depicts a flowchart of a typical stress response in a human being.

FIG. 2 illustratively depicts a flowchart of the stress-eating process.

FIG. 3A illustratively depicts a dosage form according to embodiments herein.

FIG. 3B illustratively depicts kit according to embodiments herein.

FIG. 4 illustratively depicts a flowchart showing the mediation of stress in the body upon administration of a dosage form and/or kit according to embodiments herein.

FIG. 5 illustratively depicts a flowchart showing the synergistic combination of effects from dosage forms and kits according to embodiments herein.

FIG. 6 illustratively depicts the homeostasis balance in the body.

### BRIEF SUMMARY

Disclosed herein are embodiments of stress eating dosage forms, stress eating foods and stressed gut dosage forms, comprising: at least one sensory disrupter comprising an aromatic oil; and at least one functional food, comprising one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof.

In some embodiments, disclosed herein are stress eating foods, comprising: at least one sensory disrupter comprising an aromatic oil; and at least one functional food, comprising one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof, wherein the stress eating food is in the form of at least one of a taffy, granulation, gummy, chip, ball, cookie, square, brownie, layered pyramid, meal replacement shake or bar, sachet, tea, extrusion, or combination thereof.

According to one or more embodiments, further disclosed herein are stressed gut multi-part capsule dosage form, comprising: a liquid phase comprising at least one of beta caryophyllene, peppermint oil, flaxseed oil, organic grape seed oil, extracts thereof, or combinations thereof; and a solid phase comprising at least one of valerian root extract, licorice extract, mushroom, ginger root extract, microcrystalline cellulose, magnesium stearate, extracts thereof, or combinations thereof, optionally, wherein the mushroom comprises a blend of Ganoderma lucidum, Trametes versicolor, Inonotus obliquus, Lentinula edodes, maitake, lions mane, shiitake, oyster, cinnamon caps, reishi, portabello, turkey tail, Royal Sun Blazei, chaga, mesima, dried plant parts or matter thereof, extracts thereof or combinations thereof.

### Definitions

In describing the present disclosure, the following terms are to be used as indicated below. As used herein, the singular forms “a,” “an,” and “the” include plural references unless the context clearly indicates otherwise. Thus, for example, reference to “an active agent” includes a single active agent as well as a mixture of two or more different active agents, and reference to “a resin” includes a single resin as well as a mixture of two or more different resins, and the like.

The use of the terms “include,” “includes,” “including,” “have,” “has,” or “having” should be generally understood as open-ended and non-limiting unless specifically stated otherwise.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything higher than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

As used herein, the terms “component,” “ingredient,” “active agent,” “active ingredient,” “pharmaceutical agent,” and “drug” refer to any material that is intended to produce a therapeutic, prophylactic, and/or other intended effect to a human in need thereof, whether or not approved by a government agency for that purpose. These terms with respect to specific agents include all active forms of the agent, including the free base form of the agent, and all pharmaceutically acceptable salts, complexes, stereoisomers, crystalline forms, co-crystals, ether, esters, hydrates, solvates, prodrugs and mixtures thereof, where the form is active.

For purposes of this disclosure, “pharmaceutically acceptable salts” include, but are not limited to, inorganic acid salts such as hydrochloride, hydrobromide, sulfate, phosphate and the like; organic acid salts such as formate, acetate, trifluoroacetate, maleate, tartrate and the like; sulfonates such as methanesulfonate, benzenesulfonate, p-toluenesulfonate and the like; amino acid salts such as arginate, asparaginate, glutamate and the like; metal salts such as sodium salt, potassium salt, cesium salt and the like; alkaline earth metals such as calcium salt, magnesium salt and the like; and organic amine salts such as triethylamine salt, pyridine salt, picoline salt, ethanolamine salt, triethanolamine salt, discyclohexylamine salt, N,N′-dibenzylethylenediamine salt and the like.

The terms “controlled-release,” “extended-release” or “sustained release” are interchangeable and are defined for purposes of the present disclosure as the release of one or more component (e.g., a sensory disrupter, a stress buster, a calming reliever, etc.) at such a rate that blood (e.g., plasma) concentrations are maintained within the therapeutic range, but below toxic concentrations, over a period of time of at least about 1 hour or longer, at least about 2 hours or longer, at least about 3 hours or longer, at least about 4 hours or longer, at least about 5 hours or longer, or at least about 6 hours or longer, or at least about 10 hours or longer, or at least about 12 hours or longer or at least about 24 hours or longer.

The term “immediate release” is defined for the purposes of the present disclosure as the release of one or more component (e.g., a sensory disrupter, a stress buster, a calming reliever, etc.) into the air, mouth or in the gastrointestinal contents with no delay or prolongation of dissolution or absorption, smell or taste of the one or more component.

A “functional food” as used herein refers to a naturally occurring food or a mildly processed form thereof, for example, an extract, a dried material, an oil, etc. Functional foods include, but are not limited to, fruits, vegetables, plant-based oils, nuts, nut oils, seeds, seed oils, syrups (e.g., maple syrup, honey, molasses, agave, sucralose, etc.), butters (e.g., nut butters, plant butters), grains, pseudo grains, mushrooms, herbs, spices, acids, binders, natural excipients and/or combinations thereof.

A “functional food product” is a food that is created by modifying traditional food via agricultural, enzymatic, chemical, and/or technological means. An example of this is orange juice with extra pulp that helps maintain gastro-intestinal health by increasing fiber consumption and promoting growth of beneficial bacteria in the colon. Overall, foods are considered functional if they contain non-nutritive beneficial ingredients. From a regulatory standpoint, functional food products fall into the category defined as “food.”

Functional foods and functional food products can be “stress fighting foods.” The term “stress fighting food” as used herein refers to functional foods and functional food products that have properties to combat stress eating and/or stressed gut.

In contrast, a dietary supplement “(1) means a product (other than tobacco) intended to supplement the diet that bears or contains one or more of the following dietary ingredients: (A) a vitamin; (B) a mineral; (C) an herb or other botanical; (D) an amino acid; (E) a dietary substance for use by man to supplement the diet by increasing the total dietary intake; or (F) a concentrate, metabolite, constituent, extract, or combination of any ingredient described in clause (A), (B), (C), (D), or (E); (2) means a product that (B) is not represented for use as a conventional food or as a sole item of a meal or the diet; and (C) is labeled as a dietary supplement . . . ” (FFDCA Sec. 201(ff)). Unlike functional foods, dietary supplements cannot be represented for use as a conventional food or as a sole item of a meal or the diet and are not used primarily for their taste or aroma. Furthermore, dietary supplements were originally restricted to delivery formats such as a capsule, powder, softgel, gelcap, tablet, or liquid (FFDCA Sec. 411(c)(1)(B)(i)), so they would not be mistaken for a meal. Later, FDA relaxed the rules to allow delivery in other forms including a bar (e.g., snack bar) or bottled liquid (e.g., “vitamin waters”), but if a supplement is delivered in this manner, information on the label must not represent the product as a conventional food or a sole item of a meal or diet, and have the “Supplement Facts” label (FDA, 2019b).

### DETAILED DESCRIPTION

It is increasingly recognized that most chronic diseases of concern today are multifactorial in origin. To combat such diseases and adverse health conditions, a treatment approach where medicines and nutrition complement each other may prove to be the most successful. Within nutrition, apart from (disease-related) dietetic regimes, an increasing number of functional foods and dietary supplements, each with their own health claim, are marketed. These food items are considered to be positioned between traditional foods and medicines at the so-called “Pharma-Nutrition Interface.”

The use of functional foods or dietary supplements may offer opportunities to reduce health risk factors and risk of diseases, both as monotherapy and in combination with prescription drugs. Nevertheless, the potential caveats of these products should not be overlooked. Some fruits, vegetables, herbs, spices, cocoa and their extracts display a perceived functional activity increasing antioxidant status and at the same time modulating oxidative and inflammatory stress in humans. Interestingly, the modulatory effect of plant foods seems much more efficient in subjects characterized by different risk factors and high level of inflammatory and oxidative stress.

The health benefits of plant food-based diets could be related to both integrated antioxidant and anti-inflammatory mechanisms exerted by a wide array of phytochemicals present in fruit, vegetables, herbs and spices. Therefore, there is mounting interest in identifying foods, food extracts and phytochemical formulations from plant sources which are able to efficiently modulate oxidative and inflammatory stress to prevent diet-related diseases.

Inflammatory and oxidative stress can rise also as a direct consequence of unbalanced dietary life style, such as the ingestion of high fat and high carbohydrate meals. Increase in postprandial lipopolysaccharide (LPS) and Toll-like receptor-4 (TLR4) is associated with increased levels of inflammatory cytokines, such as interleukin (IL)-6, IL-17 and tumor necrosis factor-alpha (TNF-α), which in turn activate oxidative burst. Given these premises, the importance of the diet, as inducer or preventer of inflammatory and oxidative stress, is paramount.

A large body of epidemiological and clinical evidence provides a solid rationale for the health benefits of diets based on foods of vegetable origin, thanks to their content of bioactive ingredients such as vitamins and flavonoids. In fact, flavonoids and their metabolites, in addition to their direct free radical scavenging capacity, impair the production of ROS and RNS by neutrophils and other phagocytic cells through the inhibition of NOX, MPO and inducible-Nitric Oxide Synthases (iNOS). However, herbs and spices used for culinary purposes also represent an excellent, source of phytochemicals. Antioxidant and anti-inflammatory activities have been reported in vitro and in animal models for ginger (Zingiber officinale), milk thistle (Silybum marianum), hawthorn (Crataegus monogyna), passion flower (Passiflora edulis) and chamomile (Matricaria chamomilla). Therefore the health benefits of plant food-based diets could be related to both integrated antioxidant and anti-inflammatory mechanisms exerted by a wide array of phytochemicals present in fruit, vegetables, herbs and spices. On this basis, there is mounting interest in identifying foods, food extracts and phytochemicals formulations from plant sources which are able to efficiently modulate oxidative and inflammatory stress to prevent diet-related diseases.

Embodiments of the present disclosure provide formulations and methods of preparation and use thereof that help regulate a human body's response to stress and anxiety, which can result in a reduction in stress-eating. In embodiments, a dosage form, for example, a dietary supplement, includes a sensory disrupter, a stress-buster and a calming reliever. The sensory disrupter can include at least one of a terpene, linalool, limonene and caryophyllene. The stress-buster can include at least one of arginine, lysine, glycine, gamma amino butyric acid (GABA), magnesium, citi-choline, inositol and apigenin. The calming reliever can include at least one of a cannabidiol, lemon balm, passionflower and ashwagandha. In embodiments, the dosage form, for example, a dietary supplement, can include a nervous system component, an immune system component and an endocrine system component. The nervous system component can include at least one of gamma amino butyric acid, valerian root, 5-hydroxytryptophan, L-theanine, passionflower, and lemon balm. The immune system component can include at least one of Ahi flower oil, MCT oil, Vitamin D3 and an aromatic oil. The endocrine system component can include at least one of magnolia extract, phaelladendron extract and ashwagandha.

According to further embodiments, disclosed herein are methods of use that employ a multi-targeted approach that invokes the afferent sensory branch within the peripheral nervous system division and the central nervous system (CNS) to treat stress acutely and mid-long term. In embodiments, the methods of use include administering the dosage form or a kit including the dosage form to provide a “sensory distraction,” the acute response, which causes a physiologic response that temporarily reduces stress. In addition to containing a sensory distraction component, the dosage form can include one or more stress relieving ingredients that target key receptors or other targets within the CNS and indirectly affect the autonomic nervous system (ANS) to reduce stress over the mid- to longer-term, i.e., the sustained response. Notably, within the ANS division there are two branches: the sympathetic (i.e., activates stress response) and the parasympathetic (i.e., counteracts stress response, e.g., the relaxation response). This dual approach of invoking changes of input to the parasympathetic nervous system (PNS) and CNS, surprisingly provides a synergistic relaxation response modulated by the ANS (i.e., the parasympathetic branch), thus reducing stress in the short term (immediate), as well as a controlled (mid-long term) response.

Although the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

### Stress Response

A stress response provides a burst of energy to fight off attackers or run away effectively. This helped human ancestors, who faced numerous physical threats, to stay safe. In those times, the main threats were physical in nature and short-lived, usually predators indicating an extreme physical threat that then vanish.

However, current threats tend not to be physical and instead associated with the modern way of life—a challenge to status, a demand for performance, or any situation where the demand may exceed a human's ability to cope or require the human to work on coping. In addition to providing a set of changes that may not match current needs (e.g., it might be more effective to have a burst of mental clarity or wisdom than a burst of physical strength when facing a psychosocial stressor), the stress response can actually cause harm if it leads to a state of chronic stress—that is, if a stress response is triggered and sustained, then the body does not go back to its normal state via the relaxation response.

The strength of the stress response is related to the level of perceived threat_rather than actual, physical threat. As such, two people can experience the same situation and have very different stress reactions to the same trigger—some people perceive a threat where others do not. Knowing this, people may reduce the strength of their stress response by reminding themselves that this threat may not be as immediate as perceived. This is difficult to do, however, particularly for those who do not realize such a possibility exists.

A person may experience a greater level of stress when ignored or in a tense social situation, versus when they are driving a car in congested traffic, where the chances of being physically hurt are greater. Some people may experience greater levels of stress when speaking in public with no actual threat of physical danger (and relatively little social danger), but they nonetheless feel threatened and find their hands sweating and shaking, and their feet cold as the epinephrine/norepinephrine is released and redirection of blood flow away from extremities yields its effects. This also comes into play when negative experiences in childhood become stress triggers later in life causing a feeling that the person may be similarly hurt, but actually is not in danger.

As a subject's body perceives stress, the adrenal glands make and release cortisol into the bloodstream. Often called the “stress hormone,” cortisol causes an increase in heart rate and blood pressure resulting in the natural “flight or fight” response. Excess cortisol in the bloodstream can decrease metabolism and cause chronic fatigue, hypertension, depression, hunger, arthritis, migraines, tunnel vision, sleep deprivation and acid reflux. Feelings of appetite and satiety involve complex interactions between hormones from the gastrointestinal tract to the hypothalamus and subsequent feedback—(via the hypothalamic-Pituitary-Adrenal or “HPA” Axis). Cortisol levels modulate the release of “appetite regulating hormones” including ghrelin and leptin. Ghrelin also referred to as the “hunger hormone,” produces sensations of appetite and leads to food consumption. Leptin, the “satiety hormone,” produces a feeling of fullness. Through the interactions of ghrelin and leptin, the hypothalamus can regulate the sensation of hunger and satiety, leading to energy homeostasis. Imbalance and dysregulation of these hormones can have drastic effects on the body's energy homeostasis.

Persistent stress causes the nervous system to signal for increased and ongoing secretion of cortisol from the endocrine system (e.g., (via the HPA axis) into the bloodstream. Persistent stress further stimulates the endocrine system to signal the brain (nervous system) to consume sweets to replenish/or add-on top of glucose stores (e.g., fuel for the brain) for energy required to maintain the chronic stress state and for blood sugar/insulin control. Note, persistent fluctuations in insulin/blood sugar can lead to Type II diabetes. Long-term stress-eating also changes the gut microbiota to unhealthy bacteria (e.g., fermicutes) which also can signal the brain to consume sugar laden and high fat processed foods. Such fluctuations also can manufacture unhealthy short chain fats that go into storage in organs and other areas that are not good for all systems of the body.

Stress causes or contributes to a large variety of diseases and disorders. Immediately after a stressful event there is a corticotropin-releasing-hormone (CRH)-mediated suppression of food intake. In the acute phase, this diverts the body's resources away from the less pressing need to find and consume food, prioritizing fight, flight, or withdrawal behaviors so the stressful event can be dealt with. In the hours following, however, there is a glucocorticoid-mediated stimulation of hunger and eating behavior. In the case of ongoing psychological stress, however, chronically elevated glucocorticoids can lead to chronically stimulated eating behavior and excessive weight gain.

Stress can enhance the propensity to eat high calorie “palatable” food via its interaction with central reward pathways. Activation of this circuitry can also interact with the hypothalamic-pituitary-adrenal (HPA) axis to suppress its further activation, that is, not only can stress encourage eating behavior, but eating can suppress the HPA axis and the feeling of stress. Eating behavior and stress can modulate one another between the HPA axis and eating, introducing a potential integrative role for the hormone, ghrelin and leptin.

A balance between ghrelin and leptin is essential in maintaining adequate energy homeostasis. The interactions of these signals between the gastrointestinal tract and adipocyte storages allow the appropriate signals to be sent to various nuclei within the hypothalamus to exert the desired effect. An imbalance causes diverse pathophysiology related to weight imbalance and improper energy homeostasis. Chronically elevated levels of cortisol knock the system out of homeostasis. Imbalance and dysregulation of these hormones can have drastic effects on the body's energy homeostasis. An energy demand to the brain also provides a drive to eat.

### Stress Pathways

There are a number of systems that impact the degree of stress and anxiety a person may experience. The main “stress pathways” include:

The hypothalamic-pituitary adrenal axis (HPA-axis). When feeling stressed, the body goes into a “fight or flight” response and secretes increased amounts of stress hormones including cortisol and epinepherine/norepinephrine. These hormones are released through the HPA axis (a central hormone pathway), which includes the hypothalamus, the pituitary gland, and the adrenal glands. When stress levels are high, they lead to an imbalance in the HPA axis.

The Catecholamine Pathways: Three commonly known catecholamines are epinephrine (adrenaline), norepinephrine, and dopamine. Catecholamines can serve as neurotransmitters, transferring signals from neuron to neuron, as well as hormones, which regulate physiological functions such as heartbeat and breathing rate.

The Corticosteroid Pathway—The hypothalamus signals the pituitary gland to secrete adrenocorticotropic hormone (ACTH) and the adrenal cortex to release corticosteroids, which increase energy.

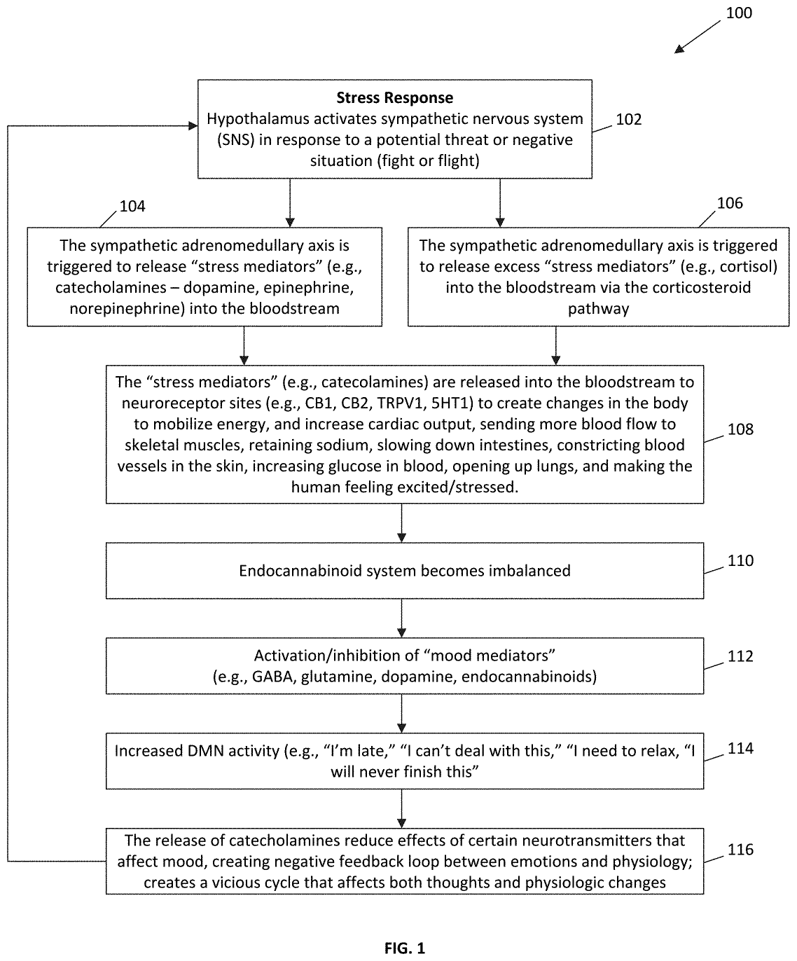

Referring to FIG. 1, the stress response process 100 begins at 102 when the hypothalamus activates the sympathetic nervous system in response to a potential threat or negative situation (“fight or flight”). As the stress response is triggered and the body's sympathetic nervous system is activated, at 104 and 106, the adrenal glands release stress hormones like cortisol, while the sympathetic-adrenomedullary axis (SAM) is also triggered to release catecholamines (e.g., dopamine, epinephrine, norepinephrine). These circulate through the bloodstream and the brain. They act on neuro-receptor sites to create changes in the body to mobilize energy. This is part of the “fight or flight,” response—putting the body on alert. The biological reason for overeating when stressed results from HPA/SAM activation, which produces a stress response.

During HPA activation, CRH initiates a stress response. CRH stimulates the secretion of ACTH from the anterior pituitary. Circulating ACTH acts on the zona fasciculata of the adrenal cortex where it stimulates the release of cortisol or corticosterone. In turn, cortisol feeds back to the brain to shut off further cortisol secretion. This negative feedback loop protects an organism from prolonged, detrimental cortisol exposure and keeps its concentration within a wide but stable operating range. SAM activation occurs in the adrenal gland. Cortisol provides adequate nutrients for adenosine triphosphate (ATP) synthesis within the adrenal gland during stress. This process reduces protein synthesis to spare ATP and spares glucose for the brain.

At block 108 of FIG. 1, the “stress mediators” (e.g., catecholamines) are released into the bloodstream to neuroreceptor sites (e.g., CB1, CB2, TRPV1, 5HT1) to create changes in the body to mobilize energy. The immediate effects of catecholamines include: increasing cardiac output, sending more blood flow to skeletal muscles, retaining sodium, slowing down the intestines, constricting the blood vessels in the skin, increasing glucose in the bloodstream, opening up lungs, and making a person feel excited, nervous, stressed and/or on edge. The heart beats faster and directs the flow to muscles, enabling the ability to run or fight. By reducing blood flow to the skin, there may be less bleeding in case of injury. This causes faster breathing and more oxygen.

Prolonged exposure to catecholamine's can create negative psychological and physical outcomes. Prolonged release of catecholamines can reduce the effects of certain neurotransmitters that affect mood, creating a negative feedback loop between emotions and physiology. These changes can also lead to chronic inflammation of organs and the failure of adaptive systems. This can lead to behavior and quality of life changes, sleep disturbances, metabolic disturbances and cardiovascular disturbances.

The catecholamines are part of the body's parasympathetic nervous system (PNS) or the relaxation response. This calms the body's physiology and returns the body to its pre-stressed state when the perceived threat is gone.

Endocannabinoid System (ECS)—The endocannabinoid system is a biological system within all humans. Endocannabinoids, that is, anadamide (AEA) and 2-Arachidonoylglycerol (2-AG), are neurotransmitters that bind to cannabinoid receptors and cannabinoid receptor proteins, which are expressed throughout the vertebrate central nervous system (including the brain) and peripheral nervous system. The endocannabinoids are messengers synthesized by the body. The two main cannabinoid receptors are CB1 and CB2. CB1 receptors are found predominantly in the brain and nervous system, and in peripheral organs and tissues. CB1 receptors are the main target of AEA, as well as exogenous cannabinoids such as cannabidiol (CBD), cannabinol (CBN) and tetrahydrocannabinol (THC) found in cannabis plants. The 2-AG endocannabinoid acts as a full agonist at both the CB1 and CB2 receptors.

As a result of stress, at block 110, a person's ECS can become imbalanced. People in a chronic stress state have been found to have low levels of the natural endocannabinoids AEA and 2-AG. These chemical messengers, which are naturally found in the brain and tissues of the body, act as a bridge between your body and brain, helping regulate multiple functions. For example, cannabidiol (CBD) oil extracted from a cannabis plant upregulates or produces more receptors for endocannabinoids to bind. That could help in terms of calming stress and modulating the negative impact of stress on brain function as well as immunity and other functions. Essentially, the ECS provides the fine-tuning or modulation of the stress pathways to decrease input and induce the relaxation response.

One theory is that the endocannabinoids, AEA and 2-AG, act as “gatekeepers” to keep the stress response and high emotional loads at bay and improve recovery to pre-stress levels once the stress burden is reduced to baseline. Cannabinoids are thought to rebalance or augment responses to stress. Moreover, there is evidence from preliminary human studies that disrupting endocannabinoid signaling and regulation has an important impact on the hypothalamic-pituitary-adrenal axis (HPA-axis) by increasing signs of anxiety and depression. The crosstalk between the immune system, cytokine signaling, and the nervous system influencing behavior, anxiety and mood has been proposed by numerous preclinical studies.

A number of recent studies have demonstrated the role of CB2 receptors classically associated with the immune system in anxiety and depression-related behavior in animal models and human clinical studies. In this context, it is interesting to note that a balanced ECS appears to be pivotal to a healthy stress response and mitigating fear, anxiety, and panic that tend to accumulate with dysfunctional responses to stress.

At block 112, as a part of the stress response, “mood mediators” become activated and/or inhibited. The mood mediators include, for example, gamma aminobutyric acid (GABA), glutamine, dopamine, endocannabinoids, etc. This leads to, at block 114, increased default mode network (DMN) activity. The DMN is a large scale brain network of interacting brain regions known to have activity highly correlated with each other and distinct from other networks in the brain. The increased DMN activity can produce thoughts such as “I'm late,” “I can't deal with this,” “I need to relax” and “I will never finish this.”

At block 116, the release of catecholamines can reduce the effects of certain neurotransmitters that affect mood, thereby creating a negative feedback loop between emotions and physiology. This creates a vicious cycle that affects both thoughts and physiologic changes.

In other words, a stimulus perceived by the central nervous system, including the brain, increases hypothalamus activity and activates the sympathetic nervous system (SNS). The SAM is triggered to release catecholamines to increase adrenaline (epinephrine) and noradrenaline (norepinephrine) in the blood stream resulting in an increase in cardiovascular activity and an increase in stress. Further activation occurs in the endocrine system via the hypothalamic-pituitary adrenocortical axis (HPA-axis), which leads to further release of hormones like cortisol and other transmitters that increase heart rate, blood pressure, etc. causing feelings of excitement and heart fluttering. An increase in stress mediators (e.g., catecholamines, glucocorticoids) released into the bloodstream to neuro-receptor sites creates changes in the body to mobilize energy. Continued activation also alerts the immune system, which is placed on high alert, causing the immune system to produce various chemicals that lead to inflammation resulting in increased susceptibility to colds/infection. Binding and activation of key receptors, CB1, CB2, TRPV1 and 5HTP1, takes place and within the CNS there is an activation/inhibition of the “mood mediators,” GABA, glutamate, dopamine, serotonin and endocannabinoids. All of this activity leads to an imbalance across these three (3) systems: the CNS, the endocrine system and the immune system as they can become depleted of various chemicals and transmitters that balance things out. This creates a vicious cycle that affects both thoughts and physiologic changes.

Relaxation Response—The counterpart to the “fight-or-flight” response, the relaxation response, occurs when the body is no longer in perceived danger, and the autonomic nervous system functions to return to normal. Simply put, the relaxation response is the opposite of the body's stress response—an “off switch” to the body's tendency toward fight-or-flight.

During the relaxation response, the body moves from a state of physiological arousal, including increased heart rate and blood pressure, slowed digestive functioning, decreased blood flow to the extremities, increased release of hormones like adrenaline and cortisol, and other responses preparing the body to fight or run, to a state of physiological relaxation, where blood pressure, heart rate, digestive functioning, and hormonal levels return to their normal state.

During acute stress, this response occurs naturally. Historically, this worked well when the stress response was triggered, somewhat rarely, and meant fast-moving physical threats like predators. In modern times, however, as the stress response is triggered multiple times throughout the day, the relaxation response does not always have a chance to naturally follow, creating an imbalance and a persistent stress response. For example, in times of chronic stress, the body is in a constant state of physiological arousal over perceived threats that are numerous and not life-threatening, and the body's relaxation response does not always have time to kick in before the next stressor hits. This decreases immunity and increases negative emotional consequences such as anxiety and burnout.

In situations like these, the relaxation response can be induced through techniques that relax the physical or physiological body, or the mind—if both can be relaxed simultaneously, it is even more effective. With all of today's modern technology and increased demands on an individual's time and heightened expectations, stress and anxiety has become more of an issue. There have been many approaches for reducing stress, either pharmacologically, or via cognitive approaches such as meditation, breathing, yoga, or exercising. There has not been a single type of treatment that can address the continuum of the stress response, and thus, what is needed, is a treatment that provides a holistic approach, leveraging and affecting multiple pathways involved in stress.

Homeostasis—There are two branches of the nervous system—the sympathetic nervous system (SNS) and the parasympathetic nervous system (PNS). Their primary function is to maintain what is referred to as homeostasis (i.e., balance). In times of stress, the sympathetic nervous system is activated (i.e., the “flight or flight” response discussed above) causing the heart to beat faster, and the person to feel nervous and on edge, for example, as if consuming too much coffee. Fight or flight is a primitive response that is activated when the body (i.e., the brain) senses danger or something that may cause worry. The response is communicated by neurotransmitters and activated hormones that kick off a cascade of events to prepare for fight or flight.

Homeostasis is achieved when the two nervous system branches are in balance. Once a stressor is removed or fear subsides, a person begins to feel back in control due to the parasympathetic system. The parasympathetic nervous system counteracts the sympathetic nervous system, releasing neurotransmitters that induce a more relaxed state, lowering the heart rate, blood pressure and jitters. Activation of the parasympathetic nervous system to counteract the sympathetic nervous system causes the “relaxation response” discussed above. Breathing and aromatherapy can induce the relaxation response and are helpful to calm the body in times of stress. The parasympathetic nervous system helps return the two systems back into homeostasis—a rebalancing or resetting of those two systems.

Allostasis—Two additional systems in the body that are also activated by the stress response are the immune system and the endocrine system. As discussed above, these two systems communicate closely with the nervous systems and, in times of stress, the immune and endocrine systems also respond and can become imbalanced. During time of stress, the immune system can become depressed making it easier for a person to catch a cold. The Endocrine system, which regulates various hormones including cortisol (a.k.a. the stress hormone) also can become imbalanced. When homeostasis is achieved together with balance of the immune and endocrine systems, this is referred to as “allostasis.”

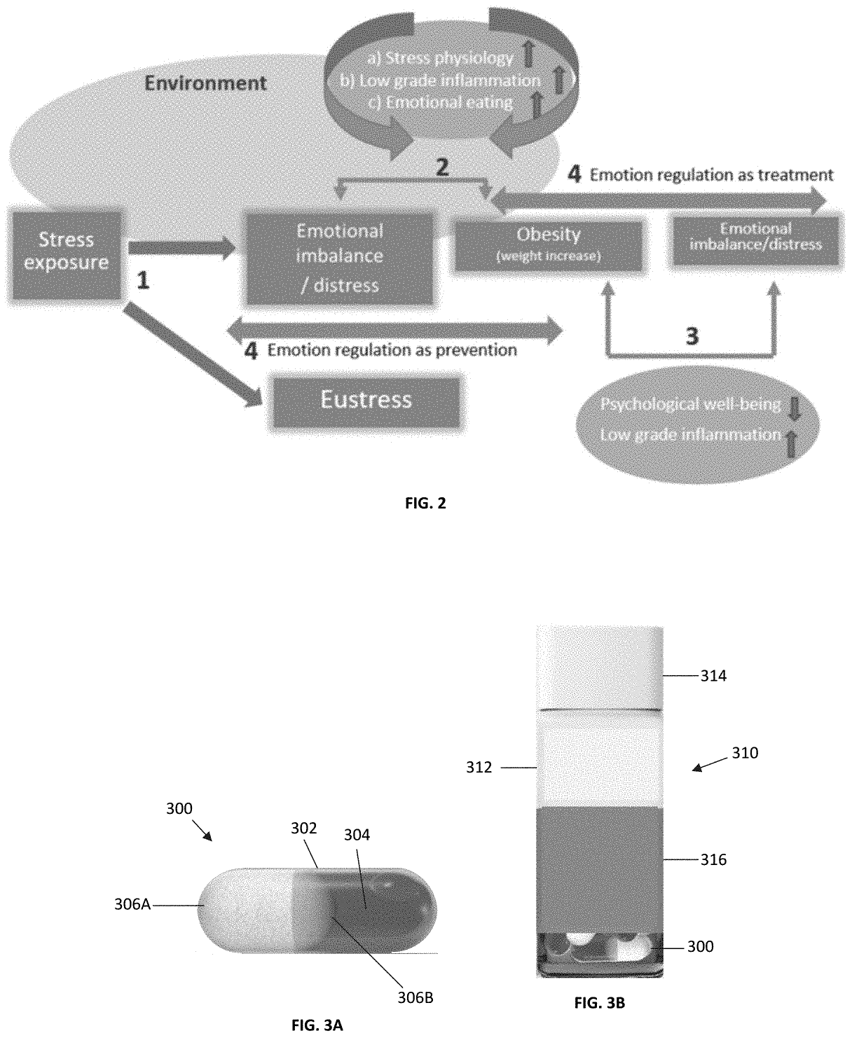

FIG. 2 is a representation showing the process involved when a subject stress eats. At 1, the subject is exposed to stress. At 2, an emotional imbalance and/or distress occurs. Stress physiology takes place in the subject together with low grade inflammation. At this stage the subject engages in emotional eating. At 3, the emotional eating leads to weight increase and/or obesity causing further emotional imbalance/distress. Low grade inflammation within the subject's body increases while the subject's psychological well-being decreases. At 4, the combination of 1, 2 and 3 may fall within emotion regulation as treatment. A subject, however, may not always proceed down the path of emotional imbalance/distress. In some instances, following the stress exposure, the subject experience eustress, which is a moderate or normal psychological stress that is interpreted as being beneficial. This falls within emotion regulation as prevention.

### Stress Eating

There are both physical and psychological causes for emotional eating. Often, emotional eating is triggered by stress or other strong emotions. Coping strategies can help a person trying to alleviate the most severe symptoms. People eat to satisfy true hunger, to fulfill a physical need to eat and survive. At other times, such as when a person stress-eats, s/he eat to satisfy appetite, or a desire for a particular type of food, because the person “believes” it will provide relief. That is a psychological, or emotional, need that generally has nothing to do with actual hunger. Emotional hunger is a driving response to overwhelming feelings and emotions. Personal experience also may be a factor in stress eating. Comfort foods—those that mentally bring people back to a more carefree time of childhood, and that are often high in sugar, fat, salt or both—are what emotional overeaters usually crave when tensions rise, especially sugar. This may help explain why psychological stress and “reward eating” is characterized by a lack of control over the types and amount of food eaten. Individuals associate comfort with foods based on personal and family experiences. It is no surprise that comfort foods are different depending on gender, age and culture. Additionally, those that eat when emotionally vulnerable, consider tastier food more comforting.

The first step a person needs to take to rid themselves of emotional eating is to recognize the triggers and situations that apply in his/her life. Keeping a food diary or journal can help to identify situations when someone is more likely to eat because of emotional instead of physical hunger. Tracking behavior is another way someone can gain insight into eating habits including patterns of hunger levels, what happens if the food is tedious and unpleasant, and/or what when bored or angry. Possible solutions to boredom may be a new book that sounds exciting to start reading, start a new hobby that could provide a challenge. Possible solutions to stress include yoga, meditation, or taking a walk to help cope with emotions. Possible solutions for depression include calling a friend, taking the dog for a run, or planning an outing to cope with negative feelings. It also can be helpful to talk to a therapist or psychologist to discuss other ways to break the cycle of emotional eating. A nutritionist or doctor may also be able to provide a referral to an expert or additional information on creating positive eating habits and a better relationship with food. Emotional eating is not simply a matter of a person lacking self-discipline or needing to eat less. Likewise, people who eat to deal with stress do not just lack self-control.

The causes of stress eating are complex and may involve childhood development and/or difficult dealing with emotions. For some people, emotional eating is a learned behavior. During childhood, their parents give them treats to help them deal with a tough day or situation, or as a reward for something good. Over time, the child who reaches for a cookie after getting a bad grade on a test may become an adult who grabs a box of cookies after a rough day at work. In an example such as this, the roots of emotional eating are deep, which can make breaking the habit extremely challenging.

It is common for people to also struggle with difficult or uncomfortable feelings and emotions. There is an instinct or need to quickly fix or destroy these negative feelings, which can lead to unhealthy behaviors. And emotional eating is not only linked to negative emotions. Eating a lot of candy at a fun Halloween party, or too much on Thanksgiving are examples of eating because of the holiday occasion itself.

There are also some physical reasons why stress and strong emotions can cause a person to overeat: high cortisol levels, cravings and sex. Initially, stress causes the appetite to decrease so that the body can deal with the situation. If the stress does not let up, cortisol is released. Cortisol increases appetite and can cause someone to overeat. High cortisol levels from stress can increase food cravings for sugary or fatty foods. Stress is also associated with increased hunger hormones, which may also contribute to cravings for unhealthy foods. Some research shows that women are more likely to use food to deal with stress than men are, while men are more likely than women to smoke or use alcohol.

It is very easy to mistake emotional hunger for physical hunger. But there are characteristics that distinguish them. Recognizing these subtle differences is the first step towards helping to stop emotional eating patterns. Emotional hunger tends to hit quickly and suddenly and feels urgent. Physical hunger is usually not as urgent or sudden unless it has been a while since a person ate. Emotional hunger is usually associated with cravings for junk food or something unhealthy. Someone who is physically hungry will often eat anything, while someone who is emotionally hungry will want something specific, such as fries or a pizza. Emotional eating is a common experience and is not usually associated with physical hunger. Some people succumb to it occasionally while others can find it impacts on their lives and may even threaten their health and mental wellbeing.

A person who experiences negative emotions around his/her eating habits should arrange a visit to their doctor to discuss their issues. S/he may also want to consult a registered nutritionist or another therapist to help them find solutions or coping mechanisms.

Emotions, such as stress, are not the only triggers for emotional eating. Other common triggers include 1) Boredom: Being bored or having nothing to do is a common emotional eating trigger. Many people live very stimulating and active lives, and when they have nothing to do will turn to food to fill that vacuum; 2) Habits: These are often driven by nostalgia or things that happened in a person's childhood. An example might be, having ice cream after a good report card or baking cookies with a grandparent; 3) Fatigue: It is easier to overeat or eat mindlessly when fatigued, especially when tired of doing an unpleasant task. Food can seem like the answer to not wanting to do a particular activity anymore; and 4) Social influences: Everyone has that friend who encourages them to get a pizza after a night out, go out for dinner or drinks after a difficult day, or as a reward for a good day. It can be easy to overeat when with friends or family.

Stress eating can ruin a person's weight loss goals—the key is to find ways to relieve stress without overeating. There is much truth behind the phrase “stress eating.” Stress, the hormones it unleashes, and the effects of high-fat, sugary “comfort foods” push people toward overeating. Researchers have linked weight gain to stress, and according to an American Psychological Association survey, about one-fourth of Americans rate their stress level as 8 or more on a 10-point scale.

In the short term, stress can shut down appetite. The nervous system sends messages to the adrenal glands atop the kidneys to pump out the hormone epinephrine (also known as adrenaline). Epinephrine helps trigger the body's fight-or-flight response, a revved-up physiological state that temporarily puts eating on hold. However, if stress persists, it's a different story. The adrenal glands release another hormone called cortisol, and cortisol increases appetite and may also ramp up motivation in general, including the motivation to eat. Once a stressful episode is over, cortisol levels should fall, but if the stress doesn't go away—or if a person's stress response gets stuck in the “on” position—cortisol may stay elevated.

There is much truth behind the phrase “stress eating.” Stress, the hormones it unleashes, and the effects of high-fat, sugary “comfort foods” push people toward overeating. Researchers have linked weight gain to stress, and according to an American Psychological Association survey, about one-fourth of Americans rate their stress level as 8 or more on a 10-point scale. In the short term, stress can shut down appetite. The nervous system sends messages to the adrenal glands atop the kidneys to pump out the hormone epinephrine (also known as adrenaline). Epinephrine helps trigger the body's fight-or-flight response, a revved-up physiological state that temporarily puts eating on hold. But if stress persists, it's a different story. The adrenal glands release another hormone called cortisol, and cortisol increases appetite and may also ramp up motivation in general, including the motivation to eat. Once a stressful episode is over, cortisol levels should fall, but if the stress doesn't go away—or if a person's stress response gets stuck in the “on” position—cortisol may stay elevated.

Stress also seems to affect food preferences. Numerous studies—granted, many of them in animals—have shown that physical or emotional distress increases the intake of food high in fat, sugar, or both. High cortisol levels, in combination with high insulin levels, may be responsible. Other research suggests that ghrelin, a “hunger hormone,” may have a role. Once ingested, fat- and sugar-filled foods seem to have a feedback effect that dampens stress related responses and emotions. These foods really are “comfort” foods in that they seem to counteract stress—and this may contribute to people's stress-induced craving for those foods. Of course, overeating isn't the only stress-related behavior that can add pounds. Stressed people also lose sleep, exercise less, and drink more alcohol, all of which can contribute to excess weight.

Some research suggests a gender difference in stress-coping behavior, with women being more likely to turn to food and men to alcohol or smoking. And a Finnish study that included over 5,000 men and women showed that obesity was associated with stress-related eating in women but not in men. Harvard researchers have reported that stress from work and other sorts of problems correlates with weight gain, but only in those who were overweight at the beginning of the study period. One theory is that overweight people have elevated insulin levels, and stress-related weight gain is more likely to occur in the presence of high insulin. How much cortisol people produce in response to stress may also factor into the stress—weight gain equation. In 2007, British researchers designed an ingenious study that showed that people who responded to stress with high cortisol levels in an experimental setting were more likely to snack in response to daily hassles in their regular lives than low-cortisol responders.

When stress affects someone's appetite and waistline, the individual can forestall further weight gain by ridding the refrigerator and cupboards of high-fat, sugary foods. Keeping those “comfort foods” handy is just inviting trouble. Here are some other suggestions for countering stress: 1) Meditation. Countless studies show that meditation reduces stress, although much of the research has focused on high blood pressure and heart disease. Meditation may also help people become more mindful of food choices. With practice, a person may be able to pay better attention to the impulse to grab a fat- and sugar-loaded comfort food and inhibit the impulse; 2) Exercise. While cortisol levels vary depending on the intensity and duration of exercise, overall exercise can blunt some of the negative effects of stress. Some activities, such as yoga and tai chi, have elements of both exercise and meditation; and 3) Social support. Friends, family, and other sources of social support seem to have a buffering effect on the stress that people experience. For example, research suggests that people working in stressful situations, like hospital emergency departments, have better mental health if they have adequate social support. But even people who live and work in situations where the stakes aren't as high need help from time to time from friends and family.

Stress causes or contributes to a huge variety of diseases and disorders. Immediately after a stressful event there is a corticotropin-releasing-hormone (CRH)-mediated suppression of food intake. In this acute phase, the body's resources are diverted away from the less pressing need to find and consume food, prioritizing fight, flight, or withdrawal behaviors so the stressful event can be dealt with. In the hours following this, however, there is a glucocorticoid-mediated stimulation of hunger and eating behavior. In the case of ongoing psychological stress, however, chronically elevated glucocorticoids can lead to chronically stimulated eating behavior and excessive weight gain. Stress can enhance the propensity to eat high calorie “palatable” food via its interaction with central reward pathways.

Activation of this circuitry can also interact with the HPA axis to suppress its further activation, meaning not only can stress encourage eating behavior, but eating can suppress the HPA axis and the feeling of stress. Eating behavior and stress modulate one another between the HPA axis and eating, introducing a potential integrative role for the hormone, ghrelin and leptin. The biological reason a person overeats when stressed is that HPA/SAM Activation begins the stress response. The stress response includes: 1) HPA activation, 2) SAM activation, 3) Cortisol release, 4) Sugar/fuel and 5) energy homeostasis involving ghrelin and leptin. Although the stress response depends on intensity, duration and ‘type’ of stressor, the key components involve activation of the hypothalamus pituitary adrenal (HPA) axis and the sympathetic—(SAM) system. The central control stations of the stress response are located in the hypothalamus and the brain stem. Corticotropin-releasing hormone (CRH) neurons of the paraventricular nucleus initiate the stress response and comprise the principal hypothalamic regulator of the hypothalamus-pituitary-adrenal (HPA) axis. The corticotropin-releasing hormone (CRH) initiates the stress response. CRH stimulates the secretion of adrenocorticotropic hormone (ACTH) from the anterior pituitary. Circulating ACTH acts on the zona fasciculata of the adrenal cortex where it stimulates the release of cortisol or corticosterone. In turn, cortisol feeds back to the brain to shut off further cortisol secretion. This negative feedback loop protects the organism from prolonged, detrimental cortisol exposure and keeps its concentration within a wide but stable operating range. The goal of cortisol is to provide adequate nutrients for adenotriphosphate (ATP) synthesis during stress. This reduces protein synthesis to spare ATP and creates glucose sparing for the brain. The sympathetic—adrenomedullary system (SAM) originates in the locus ceruleus, and—together with the HPA axis—builds the effector limbs of the stress response.

The feelings of appetite and satiety involve complex interactions between hormones from the gastrointestinal tract to the hypothalamus and subsequent feedback (via the HPA Axis). High blood levels of cortisol are linked to increased appetite. Cortisol levels modulate the release of “appetite regulating hormones.” Two Main hormones affected by cortisol levels regulate energy homeostasis: Ghrelin and Leptin. Ghrelin produces sensations of appetite and leads to food consumption. Originally, ghrelin was discovered as a growth hormone-releasing peptide that acted on the hypothalamus. Subsequent studies then showed that ghrelin had a role in increasing body weight and elevated levels before meals, thus earning the name “hunger hormone.” The lateral area of the hypothalamus is responsible for hunger and becomes stimulated by ghrelin. Since then, many studies have attempted to adjust the balance between ghrelin and leptin for therapeutic uses. Although ghrelin is most prominently known for its role in stimulating appetite, ghrelin is also involved in regulating sleep-wake rhythms, taste sensation, and the regulation of glucose metabolism. Studies continue to explore the growing relationship between ghrelin and glucose metabolism, showing ghrelin's ability to decrease insulin release.

Leptin, referred to as the “satiety hormone,” produces a feeling of fullness. Imbalance and dysregulation of these hormones can have drastic effects on the body's energy homeostasis. Leptin is perhaps best understood as the opposite of ghrelin, acting as the body's satiety signal (aka “feeling full”). Leptin was discovered primarily as a signal in regulating body weight. However, the roles of these hormones in regulating appetite and satiety were not explicitly known until research showed a correlation between a rise in plasma levels of ghrelin before meals and a subsequent decrease in plasma levels of ghrelin after meals and a subsequent change in plasma leptin levels. Together, ghrelin and leptin signals regulate our sensations of hunger and satiety by sending signals to different nuclei within the hypothalamus for food intake. Imbalance and dysregulation of these hormones can have drastic effects on the body's energy homeostasis.

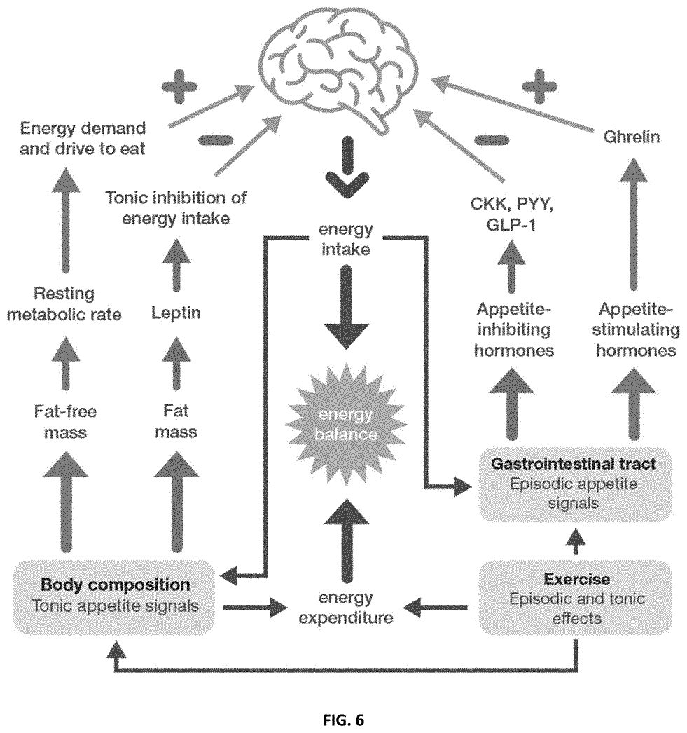

FIG. 6 is a diagram depicting homeostasis in the body. A balance between ghrelin and leptin is essential in maintaining adequate energy homeostasis. Furthermore, the interactions of these signals between the gastrointestinal tract and adipocyte storages allow the appropriate signals to be sent to various nuclei within the hypothalamus to exert the desired effect. An imbalance causes diverse pathophysiology related to weight imbalance and improper energy homeostasis. Chronically elevated levels of cortisol knock the system out of homeostasis. Imbalance and dysregulation of these hormones can have drastic effects on the body's energy homeostasis. Imbalance and dysregulation of these hormones can have drastic effects on the body's energy homeostasis. Imbalance and dysregulation of these hormones can have drastic effects on the body's energy homeostasis.

Together with ghrelin, leptin exists in balance to regulate energy homeostasis. The ventromedial region of the hypothalamus is responsible for satiety and is stimulated by leptin. Furthermore, leptin inhibits stimulation of the lateral hypothalamus to inhibit the effects of ghrelin. As an adipocyte-derived hormone (from fat stores/exogenous), leptin sends signals to the medial hypothalamus regarding energy storage within the body. However, leptin also has many other roles within the body, such as reproduction, blood pressure, and vast effects on the immune system. These other functions of leptin have an overall effect on energy metabolism and act to change the balance within the body. Similarly, the relationship between inactive leptin and obesity has also been the topic of research.

Through the interactions of ghrelin and leptin, the hypothalamus can regulate the sensation of hunger and satiety, leading to energy homeostasis. Persistent stress causes the nervous system to signal for increased and ongoing secretion of cortisol from the endocrine system (e.g., (via the HPA axis) into the bloodstream. High blood levels of cortisol are linked to increased appetite, via release of “hunger hormones” such as Grehlin. Persistent stress further stimulates the endocrine system to signal the brain (nervous system) to consume sweets to replenish/or add-on top of glucose stores (e.g., fuel for the brain) for energy required to maintain the chronic stress state and for blood sugar/insulin control. Note, persistent fluctuations in insulin/blood sugar can lead to Type II diabetes. Long-term stress-eating also changes the gut microbiota to unhealthy bacteria (e.g., fermicutes) which also can signal the brain to consume sugar laden and high fat processed foods. They also can manufacture unhealthy short chain fats that go into storage in organs and other areas that are not good for all systems of the body.

Under normal conditions, 1) food stimulates the vagus nerve lining the GI tract to initiate negative feedback, i.e., satiation; 2) ghrelin is produced in the upper regions of the stomach and promotes hunger; peptide tyrosine tyrosine (PPY), pancreatic peptide (PP), cholecystokinin (CCK), glucagon-like peptide 1 (GLP-1) and oxyntomodulin (OXM) reduce food intake; and 4) leptin is produced by adipose tissues and reduces hunger. Although the stress response depends on intensity, duration and “type” of stressor, the key components involve activation of the hypothalamus pituitary adrenal (HPA) axis and the sympathetic—adrenomedullary (SAM) system. The central control stations of the stress response are located in the hypothalamus and the brain stem. Corticotropin-releasing hormone (CRH) neurons of the paraventricular nucleus initiate the stress response and comprise the principal hypothalamic regulator of the hypothalamus-pituitary-adrenal (HPA) axis. CRH stimulates the secretion of ACTH from the anterior pituitary. Circulating ACTH acts on the zona fasciculata of the adrenal cortex where it stimulates the release of cortisol or corticosterone. In turn, cortisol feeds back to the brain to shut off further cortisol secretion. This negative feedback loop protects the organism from prolonged, detrimental cortisol exposure and keeps its concentration within a wide but stable operating range. The sympathetic—adrenomedullary system (SAM) originates in the locus ceruleus, and—together with the HPA axis—builds the effector limbs of the stress response.

Once the mechanisms of stress are understood, it is no surprise that stress is also involved in appetite regulation. Stress encourages the release of sugar into the bloodstream for energy production. The adrenaline hormones (epinephrine/nor-epinephrine) suppress appetite, while cortisol increases hunger to replenish the energy used. During chronic stress, a person experiences elevations in cortisol that stimulate appetite (via ghrelin release/leptin inhibition)—this makes the person prone to overeating. Any cognitive associations the individual has made between food, happiness and comfort, it further influences food selection. Since the hormone cortisol signals with the master regulator of metabolism, the hypothalamus, cortisol may influence the reward values of certain foods.

Increased cortisol disrupts the stress axis as well as neuronal hormones and peptides involved in regulating appetite. Short-term it may make unhealthy foods sound a lot more appealing, as the body will crave sugar and fat. Long-term though may lead to metabolic dysfunction. Increased leptin released from fat-storing cells signals the hypothalamus indicating the body is full. However, the hypothalamus may begin to adapt to the leptin, and require even higher levels before the body feels full and satiated. NPY is produced and released from many different regions of the brain, including the hypothalamus and amygdala. Disruptions or dysregulation in neuropeptide Y (NPY) production may stimulate stress-induced feeding. Increased insulin tells the body to take up more glucose. However, if signaling between the liver and insulin is dysregulated, so is the body's glucose metabolism.

In addition to insulin and leptin there is evidence for glucocorticoids to stimulate the food intake branch—the NPY system, thereby promoting obesity. Central dexamethasone infusion decreased hypothalamic CRH and increased NPY content. Chronic NPY infusion resulted in marked hyperphagia and hyperinsulinemia in the rat. Therefore, a classic feedback loop has been proposed between CRH and NPY on a hypothalamic level. In that feedback loop, glucocorticoids stimulate NPY release via an inhibition of CRF. NPY is an anxiolytic peptide, leading to decreased anxiety. It is known to play an important role in the response to stress and in psychiatric disorders, thus, potentially an important mediator of what is anecdotally described as ‘emotional eating’. Low NPY concentrations have been observed in subjects with posttraumatic stress disorder and depression—psychiatric conditions classically associated with a loss of appetite. Increased NPY is associated with stress resilience in subjects exposed to traumatic experience. NPY increases in response to stress may be one biochemical signal underlying stress eating. A major obstacle for NPY research in humans is that central release and metabolism are difficult to access. Therefore, most studies use the easier accessible peripheral compartment, which may reflect sympathetic nervous system activity more than central NPY signaling.

Elevated levels of cortisol can increase caloric intake, such as for people taking prednisone for various medical conditions or cancer treatment. In a well-controlled study, administration of glucocorticoids markedly increased food intake. Presumably, high stress reactivity, increases cortisol, leading to greater intake of calories, at least phasically. Thus, one's psychological stress reactivity may be a clue as to differences psychobiological characteristics that explain stress eating or food cravings. In one study of healthy medical students, self-identified stress eaters had significantly higher urinary cortisol and insulin during a stressful period (medical student exams) compared to a control period (summer vacation), and also gained more weight than non-stress eaters, during stress. It is possible that the stress eaters have underlying high stress reactivity, which promotes their overeating, although this has not been tested directly. In a second study, compared a similar threat stressor to a positive challenge stressor (identical tasks but with positive feedback from the audience). Preliminary results suggest that indeed, the ‘threat’ condition stimulated greater food intake, particularly of calorically dense food, than the “challenge” condition. Further, the difference in fat intake by condition was mediated by psychological threat appraisals.

The relationship between stress and adiposity is complex, and a narrow or simplified model emphasizes the role of cortisol. Threat related stress can lead to greater cortisol exposure. Cortisol clearly activates the reward system. Intermittent access to food engages the reward system, and can enhance the effects of stress alone. The effects of cortisol on the reward system may be partly mediated through increases in insulin, NPY, and leptin. Insulin has acute effects inhibiting the reward system and. without being bound by any particular theory, it is believed that chronic exposure to circulating insulin may stimulate the reward system, as in the case of insulin resistance. The effect of those mediators on the brain reward center may contribute to a state of hedonic withdrawal, leading to the subsequent drive to relieve this negative state. People have learned that intake of highly palatable food can do just that.

The natural reward of highly palatable food can directly or indirectly reduce activity of the HPA axis. This has been described as “self-medication” with food. Changes in neuroendocrine balance (high cortisol and insulin) from eating when under stress might further sensitize the reward center of the brain, leading to a positive feedback loop drive to maintain opioid stimulation from palatable food.

Given that cortisol and eating stimulate insulin, the combination of stress and highly palatable food intake sets up potent conditions for visceral fat storage. While this model is speculative, the data at this point show that human's stress related energy intake is not very different than that of the rat. Further, a recent review suggests that stress induced cortisol exposure may impair right prefrontal cortex activity, thus impeding the more reflective cognitive control over eating that is distinct to humans. While recent research has elucidated likely pathways for stress-eating, there is much progress to be made in trying to understand and prevent stress eating and non-homeostatic eating in general. In view of the foregoing, there is a need for stress eating dosage forms and foods and for stressed gut dosage forms and foods to support individuals during times of stress including chronic stress.

### Dosage Forms and Foods

Dosage forms, foods and kits according to embodiments herein, target all three stress pathways, the nervous system, endocrine system and immune system, to help bring the body back into allostasis. Dosage forms, dietary supplements and/or methods according to embodiments herein target all three of these systems to help support the body in reaching allostasis thereby lessening stress and stress-eating.

In one or more embodiments, disclosed herein are dosage forms and foods that are formulated to support an individual when combatting stress-eating and periods of stress. According to various embodiments, dosage forms can be formulated for any suitable route of administration. In embodiments, the dosage form can be formulated for a route of administration selected from oral, parenteral, subcutaneous, intravenous, intramuscular, intraperitoneal, transdermal, transmucosal (e.g., via the transurethral or rectal routes), sublingual, buccal, gingival, rectal, subcutaneous, transpulmonary, topical, nasal, inhalation and combinations thereof. According to embodiments, dosage forms as described herein may in the form of a tablet, troche, lozenge, a plurality of units (as described in more detail below), hard capsule, soft capsule, buccal tablet, buccal film, sublingual tablet, sublingual film, transdermal patch, topical gel, cream, oil or ointment, liquid (e.g., a liquid shot) and/or combinations thereof. In embodiments, the dosage form is a shot having a volume of about 1 ml to about 100 ml, about 2 ml to about 75 ml, about 5 ml to about 50 ml, or about 10 ml to about 25 ml.

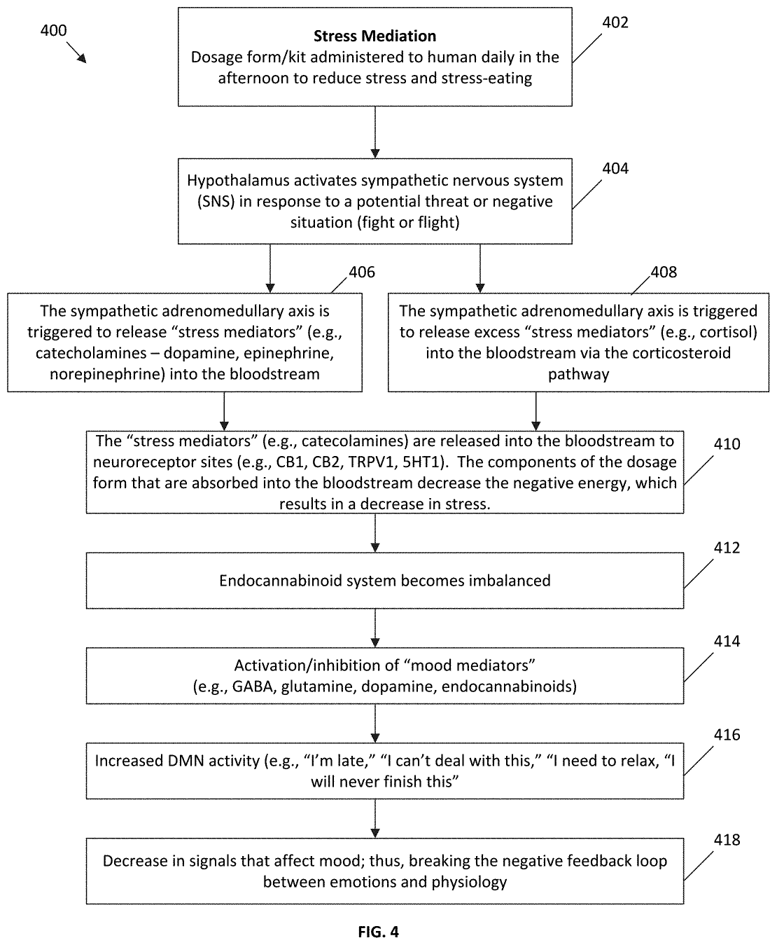

According to various embodiments, dosage forms as described herein can be two-phase, two-compartment release systems. In some embodiments, as shown in FIG. 3A, the dosage form 300 is comprised of two phases, a solid phase 306A, 306B and a liquid phase 304, which may be encapsulated 302 separately or together. In some embodiments, the solid phase 306A, 306B is in the form of a tablet, an extrudate, a compressed solid, a slug and/or may be comprised of a plurality of units (e.g., particles, granules, powder, extrudates, micro capsules, micro tablets, etc.). In some embodiments, the solid phase may be encapsulated particles where a portion 306B of the encapsulated particles form an inner capsule that extends into the cavity of the outer capsule containing the liquid phase 304 as shown in FIG. 3A. The liquid phase 304 may be in the form of an aqueous liquid, a solvent, an oil and/or a dispersion. An embodiment of a packaging system 310 is shown in FIG. 3B. In some embodiments, capsules 300 as described with respect to FIG. 3A, may be packaged in packaging system 310.

Dosage forms according to embodiments herein can have an apple pie flavor. For example, essential oil/aromatherapy oils can be sprayed onto the outer capsule and/or can be comprised in the solid and/or liquid phases of the dosage form. The aromatic oils engage a user's senses the moment the packaging system 310 is opened. The smell, taste and visual appearance of the capsules engage the user's senses guiding the user to a comfort state.

According to various embodiments, dosage forms can include a sensory disrupter, a stress-buster and a calming reliever. Suitable sensory disrupters include, but are not limited to, a terpene, linalool, limonene, caryophyllene (also has warming properties), cooling agents (e.g., menthol, menthol-like, etc.), warming agents (e.g., cinnamon, black pepper, cardamom, clove bud, ginger, juniper berry, marjoram, rosemary and oils thereof), any suitable colors to stimulate sight (e.g., to provide a relaxed and/or happy feeling), agents that stimulate taste (e.g., aromatic oils as described herein, suitable food products, pop rock-like, etc.), and components that stimulate sound (e.g., popping as in pop rocks, crinkling, wind, rain, birds, ocean, music, classical music, jazz music, relaxation app, etc.) and combinations thereof. Suitable stress-busters include, but are not limited to, L-arginine, L-theanine, lysine, glycine, gamma amino butyric acid (GABA), magnesium, citi-choline, inositol, apigenin and combinations thereof. Suitable calming relievers include, but are not limited to, cannabidiol, lemon balm, passionflower, ashwagandha, valerian root extract and combinations thereof.

According to embodiments, dosage forms as described herein can be formulated to have quick or rapidly dissolving properties that would provide an oral sensation of dissolving quickly within the oral cavity. In embodiments, the dosage forms can be formulated to provide rapid delivery (e.g., immediate release) via sub-lingual application incorporating the various components as described herein. In embodiments, oral dosage forms can employ ingredients that produce an effervescent reaction upon placement into liquid, such as water or juice. In yet further embodiments, oral dosage forms described herein can be formulated into a gelatin gummy form. Such “gummies” can incorporate various components that invoke one or more of the following sensations: a cooling or heating sensation within the oral cavity, and bitter, sour and/or sweet taste upon ingestion via oral cavity. In yet further embodiments, dosage forms can be formulated for delivery via a “tea-bag” that containing ingredients as set forth herein. This “tea-bag” form can also employ aromatic oils are natural oils such as plant terpenes to stimulate the olfactory system, thus providing a sensory disruption to the sympathetic nervous system.

In embodiments, the dosage form can comprise a plurality of units. The plurality of units can include, but are not limited to, particles, powder, granules, beads, microspheres, micro-tablets, microcapsules, extrudates and combinations thereof. In certain embodiments, the plurality of units are in the form of micro-tablets. The micro-tablets can have any suitable shape known to those of ordinary skill in the art, for example, the micro-tablets can be circular, cylindrical, pyramidal, toroidal and combinations thereof. The micro-tablets can be formed from compressed powder, beds, microspheres and/or granules or can be extrudates. Each of the plurality of units can have a mean size of about 0.1 μm to about 5 mm, or about 1 μm to about 3 mm, or about 50 μm to about 1 mm. In embodiments, the micro-tablets can have a mean size of about 0.5 mm to about 5 mm.

According to various embodiments, the plurality of units can include a first plurality of units and a second plurality of units. The first plurality of units may be a different color than the second plurality of units. For example, the first plurality of units may be white and the second plurality of units may be orange or purple. The color can be selected to have a soothing effect and may be selected from shades of green (e.g., sage green), blue (e.g., baby blue, slate blue, etc.), purple (e.g., lavender), white, grey (e.g., soft grey), pink, yellow and orange (e.g., mandarin orange). In embodiments, the plurality of units can be divided into, two, three, four and so on. Each of the plurality of units can have a different color. The plurality units can include natural pigments to provide the desired color. Such pigments can be food colorants and may include, but are not limited to, flavonoids, spirulina, beets, orange carrots, pumpkins, black carrots, sweet potatoes, elderberries, tomatoes, blueberries, grapes, safflower and combinations thereof.

According to various embodiments, the plurality of units can be formulated to provide a controlled release of one or more component therein. The terms “controlled-release,” “extended-release” or “sustained release” are interchangeable and are defined for purposes of the present disclosure as the release of one or more component (e.g., a sensory disrupter, a stress buster, a calming reliever, etc.) at such a rate that blood (e.g., plasma) concentrations are maintained within the therapeutic range, but below toxic concentrations, over a period of time of at least about 1 hour or longer, at least about 2 hours or longer, at least about 3 hours or longer, at least about 4 hours or longer, at least about 5 hours or longer, or at least about 6 hours or longer, or at least about 10 hours or longer, or at least about 12 hours or longer or at least about 24 hours or longer. Preferably, a controlled release dosage form can provide one, two, three or four times daily dosing.

In embodiments, the plurality of units can be formulated to provide an immediate release of one or more component therein. The term “immediate release” is defined for the purposes of the present disclosure as the release of one or more component (e.g., a sensory disrupter, a stress buster, a calming reliever, etc.) into the air, mouth or in the gastrointestinal contents with no delay or prolongation of dissolution or absorption, smell or taste of the one or more component.

In embodiments, the dosage form may comprise a pharmaceutically acceptable capsule. In embodiments, at least one of a sensory disrupter, a stress buster and a calming reliever can be within the pharmaceutically acceptable capsule. In embodiments where the dosage form comprises a plurality of units, the plurality of units can be contained within the pharmaceutically acceptable capsule. The capsule may be any suitable capsule known to those of ordinary skill in the art including a hard shell capsule, a soft shell or a soft gelatin capsule. The pharmaceutically acceptable capsule can be formed of a mixture of natural oils and components. In embodiments, the pharmaceutically acceptable capsule comprises a sensory disrupter, for example, at least one aromatic oil (e.g., a natural oil) as described in embodiments herein. In embodiments, the aromatic oil comprises at least one of mint oil, lavender oil and citrus oil. Suitable components used to form the capsule shell can include, but are not limited to, gelatin and a physiologically acceptable plasticizer such as glycerol (e.g., the gelatin forming a matrix for the plasticizer). The capsule shell composition can include about 15% to about 30% by weight of gelatin and about 30% to 45% by weight of the plasticizer. The further component is normally a potato starch acetate, another starch derivative, starch itself or mixtures thereof. According to embodiments, the capsule shell can be clear or translucent.

An example of a dosage form according to various embodiments herein is shown in FIG. 3A. As shown, the pharmaceutically acceptable capsule 302 may be clear or translucent with micro-tablets contained therein. A first plurality of the micro-tablets 304 can be a white color and the second plurality of the micro-tablets 306 can be a different color, for example, red 306. The appearance of the dosage form may itself provide a sensory disruption to someone experiencing stress where the sight of a soothing color and unique look can help in rebalancing the body's systems to achieve allostasis.

According to embodiments, the pharmaceutically acceptable capsule comprises a coating on a surface thereof. The coating can include a sensory disrupter, for example, at least one aromatic oil. Suitable aromatic oils include, but are not limited to a plant terpene, lavender oil, citrus oil, chamomile oil, rose oil, hyssop oil, mint oil, peppermint oil, spearmint oil, wintergreen oil, clary sage oil, rosemary oil, ylang ylang oil, myrrh oil, vetiver oil, lemongrass oil, orange oil, grapefruit oil, lemon oil, frankincense oil, helichrysum oil, cedarwood oil, basil oil, melaleuca oil, arborvitae oil, patchouli, clove oil, cassia oil, oregano oil, rosemary oil, thyme oil, mango oil, juniper oil, cinnamon oil, pepper oil, lilac oil, nutmeg oil, cumin oil, pine oil, parsley oil, orchid oil and cannabis oil. In embodiments, the coating comprises at least one of mint oil, lavender oil and citrus oil. Suitable plant terpenes include, but are not limited to myrcene, pinene, caryophyllene, limonene, terpinolene and combinations thereof.

According to various embodiments, the dosage form provides an immediate release of at least one of the sensory disrupter, the stress-buster and the calming reliever. In embodiments, the dosage form provides a controlled release of at least one of the sensory disrupter, the stress-buster and the calming reliever. In further embodiments, the dosage form provides an immediate release of at least one of the sensory disrupter, the stress-buster and the calming reliever and a controlled release of at least one of the sensory disrupter, the stress-buster and the calming reliever. In certain embodiments, the dosage form, for example, as shown in FIGS. 3A and 3B, comprises a sensory disrupter (e.g., an aromatic oil) coated onto the capsule or formulated within the capsule shell material. The sensory disrupter can be in an immediate release form so that upon opening a package or container housing the dosage form therein a human can smell the aromatic oil, upon placing the dosage form in his/her mouth can taste the oil and within seconds or minutes of swallowing the dosage form can feel a warming and/or cooling sensation.

According to certain embodiments, the dosage form may be free of certain components, for example, depressants, narcotics, supplements, etc. that may cause sleep or drowsiness. The dosage form may alternatively or additionally be free of components, for example, stimulants, amphetamines, supplements, etc. that may cause insomnia or jitters. In embodiments, the dosage form is free of at least one of melatonin, diphenhydramine, caffeine, cannabinoids, cypress oil, eucalyptus oil, tea tree oil, rose oil, sandalwood oil, sugar, sweetener, preservatives, and/or a pharmaceutical drug (i.e., a substance intended for use in the diagnosis, cure, mitigation, treatment, or prevention of disease).

According to further embodiments, disclosed herein is a dosage form, comprising a nervous system component, an immune system component and an endocrine system component. Suitable nervous system components include, but are not limited to gamma amino butyric acid, valerian root, 5-hydroxytryptophan, L-theanine, passionflower, lemon balm and combinations thereof. Suitable immune system components include, but are not limited to Ahi flower oil, MCT oil, Vitamin D3, an aromatic oil and combinations thereof. Suitable endocrine system components include, but are not limited to magnolia extract, phaelladendron extract, ashwagandha and combinations thereof.

As discussed above, suitable aromatic oils include, but are not limited to a plant terpene, lavender oil, chamomile oil, rose oil, hyssop oil, mint oil, peppermint oil, spearmint oil, wintergreen oil, clary sage oil, rosemary oil, ylang ylang oil, myrrh oil, vetiver oil, lemongrass oil, orange oil, grapefruit oil, lemon oil, frankincense oil, helichrysum oil, cedarwood oil, basil oil, melaleuca oil, arborvitae oil, patchouli, clove oil, cassia oil, oregano oil, rosemary oil, thyme oil, mango oil, juniper oil, cinnamon oil, pepper oil, lilac oil, nutmeg oil, cumin oil, pine oil, parsley oil, orchid oil, cannabis oil and combinations thereof.

As discussed above, the dosage form can be formulated for any suitable route of administration known to those of ordinary skill in the art. In embodiments, the dosage form can be in the form of a plurality of units, as discussed above, contained within a soft shell capsule, also as discussed above and as shown in FIGS. 3A and 3B. The dosage form may include a controlled release component, an immediate release component or a combination of controlled release and immediate release components as described above. In embodiments, the dosage form is free of at least one of melatonin, diphenhydramine, caffeine, cannabinoids, cypress oil, eucalyptus oil, tea tree oil, rose oil, sandalwood oil or a drug (e.g., a substance intended for use in the diagnosis, cure, mitigation, treatment, or prevention of disease).

Dosage forms according to embodiments herein may include a coating on a surface thereof. The coating can include a sensory disrupter, for example, at least one aromatic oil. Suitable aromatic oils include, but are not limited to a plant terpene, lavender oil, citrus oil, chamomile oil, rose oil, hyssop oil, mint oil, peppermint oil, spearmint oil, wintergreen oil, clary sage oil, rosemary oil, ylang ylang oil, myrrh oil, vetiver oil, lemongrass oil, orange oil, grapefruit oil, lemon oil, frankincense oil, helichrysum oil, cedarwood oil, basil oil, melaleuca oil, arborvitae oil, patchouli, clove oil, cassia oil, oregano oil, rosemary oil, thyme oil, mango oil, juniper oil, cinnamon oil, pepper oil, lilac oil, nutmeg oil, cumin oil, pine oil, parsley oil, orchid oil and cannabis oil. In embodiments, the coating comprises at least one of mint oil, lavender oil and citrus oil. Suitable plant terpenes include, but are not limited to myrcene, pinene, caryophyllene, limonene, terpinolene and combinations thereof.

Dosage forms according to embodiments herein can include at least one additional active ingredient (e.g., a drug). Suitable additional active ingredients include, but are not limited to an anti-anxiety drug, an antidepressant, a prodrug thereof, a cannabinoid, dronabinol, a pharmaceutically acceptable salt thereof and combinations thereof. Suitable anti-anxiety drugs include, but are not limited to a central nervous system depressant, a benzodiazepine, buspirone, buproprion, a prodrug thereof, a pharmaceutically acceptable salt thereof and combinations thereof. Suitable benzodiazepines include, but are not limited to alprazolam, chlordiazepoxide, clonazepam, diazepam, lorazepam, a prodrug thereof, a pharmaceutically acceptable salt thereof and combinations thereof.

Suitable central nervous system depressants include, but are not limited to a barbiturate, a prodrug thereof, a pharmaceutically acceptable salt thereof and combinations thereof. According to embodiments, the barbiturate includes at least one of secobarbital, butabarbital, mephobarbital, pentobarbital, phenobarbital, amobarbital, a prodrug thereof, a pharmaceutically acceptable salt thereof and combinations thereof. Suitable antidepressants include, but are not limited to a selective serotonin reuptake inhibitor (SSRI), a selective noradrenaline reuptake inhibitor (SNRI), a tricyclic, a monoamine oxidase inhibitor (MAOI), a beta-blocker, a sedative, a prodrug thereof, a pharmaceutically acceptable salt thereof and combinations thereof. According to embodiments, the SSRI can include at least one of citalopram, escitalopram, fluvoxamine, cerixamine, fenfluramine, paroxetine, dapoxetine, dapoxetine, fluoxetine, ifoxetine, vortioxetine, sertraline, vilazodone, cyanodothiepin, nefazodone, a prodrug thereof, a pharmaceutically acceptable salt thereof and combinations thereof.

Suitable SNRIs include, but are not limited to venlafaxine, desvenlafaxine, milnacipran, duloxetine, levomilnacipran, reboxetine, desipramine, maprotiline, lofepramine, mirtazapine, oxaprotilin, fezolamine, atomoxetine, bupropion, mianserin, duloxetine, a prodrug thereof, a pharmaceutically acceptable salt thereof and combinations thereof. Suitable tricyclics include but are not limited to clomiprmamine, imipramine, a prodrug thereof, a pharmaceutically acceptable salt thereof and combinations thereof. Suitable MAOIs include, but are not limited to socarboxazid, phenelzine, selegiline, tranylcypromine, a prodrug thereof, a pharmaceutically acceptable salt thereof and combinations thereof. According to embodiments, the beta-blocker can include at least one of propranolol, atenolol, a prodrug thereof, a pharmaceutically acceptable salt thereof and combinations thereof.

In yet further embodiments, disclosed herein are dosage forms, comprising the following ingredients: vitamin D3, Ahi flower, MCT oil, L-Theanine, 5-hydroxytryptophan, valerian root, a mixture of Phellodendron amurense and Magnolia officinalis, gama amino butyric acid, ashwagandha, beta caryophyllene, citrus oil and mint oil. According to embodiments, the dosage form is a pharmaceutically acceptable capsule comprising a combination of natural oils and components as described herein. Optionally, the capsule provides an immediate release of the natural oils and components. In embodiments, the capsule is translucent or clear. The ingredients can be in the form of a plurality of units, for example, the ingredients may be prepared as a granulation or powder and formed into compressed micro-tablets or extrudates. In embodiments, a first plurality of the plurality of units is a different color from a second plurality of the plurality of units, and optionally the plurality of units provide a controlled release of the ingredients. According to various embodiments, the dosage form comprises at least one additional active ingredient as described above. In embodiments, the dosage form is a daily formulation to be taken during the day in the afternoon to support the body during its stress response enabling it to balance its systems effectively to achieve allostasis and reduce stress eating. In embodiments, Vitamin D3 Oil can be present in an amount of about 5 mcg/unit to about 100 mcg/unit (i.e., per capsule, per tablet, per two capsules, per shot, etc.), Ahi flower Oil can be present in an amount of about 100 mg/unit to about 500 mg/unit, MCT Oil can be present in an amount of about 50 mg/unit to about 275 mg/unit, L-Theanine can be present in an amount of about 25 mg/unit to about 250 mg/unit, 5-Hydroxy tryptophan (5-HTP) (Griffonia simplicifolia), can be present in amount of about 2.5 mg/unit to about 10 mg/unit, Valerian Root Officinalis CO2 extract can be present in an amount of about 0.5 mg/unit to about 10 mg/unit, a mixture of Magnolia officinalis and Phellodendron amurense can be present in an amount of about 25 mg/unit to about 250 mg/unit, GABA can be present in an amount of about 25 mg/unit to about 250 mg/unit, Ashwagandha can be present in an amount of about 25 mg/unit to about 125 mg/unit, and Beta Caryophyllene can be present in an amount of about bout 0.5 mg/unit to about 10 mg/unit, where a unit is, for example, 1 capsule, tablet, shot, etc.

In yet further embodiments, disclosed herein are dosage forms, comprising vitamin D3, Ahi flower, MCT oil, passionflower, lemon balm, chamomile flower, valerian root, a mixture of Phellodendron amurense and Magnolia officinalis, gama amino butyric acid, ashwagandha, beta caryophyllene, lavender oil and mint oil. According to embodiments, the dosage form is a pharmaceutically acceptable capsule comprising a combination of natural oils and ingredients as described in embodiments above. In embodiments, the capsule provides an immediate release of the natural oils and ingredients. Optionally, the capsule is translucent or clear. The ingredients can be in the form of a plurality of units as described according to embodiments herein. In embodiments, a first plurality of the plurality of units is a different color from a second plurality of the plurality of units. The plurality of units can provide a controlled release of the ingredients. In embodiments, the dosage form can include at least one additional active ingredient according to embodiments described herein. In embodiments, the dosage form is a daily formulation to be taken once a day (e.g. in the afternoon) to help rebalance and support the body in achieving allostasis and reduce stress-eating. In embodiments, Vitamin D3 Oil can be present in an amount of about 5 mcg/unit to about 100 mcg/unit, Ahi flower oil in an amount of bout 100 mg/unit to about 500 mg/unit, MCT Oil in an amount of about 50 mg/unit to about 275 mg/unit, Passionflower (Passiflora incarnata) in an amount of about 5 mg/unit to about 100 mg/unit, Lemon Balm (Melissa officinalis) in an amount of about 5 mg/unit to about 50 mg/unit, Chamomile Flower (Matricaria chamomilla) CO2-extract (organic) in an amount of about 0.25 mg/unit to about 5 mg/unit, Valerian Root Officinalis CO2 extract in an amount of about 5 mg/unit to about 10 mg/unit, a mixture of Magnolia officinalis and Phellodendron amurense in an amount of about 25 mg/unit to about 250 mg/unit, GABA in an amount of about 25 mg/unit to about 250 mg/unit, Ashwagandha in an amount of about 25 mg/unit to about 125 mg/unit, and Beta Caryophyllene about 5 mg/unit to about 10 mg/unit, where a unit is, for example, a capsule, a tablet, a shot, etc.

In addition to the above ingredients, a dosage forms according to embodiments herein may also contain suitable quantities of other materials, e.g., diluents, lubricants, binders, granulating aids, colorants, flavorants and glidants that ate conventional in the pharmaceutical art.

Dosage forms according to embodiments herein can include, but are not limited to, at least one adaptogen, phytochemical, botanical, herb, spice, fruit, vegetable, flavonoid, bioactive flavonoid, fermented food, edible mushroom, antioxidant, lipid, biogenic, seed, hemp, non-wheat-based flour, extracts thereof and/or combinations thereof. Suitable adaptogens include, but are not limited to, ashwagandha, other substances considered to have an adaptogenic effect on stress, extracts thereof and/or combinations thereof. Suitable phytochemicals include, but are not limited to, a carotenoids, flavonoids, phenolic acid, isothiocyanate, prebiotic, probiotic, extracts thereof and/or combinations thereof.

Suitable botanicals include, but are not limited to, substances known to provide a positive effect on down regulating stress response, ashwagandha, rhodiola, extracts thereof and/or combinations thereof. Suitable herbs include, but are not limited to, substances known to provide a positive effect on down regulating stress response, lemon balm, holy basil, lavender, extracts thereof and/or combinations thereof. Suitable spices include, but are not limited to, black pepper, beta caryophyllene, extracts thereof and/or combinations thereof.

Suitable fruits include, but are not limited to, apple, orange, grapefruit, lemon, grape, grape seed, banana, dragon fruit, mango, avocado, blueberry, raspberry, blackberry, strawberry, marionberry, pineapple, olive, watermelon, kiwi, peach, guava, pomegranate and/or lychee in powder form, extracts thereof and/or combinations thereof. Suitable vegetables include, but are not limited to, spinach, broccoli, carrot, garlic, Brussel sprouts, kale, peas, swiss chard, beet, asparagus, red cabbage, sweet potato, collard greens and/or cauliflower in powder form or extracts thereof and/or combinations thereof.

Suitable flavonoids include, but are not limited to, catechins from green tea, curcumin from turmeric, grape seed procyanidins (which exert their anti-inflammatory and antioxidant effects through the activation of Nrf, inducing the antioxidant enzymes transcription, and the inhibition of NF-kB, key transcription factors in inflammatory responses), bioactive phytochemicals like triterpenes, centella saponin, asiaticoside, and sceffoleoside, asiatic acid, madecassic acid, phenolic acid avenanthramides and others that can affect Nrf2 and/or NF-κB pathways, salts thereof, solutes thereof, prodrugs thereof, extracts thereof and/or combinations thereof.

Suitable fermented foods include, but are not limited to, foods and/or beneficial extracts thereof that have enhanced nutritional and functional properties due to transformation of substrates and formation of bioactive or bioavailable end-products. Many fermented foods also contain living microorganisms of which some are genetically similar to strains used as probiotics. Fermented foods and beverages were among the first processed food products consumed by humans. The production of foods such as yogurt and cultured milk, wine and beer, sauerkraut and kimchi, and fermented sausage were initially valued because of their improved shelf life, safety, and organoleptic properties. It is increasingly understood that fermented foods can also have enhanced nutritional and functional properties due to transformation of substrates and formation of bioactive or bioavailable end-products. Many fermented foods also contain living microorganisms of which some are genetically similar to strains used as probiotics. Although only a limited number of clinical studies on fermented foods have been performed, there is evidence that these foods provide health benefits well-beyond the starting food materials.

Edible mushrooms are a novel protein source suitable as a functional food in dosage forms according to embodiments herein. Fast demographic growth has led to increasing interest in low-cost alternative protein sources to meet population needs. Consequently, scientific researchers have been focused on finding under-exploited sources of protein, alternative to those of animal origin. Usually plant proteins have been used for this purpose; however, most of them are not considered to be high quality due to their lack of some essential amino acids. Mushroom proteins usually have a complete essential amino acid profile, which may cover the dietetic requirements, as well as may have certain economic advantages as compared to animal and plant sources. Many mushrooms also have the ability to grow in agro-industrial waste, as submerged cultures, reaching high yields in a short period of time. Edible mushrooms can be processed to obtain a wide variety of food products enriched with high quality protein, which may have as well improved functional properties, giving them an added value. This review discusses the use of mushrooms as sustainable functional food.

Mushrooms can help manage stress. Some herbs, like ashwagandha, tulsi, and maca, are adaptogens that help the body adapt to both environmental and psychological stresses. But mushrooms (including cordyceps and reishi) can also be very effective adaptogens. This category of herbs supports the nervous, endocrine, and immune systems, and supports the adrenals, which are in charge of stress management. This class of herbs “helps rebuild and strengthen an empty tank” when you've run out of energy. Mushrooms also can help the immune system. All mushrooms contain a type of complex carb called beta-glucans that stimulates your immune system and helps suppress tumor growth. Mushrooms play both sides of the field in the immune system: On defense, mushrooms like cordyceps and turkey tail directly fight viruses and bacteria. These are called “immune stimulants.” On the offense, mushrooms (including reishi and shiitake) help nourish and even strengthen the immune system and its parts, like bone marrow or white blood cells. These mushrooms are called “immune tonics.”

Chaga mushrooms are useful for antioxidant protection and immune health. With a long history of use in Eastern Europe, chaga is considered a tonic (it helps in overall wellness/immune health) and has strong antioxidant properties. Chaga is used to ward off the common cold, support the skin and hair, and lower inflammation within the body typically caused by stress and is a powerful antitumor agent.

Cordyceps mushrooms are useful as adaptogens (energy, stamina, and endurance) and immune health. Their flavor and texture is tender and pleasant when fresh; mild when dried. They are usually extracted due to rarity. Used in China for stamina and energy for generations, cordyceps are now popular with athletes. It's an adaptogen that has a laundry list of traditional and modern uses—including fighting fatigue and boosting immune health. Cordyceps increase energy.

Lion's Mane mushrooms are useful for brain health, including memory and cognition. Its flavor and texture is like a cross between chicken and fish in both flavor and texture. It is mild and chewy, with a sweet scent. This mushroom actually looks like a lion's mane—it's white and shaggy. Lion's mane boosts memory and cognition (and may even improve mild cognitive impairment) and is considered to be a nootropic, or a cognitive enhancer. Recent research suggests that these brain health benefits may be due to Lion's Manes ability to upregulate Brain Derived Neurotrophic Factor (BDNF). It's another one that's gaining favor among athletes.

Maitake mushrooms are useful for boosting immune health and influencing blood sugar levels. They have a rich, meaty flavor yet a delicate texture; they are very juicy and woodsy. Reishi mushrooms are useful for stress, sleep, immune health, and lungs. Their bitterness is a sign of their potency. Maitake mushrooms must be extracted or made into tea. Reishi mushrooms have been used for 4,000 years in China and Japan traditionally as an adaptogen, to balance and support the endocrine system, and to promote healthy sleep. They may also be useful for cancer, diabetes and more.

Shiitake mushrooms are useful for immune health, antioxidant support, healthy skin and liver. They have a savory, rich, meaty and plentiful umami flavor. They are dense and chewy in texture, especially when broiled. Perhaps the best-known medicinal mushroom due to its long-term use as food, shiitake mushrooms are used to boost the immune system for ailments ranging from sniffles to tumors. Shiitake mushroom is a strong antitumor and antiviral as well as a potent immune-supporting agent.

Turkey Tail mushrooms are useful for immune support and liver protection. They have a bitter and earthy flavor and must be extracted. Turkey tail mushrooms have been extensively researched and are actually used with standard cancer treatments in Japan. Turkey tail mushrooms have been traditionally used for cholesterol, liver health, and immune health. Turkey tail mushrooms help aid digestion and are an immune system supporter for infections. It can be used for acute infections, boosting deep immunity, and to protect the liver.

Suitable antioxidants include, but are not limited to, vitamin C, pomegranate, blueberries, extracts thereof, and/or combinations thereof. Suitable lipids include, but are not limited to, short chain triglycerides, medium chain triglycerides (MCT's), long-chain fatty acids, omega-3 fatty acids, extracts thereof and/or combinations thereof. Suitable biogenics include, but are not limited to, biologically active peptides, immunopotentiators (biological response modifier: BRM), plant flavonoids, extracts thereof and/or combinations thereof. Suitable seeds include, but are not limited to, chia, flax, sprouted sunflower, extracts thereof and/or combinations thereof.

Dosage forms according to embodiments also can include hemp in various forms, including but not limited to, hemp hearts, hemp powder, hemp protein, extracts thereof and/or combinations thereof. Suitable non-wheat based flour includes, but is not limited to, oat, lupin, chickpea, Einkorn, potato, buckwheat, Tapioca, Masa Harina, Brown Rice, Mochiko, Light Rye, Light Rye, Barley, Farro, Kamut®, Seven-Grain Flour, Spelt, Teff, Triticale and/or combinations thereof.

In some embodiments, functional foods suitable for stress eating dosage forms as described herein can be those foods with digestion-enhancing properties. Recent advances in intestinal microbiota research are the background for the appearance of functional foods. Lactic fermentation products are included in functional foods and classified into three (3) groups based on their mechanisms of action: probiotics, prebiotics and biogenics. Probiotics are viable microorganisms, such as lactobacilli and bifidobacteria that beneficially affect the host by improving the intestinal bacterial balance.

Prebiotics are nondigestible food ingredients, such as oligosaccharides and dietary fiber that beneficially affect the host by selectively stimulating the growth or activities of beneficial intestinal bacteria in the colon and thus improve health. Biogenics are biologically active peptides, including immunopotentiators (biological response modifier: BRM), plant flavonoids, etc. They act directly or indirectly through modulation of intestinal microbiota on the health of the hosts. Thus, functional foods enhance bioregulation such as stresses, appetite and absorption; biodefence, such as immunity and suppression of allergies; prevent diseases, including diarrhea, constipation, cancer, cholesterolemia and diabetes; and suppress aging through immunostimulation as well as suppression of mutagenesis, carcinogenesis, oxidation processes, intestinal putrefaction, and cholesterolemia.

The interrelated antioxidant and anti-inflammatory role of fruits, vegetables, herbs, spices and cocoa in humans can also be useful in combination in dosage forms according to embodiments herein. The regulation of endogenous antioxidant defenses, including superoxide dismutase (SOD), catalase (CAT) and glutathione peroxidase (GPX), involves the interaction with antioxidant responsive elements (ARE) which are present in the promoter regions of most of the genes inducible by oxidative stress. In particular, nuclear factor-erythroid 2-related factor 2 (Nrf2) is the transcription factor responsible for both constitutive and inducible expression of are regulated genes. Under physiological conditions, Nrf2 is bound to kelch-like protein-1 (KEAP1) and is thereby sequestered in the cytoplasm; however, in the presence of oxidative stress, Nrf2 dissociates from KEAP1, translocates into the nucleus and induces the transcription of antioxidant enzymes. Oxidative stress represents also a key stimulus for the activation of nuclear factor-kappa B (NF-κB), which appears in the cytoplasm of non-stimulated cells forming a complex with its inhibitor IκB.

Following stimulation, NF-κB is activated by phosphorylation and degradation of IκB, thus migrating to the nucleus, stimulating gene expression and inducing the synthesis of inflammatory cytokines. The close link between oxidative and inflammatory stress in the mechanisms of body defenses against stress, is further highlighted in the oxidative burst of leucocytes, the innate immune response involving the activation of NADPH-oxidase (NOX) and myeloperoxidase (MPO) yielding a massive production of Reactive Oxygen Species (ROS) and Reactive Nitrogen Species (RNS). However, the presence of an excessive and uncontrolled ROS and cytokines production, a condition defined as “low-grade chronic inflammation” takes place and is associated with pre-pathological conditions such as obesity and degenerative diseases.

Inflammatory and oxidative stress can rise also as a direct consequence of unbalanced dietary life style, such as the ingestion of high fat and high carbohydrate meals. Increase in postprandial lipopolysaccharide (LPS) and Toll-like receptor-4 (TLR4) is associated with increased levels of inflammatory cytokines, such as interleukin (IL)-6, IL-17 and tumor necrosis factor-alpha (TNF-α), which in turn activate oxidative burst.

Given these premises, the importance of the diet, as inducer or preventer of inflammatory and oxidative stress, is paramount. A large body of epidemiological and clinical evidence provides a solid rationale for the health benefits of diets based on foods of vegetable origin, thanks to their content of bioactive ingredients such as vitamins and flavonoids. In fact, flavonoids and their metabolites, in addition to their direct free radical scavenging capacity, impair the production of ROS and RNS by neutrophils and other phagocytic cells through the inhibition of NOX, MPO and inducible-Nitric Oxide Synthases (iNOS). However, herbs and spices used for culinary purposes also represent an excellent, source of phytochemicals. Antioxidant and anti-inflammatory activities have been reported in vitro and in animal models for ginger (Zingiber officinale), milk thistle (Silybum marianum), hawthorn (Crataegus monogyna), passion flower (Passiflora edulis) and chamomile (Matricaria chamomilla). Therefore the health benefits of plant food-based diets could be related to both integrated antioxidant and anti-inflammatory mechanisms exerted by a wide array of phytochemicals present in fruit, vegetables, herbs and spices. On this basis, there is mounting interest in identifying foods, food extracts and phytochemicals formulations from plant sources which are able to efficiently modulate oxidative and inflammatory stress to prevent diet related diseases.

Free radicals, antioxidants and functional foods can have an impact on human health. In recent years, there has been a great deal of attention toward the field of free radical chemistry. Free radicals reactive oxygen species and reactive nitrogen species are generated by our body by various endogenous systems, exposure to different physiochemical conditions or pathological states. A balance between free radicals and antioxidants is necessary for proper physiological function. If free radicals overwhelm the body's ability to regulate them, a condition known as oxidative stress ensues. Free radicals thus adversely alter lipids, proteins, and DNA and trigger a number of human diseases. Hence application of external source of antioxidants can assist in coping this oxidative stress. Synthetic antioxidants such as butylated hydroxytoluene and butylated hydroxyanisole have recently been reported to be dangerous for human health. Thus, the search for effective, nontoxic natural compounds with antioxidative activity has been intensified in recent years. The present review provides a brief overview on oxidative stress mediated cellular damages and role of dietary antioxidants as functional foods in the management of human diseases.

In yet further embodiments, disclosed herein are dosage forms suitable for reducing stress eating cravings that contain: ashwagandha, chromium (e.g., chromium picolinate), beta caryophyllene, cayenne pepper extract, L-theanine, vitamin D3 and/or apple cider vinegar, salts thereof, solutes thereof, prodrugs thereof, extracts thereof and/or combinations thereof. Capsaicin (cayenne pepper extract) can boost metabolism. Capsaicin increases the amount of heat the body produces, causing it to burn more calories per day. It does this through a process called die-induced thermogenesis, which causes an increase in metabolism. In one study, people who ate a breakfast containing capsaicin and medium-chain triglyceride oil burned 51% more calories during that meal, compared to people who had neither for breakfast. But while capsaicin helps boost metabolism, the overall effect is small. In another study, people who ate one (1) gram of red cayenne pepper only burned 10 more calories over four and a half hours, compared to those who did not eat any cayenne pepper.

Capsaicin also can help reduce hunger, helping the subject to eat less and feel fuller for longer. Many studies show the capsaicin in cayenne peppers helps reduce hunger. How it does this is not completely understood, but one study showed that it reduces the production of the hunger hormone ghrelin. One study showed that people taking capsaicin ate less food throughout the day than those who did not take any. Specifically, those taking capsaicin supplements ate 10% less, while those who drank a capsaicin-containing beverage ate 16% less. People in the same study also reported feeling fuller, while eating fewer calories.

Capsaicin also may lower blood pressure. High blood pressure is a huge health risk worldwide. In fact, over 40% of adults over 25 have high blood pressure. Interestingly, animal studies have shown that the capsaicin in cayenne peppers may reduce high blood pressure. One study in mice with high blood pressure showed that the long-term consumption of dietary species containing capsaicin helped reduce blood pressure. Another study showed that capsaicin helped relax blood vessels in pigs, leading to lower blood pressure. It's important to note that the findings are based on animals and capsaicin's effects may differ in humans.

Capsaicin also may aid digestive health. Dietary spices and their active components may provide many benefits for the stomach. For example, cayenne pepper may help boost the stomach's defense against infections, increase digestive fluid production and help deliver enzymes to the stomach, aiding digestions. It does this by stimulating nerves in the stomach that signal for protection against injury. While some believe that spicy food may cause stomach ulcers, a review paper has shown that the capsaicin in cayenne peppers may actually help reduce the risk of stomach ulcers.

Beta caryophyllene benefits also can help reduce stress eating cravings. Due to its unique ability to bind with CB2 receptors, beta-caryophyllene has potent anti-inflammatory, antimicrobial, antibacterial, and antioxidant properties. It is known to help relieve anxiety and pain, reduce cholesterol, prevent osteoporosis, and treat seizures. Also, some research has shown that it may help against certain neurodegenerative diseases and cancers.

Foods high in chromium also can help reduce stress eating cravings. Suitable sources of chromium include, but are not limited to, broccoli, liver and brewer's yeast, potatoes, whole grains, seafood, meats, grape juice, turkey breast, green beans, red wine, extracts thereof and/or combinations thereof. Chromium is an essential trace mineral that can improve insulin sensitivity and enhance protein, carbohydrate, and lipid metabolism. It is a metallic element that people need very small quantities. The adequate intake of chromium for ages nine (9) years and above ranges from about 21 to about 25 micrograms per day for females and about 25 to about 35 micrograms per day for men. For infants and children, the recommended intake is up to six (6) months: about 0.2 mcg/day, from seven (7) to 12 months: about 5.5 mcg/day, from one (1) to three (3) years: about 11 mcg/day, and from four (4) to eight (8) years: about 15 mcg/day. There is no accurate measure of chromium nutritional status, but chromium deficiency in humans is rare.

Chromium picolinate interferes with the absorption of thyroid medications. Thyroid medication should taken at least three (3) to four (4) hours before or after any chromium supplement. Supplemental chromium can interact with antacids, corticosteroids, H2 blockers, proton pump inhibitors, beta-blockers, insulin, nicotinic acid, non-steroidal anti-inflammatory drugs and prostaglandin inhibitors. People who are using any of these drugs, and those with diabetes should seek medical advice before taking chromium supplements. Chromium-containing dosage forms should not be taken during pregnancy or breastfeeding.

Chromium picolinate in the amount of about 600 mcg to about 1,000 mcg can help reduce carbohydrate cravings, food cravings, appetite, food intake, body fat and/or caloric intake by about 374 calories per day in healthy, increases satiety, carbohydrate metabolism, overweight adult women with carbohydrate cravings, positively impacts hunger levels, healthy mood, positive mood, promotes carbohydrate metabolism, improves blood sugar metabolism, healthy metabolism, improves lean body mass, helps maintain healthy blood sugar, maintain muscle during weight loss, improves body composition, can positively impact body composition, supports cognitive function, learning recall, recognition, supports brain glucose transporter function, contributes to improved glucose metabolism and/or memory tasks and/or can help manage hunger levels.

It should be noted that ingredients described herein with respect to dosage forms are also suitable for use in foods and stressed gut formulations according to various embodiments herein. In some embodiments, foods are formulated to contain sensory disrupters, stress busters, calming relievers, functional foods and/or excipients as described herein in various embodiments. Suitable foods include, but are not limited to taffy (e.g., “Tootsie Roll®” style), gummy, jaw breaker style, cookie, healthy energy ball, no bake ball, healthy energy squares, no back squares, bars, layered pyramid, sachet, tea, extrusion (e.g., Cheete-style), dehydrated fruit-style, baked, raw, granola, veggie chip, brownie, meal replacement shake or bar, kale chip, carrot chip, tortilla chip, potato chip, sweet potato chip, plantain chip, cassava chip and/or combinations thereof. Foods according to embodiments herein can have any suitable texture including, but not limited to, chewy, crispy, soft, creamy and/or powder.

Functional food dosage forms according to embodiments herein can be prepared in a stressed gut formulation. The stressed gut formulation may be formulated with all-natural ingredients to provide prebiotic and postbiotic support for an individual's unique microbiome. Stressed gut formulations may additionally include proven botanicals to manage stress and reduce gastrointestinal-related issues. In some embodiments, the stressed gut formulation includes, but is not limited to, licorice root, ginger root, peppermint leaf (oil), valerian root, black pepper (beta-caryophyllene), shiitake mushroom, reishi mushroom, turkey tail mushroom, chaga mushroom, extracts thereof and/or combinations thereof.

In some embodiments, the stressed gut formulation comprises two phases: a liquid phase and a dry phase. The liquid phase may be a liquid fill formulation for a capsule. Suitable ingredients for the liquid fill phase include, but are not limited to, about 1 mg to about 20 mg beta-caryophyllene, about 5 mg to about 50 mg peppermint oil, Menthe arvensis, about 10 mg to about 60 mg flaxseed oil, Linum usitatissimum, about 150 mg to about 350 mg organic grape seed oil, Vitis vinifera, and/or combinations thereof and/or any individual value or sub-range within these ranges. The dry phase may be in any suitable form as described herein. In some embodiments, the dry phase is in powder form. Suitable ingredients for the dry phase include, but are not limited to about 10 mg to about 50 mg valerian root extract (or about 100 mg to about 500 mg plant equivalent), Valeriana officinalis, about 50 mg to about 300 mg GutGard® licorice extract, Glycyrrhiza glabra, about 25 mg to about 125 mg OrMiu-GutHealth™ organic functional mushroom blend (Ganoderma lucidum, Trametes versicolor, Inonotus obliquus, Lentinula edodes), or, mushrooms may be added as individual ingredients (vs. a blend) in a range of 5-100 mg's each, about 20 mg to about 100 mg ginger root extract (or about 200 mg to about 500 mg plant equivalent), Singiber officinale, about 1 mg to about 30 mg microcrystalline cellulose, about 0.5 mg to about 20 mg magnesium stearate, and/or combinations thereof, and/or any individual value or sub-range within these ranges.

In some embodiments, stressed gut dosage forms can include a “stress support stack” including, but not limited to, valerian root, turkey tail mushroom, licorice root and black pepper. Valerian root provides stress support for the nervous system. Turkey tail mushrooms support a healthy immune system. Licorice root modulates cortisol within the endocrine system in addition to its effects on the gastrointestinal system (i.e., fullness, pain, bloating, belching). Black pepper (beta-caryophyllene) supports the nervous and endocannabinoid systems and has anti-inflammatory properties.

In some embodiments, stressed gut dosage forms alternatively or additionally include “a gardening stack” including, but not limited to, organic reishi, chaga and shitake mushrooms, licorice root, peppermint leaf oil, grape seed oil and flax seed oil. Reishi, chaga and shiitake mushrooms provide pre- and postbiotic support to help restore and promote growth of healthy gut microflora via their high beta-glucan content. Licorice root helps manage daily gut health issues relating to fullness, pain, bloating, belching, relief from meal triggered indigestion and supports management of H. pylori. Peppermint leaf oil provides soothing aromatic herb support of the digestive system. Flax seed oil provides beneficial omega-3 oils (DHA/EPA). could also be used in such preparation.

### Sensory Disrupters

A sensory disrupter is a component, composition and/or action that targets smell, sight, touch, feel and/or taste. In embodiments, sensory disrupters that target smell include, but are not limited to aromatic oils according to embodiments described herein. In certain embodiments, a sensory disrupter targeting smell comprises at least one of linalool, limonene, caryophyllene and combinations thereof. Sensory disrupters targeting sight include the visual appearance of the dosage form including, but not limited to micro-tablets within a clear capsule, a capsule within a capsule, the colors of the micro-tablets, the colors of the capsule, etc. and combinations thereof. Sensory disrupters targeting touch and feel include, but are not limited to rubbing, massaging, gels, creams, ointments, cooling, warming and combinations thereof. Sensory disrupters that target taste include, but are not limited to cooling flavors or terpenes (e.g., menthol, menthol-like, etc.), warming flavors or terpenes (e.g., caryophyllene), citrus and lemon (e.g., limonene) and lavender (e.g., linalool).

In particular, with respect to touch and feel, in people with the movement disorder cervical dystonia, a condition where various neck/shoulder muscles are chronically retracted leading to disfigurement and significant pain, the person temporarily interrupts the motor nerve inputs using a “trick” or what is referred to as a “geste atagoniste.” These tricks, which have many variations, apply a physical stimulus to and/or by the person. For example, the physical stimulus can include squeezing the wrist or arm, pressing on a muscle within the unaffected side of the neck or shoulder, which temporarily interrupts the physiologic signals to the affected muscles and/or touching a region on the person's face. Studies have shown that there is a physiologic down regulation that occurs simply by applying a sensory stimulus.

Another example of a sensory disrupter is when a toddler falls down and suddenly realizes it and begins to cry. The parent will provide a stimulus, either vocally—a soothing sound of the mother's voice, or physically—the mother picks up and holds the toddler. As a result, the sensory disrupter is enough to interrupt the toddler's current stress level triggered by the fall.

Yet another example of a sensory disrupter relates to a person who suffers chronic hyperemesis syndrome (CHS)—a condition defined by symptoms including significant nausea, vomiting and abdominal pain in the setting of chronic cannabis use. These patients find temporary relief by taking multiple very-hot water showers throughout the day—a sensory component to treat a central condition. Relief of CHS symptoms with very hot water (greater than 41° C.) has highlighted a peripheral tissue receptor called TRPV1, a G-protein coupled receptor that has been shown to interact with the endocannabinoid system, but is also the only known capsaicin receptor. The result is a temporary down-regulation of the overactive autonomic nervous system.

Dosage forms according to embodiments herein, can include one or more functional food ingredients. Suitable functional food ingredients include, but are not limited to those shown in Table 1.

TABLE 1
Suitable Functional Food Ingredients for Dosage Forms

| | | | | | | | |
|---|---|---|---|---|---|---|---|
| | | | Nutritional | Physical | Water | Good | |
| Class | Ingredient | Dosage | Benefit | State | Sol. | Flavor | Sources |

Neurotransmitters (CNS): Transmitter and Receptors

| Neurotransmitter | Vitamin B1 | 1.2 mg | | Optimizes | Powder | Y | Y | Thiamine |
|---|---|---|---|---|---|---|---|---|
| | (Thiamine) | (RDI)- | | mental and | | | | Mononitrate |
| | | 100 mg | | physical health | | | | (80%) |
| | | | | by increasing | | | | |
| | | | | energy | | | | |
| | | | | metabolism | | | | |
| | | | | and nerve cell | | | | |
| | | | | function | | | | |
| Neurotransmitter | Vitamin B3 | 16 mg | | Supports | Powder | Y | Y | Niacin, |
| | (Niacin) | (RDI)- | | carbohydrate | | | | Niacinamide |
| | | 500 mg | | metabolism & | | | | (98%) |
| | | | | supports | | | | |
| | | | | healthy blood | | | | |
| | | | | lipid levels | | | | |
| Neurotransmitter | Vitamin B5 | 5 mg | | Plays an | Powder | Y | Y | Calcium |
| | (Pantothenic | (RDI)- | | essential role | | | | Pantothenic |
| | Acid) | 250 mg | | in adrenalin | | | | Acid |
| | | | | production and | | | | (90%) |
| | | | | carbohydrate | | | | |
| | | | | metabolism | | | | |
| Neurotransmitter | Vitamin B6 | 1.7 mg | | Supports | Powder | Y | Y | Pyridoxine |
| | (Pyridoxine) | (RDI)- | | cardio health, | | | | HCL |
| | | 100 mg | | energy | | | | (82%) |
| | | | | metabolism | | | | |
| | | | | and the normal | | | | |
| | | | | breakdown of | | | | |
| | | | | fats, proteins | | | | |
| | | | | and etc. | | | | |
| Neurotransmitter | Vitamin B9 | 400 mcg | | Essential for | Powder | Y | Y | Quatrefolic |
| | (Folic Acid) | (RDI)- | | prenatal health | | | | (54% Folate/ |
| | | 1,000 mcg | | and heart | | | | 90% DFE) |
| | | | | health | | | | |
| Neurotransmitter | Vitamin B12 | 2.4 mcg | | Supports | Powder | Y | Y | Methylcobalamin, |
| | (Cyanocobalamin) | (RDI)- | | energy | | | | Cyanocobalamin |
| | | 2,500 mcg | | metabolism | | | | 1-98% |
| | | | | and is an | | | | |
| | | | | essential for | | | | |
| | | | | nervous | | | | |
| | | | | system | | | | |
| | | | | function | | | | |
| Neurotransmitter | Inositol | 650 | mg | Required for | Powder | Y | Y | Inositol |
| | (myo- | | | the formation | | | | 98% |
| | inositol) | | | of cellular | | | | |
| | | | | membranes | | | | |
| | | | | and healthy | | | | |
| | | | | nerve | | | | |
| | | | | transmission | | | | |
| Neurotransmitter | Vitamin H | 30 mcg- | | Supports | Powder | Y | Y | Biotin |
| | (Biotin) | 10,000 mcg | | healthy skin, | | | | 5-98% |
| | | | | hair, nails and | | | | |
| | | | | metabolism | | | | |
| Neurotransmitter | Vitamin C | 90 mg | | Immune | Powder | Y | Y | Ascorbic |
| | (Ascorbic | (RDI)- | | system support | | | | Acid 98%, |
| | Acid) | 1,000 mg | | | | | | Calcium |
| | | | | | | | | Ascorbate 87% |
| Neurotransmitter | Vitamin D3 | | | Helps (to) | | | | |
| | | | | maintain/support | | | | |
| | | | | immune | | | | |
| | | | | function. Vits | | | | |
| | | | | have shown to | | | | |
| | | | | increase or | | | | |
| | | | | maintain | | | | |
| | | | | microbial | | | | |
| | | | | diversity | | | | |
| | | | | (vit A, B2, | | | | |
| | | | | B3, C, K) and | | | | |
| | | | | richness | | | | |
| | | | | (vit D); | | | | |
| | | | | Vit A and D: | | | | |
| | | | | modulate the | | | | |
| | | | | gut immune | | | | |
| | | | | response or | | | | |
| | | | | barrier | | | | |
| | | | | function | | | | |
| Nerve Function | Calcium | 1300 mg | | Helps build | Powder | Y | N | Calcium |
| | | (RDI) | | and support | | | | Carbonate |
| | | | | strong bones | | | | 39% |
| | | | | and promotes | | | | |
| | | | | energy | | | | |
| | | | | production and | | | | |
| | | | | muscle | | | | |
| | | | | relaxation | | | | |
| Nerve Function | Magnesium | 150-420 mg | | healthy blood | Powder | Y | Y | Dimagnesium |
| | | (RDI) | | pressure and | | | | malate |
| | | | | glucose levels | | | | (20%), |
| | | | | and is essential | | | | Magnesium |
| | | | | for strong | | | | Oxide |
| | | | | muscles, bones | | | | (60%) |
| | | | | and | | | | |
| | | | | cardiovascular | | | | |
| | | | | health | | | | |
| Neurotransmitter | GABA | 100-500 | mg | Promotes | Powder | Y | Y | GABA |
| (5HT and Gaba) | | | | relaxation and | | | | 98% |
| | | | | eases nervous | | | | |
| | | | | tension; | | | | |
| | | | | supports | | | | |
| | | | | restful and | | | | |
| | | | | restorative | | | | |
| | | | | sleep | | | | |
| Neurotransmitter | L-phenylalanine | 375-750 | mg | Specialized for | Powder | Y | Y | |
| (5HT and Gaba) | | | | dietary support | | | | |
| | | | | and | | | | |
| | | | | neurotransmitter | | | | |
| | | | | function | | | | |
| Neurotransmitter | L-tyrosine & | 100-500 | mg | A key | Powder | Y | Y | |
| (5HT and Gaba) | 5HTP | | | componenet in | | | | |
| | | | | maintaining | | | | |
| | | | | healthy mental | | | | |
| | | | | function and | | | | |
| | | | | support of | | | | |
| | | | | nervous | | | | |
| | | | | system, | | | | |
| | | | | relaxation | | | | |
| Neurotransmitter | L-theanine | 100-200 | mg | Supports | Powder | Y | Y | 98% |
| (5HT and Gaba) | (Theanine) | | | balanced | | | | |
| | | | | mental health | | | | |
| | | | | and emotions | | | | |
| | | | | while | | | | |
| | | | | maintaining a | | | | |
| | | | | feeling of calm | | | | |
| | | | | and ease of | | | | |
| | | | | nervous | | | | |
| | | | | tension | | | | |
| Neurotransmitter | TheaKalm | 100-200 | mg | Supports | Powder | Y | Y | |
| (5HT and Gaba) | Pure L- | | | serotonin | | | | |
| | Theanine | | | production | | | | |
| | (Green Tea | | | (Branded | | | | |
| | Extract) | | | theanine) | | | | |
| Neurotransmitter | L-Glutamine | 500-5,000 | mg | Supports | Powder | Y | Y | |
| (5HT and Gaba) | (Glutamine) | | | muscle growth | | | | |
| | | | | and recovery | | | | |
| | | | | while | | | | |
| | | | | maintaining a | | | | |
| | | | | healthy | | | | |
| | | | | memory and | | | | |
| | | | | cognitive | | | | |
| | | | | function | | | | |
| Neurotransmitter | L-Glycine | 500 | mg | Plays a crucial | Powder | Y | Y | |
| (5HT and Gaba) | (Glycine) | | | role in the | | | | |
| | | | | synthesis of | | | | |
| | | | | proteins, | | | | |
| | | | | peptides and | | | | |
| | | | | etc. | | | | |
| Neurotransmitter | L-Taurine | 500-1,000 | mg | Helps the body | Powder | Y | Y | 98% |
| (5HT and Gaba) | (Taurine) | | | maintain | | | | |
| | | | | electrolyte | | | | |
| | | | | balance | | | | |
| | | | | especially | | | | |
| | | | | during | | | | |
| | | | | strenuous | | | | |
| | | | | activity | | | | |
| Neurotransmitter | L-Threonine | 500 | mg | Supports | Powder | Y | Y | |
| (5HT and Gaba) | (Threonine) | | | nervous | | | | |
| | | | | system | | | | |
| | | | | function | | | | |
| Cholinergic/ | Hops | 10-500 | mg | Helps keeps | Powder/ | Y | N | |
| Nootropic | | | | you calm and | Oil | | | |
| | | | | relaxed | | | | |
| Cholinergic/ | Gotu Kola | 100-2,000 | mg | An ancient | Powder | Y | N | |
| Nootropic | | | | energizing | | | | |
| | | | | herb that helps | | | | |
| | | | | keep the | | | | |
| | | | | vascular | | | | |
| | | | | system healthy | | | | |
| | | | | and promotes | | | | |
| | | | | even blood | | | | |
| | | | | flow | | | | |
| Cholinergic/ | DMAE | 250-350 | mg | Supports brain | Powder | Y | Y | DMAE |
| Nootropic | | | | function/ | (bitartate), | | | Liquid, |
| | | | | neuro | Liquid | | | DMAE |
| | | | | transmitter | (DMAE) | | | Bitartate |
| | | | | production | | | | |
| Cholinergic/ | Ginkgo | 60-120 | mg | Supports | Powder | Y | N | Gingko |
| Nootropic | | | | mental | | | | 24/6 |
| | | | | memory and | | | | Extract |
| | | | | mental | | | | |
| | | | | alertness | | | | |
| Cholinergic/ | Citicoline | 250-500 | mg | Helps fight | Powder | Y | Y | Cognizin |
| Nootropic | | | | age-related | | | | 98% |
| | | | | cognitive | | | | |
| | | | | decline while | | | | |
| | | | | maintaining | | | | |
| | | | | memory and | | | | |
| | | | | cognitive | | | | |
| | | | | function | | | | |
| Cholinergic/ | Maté | 125-600 | mg | Boosts energy | Powder | Y | Y | |
| Nootropic | | | | and vitality | | | | |
| Cholinergic/ | Sage | 160 | mg | Free radical | Powder | Y | N | |
| Nootropic/1 mm | | | | scavenger for | | | | |
| | | | | total body | | | | |
| | | | | health; | | | | |
| | | | | Anxiolytic | | | | |
| | | | | effects: In | | | | |
| | | | | animal | | | | |
| | | | | research, | | | | |
| | | | | rosmarinic | | | | |
| | | | | acid, a | | | | |
| | | | | constituent of | | | | |
| | | | | sage, produced | | | | |
| | | | | anxiolytic-like | | | | |
| | | | | effects in | | | | |
| | | | | lower doses | | | | |
| Benzodiazepine | Passion | 500 | mg | Helps fight the | Powder | Y | Y | |
| Receptor | Flower | | | effects of | | | | |
| | | | | stress | | | | |
| Benzodiazepine | Chamomile | 350-500 | mg | Soothing & | Powder/ | Y | Y | Powder or |
| Receptor | | | | comforting | Oil | | | Co2 Extract |
| Benzodiazepine | Valerian | 200-500 | mg | Promotes | Powder/ | Y | N | Powder or |
| Receptor | Root | | | calmness and | Oil | | | Co2 Extract |
| | | | | relaxation | | | | |
| | | | | along with | | | | |
| | | | | support of a | | | | |
| | | | | restful sleep | | | | |
| Benzodiazepine | Skullcap | 400-1,600 | mg | Supports a | Powder | Y | Y | |
| Receptor | | | | good nights' | | | | |
| | | | | sleep | | | | |
| Benzodiazepine | Proloftin | | | Phosphatidylserine, | Powder | Y | Y | |
| Receptor | | | | L-theanine, | | | | |
| | | | | magnolia bark, | | | | |
| | | | | rhodiola and | | | | |
| | | | | beta-sitosterol | | | | |
| Benzodiazepine | Lactium | 167 | mg | A casein- | Powder | Y | Y | |
| Receptor | | | | derived | | | | |
| | | | | peptide that | | | | |
| | | | | helps counter | | | | |
| | | | | the negative | | | | |
| | | | | physiological | | | | |
| | | | | effects of | | | | |
| | | | | stress/anxiety | | | | |
| Benzodiazepine | Pregnenolone | 10-100 | mg | Powerful | Powder | Y | Y | |
| Receptor | | | | hormonal | | | | |
| | | | | precursor that | | | | |
| | | | | supports | | | | |
| | | | | healthy brain | | | | |
| | | | | function | | | | |
| Serotonin | Bacopa | 50-500 | mg | Supports | Powder | Y | Y | 20% |
| | | | | memory, | | | | Bacopa |
| | | | | mental focus | | | | Extract |
| | | | | and a normal | | | | |
| | | | | response to | | | | |
| | | | | daily stress | | | | |
| Serotonin | Griffonia | 50-200 | mg | Increases | Powder | Y | Y | 95% |
| | Simplicifolia | | | levels of | | | | 5HTP |
| | | | | serotonin | | | | |
| Serotonin | Kanna | 25-350 | mg | Dopamine and | Powder | Y | N | |
| | | | | serotonin | | | | |
| | | | | receptors | | | | |

Immune/Central Nervous System

| | | | | | | | | |
|---|---|---|---|---|---|---|---|---|
| Adaptogens | Reishi | 300-650 | mg | Maintains | Powder | Y | Y | |
| | | | | immune health | | | | |
| | | | | and supports | | | | |
| | | | | liver health | | | | |
| | | | | and | | | | |
| | | | | detoxification | | | | |
| Adaptogens | Lion's | 500 | mg | Supports | Powder | Y | Y | |
| | Mane | | | balanced | | | | |
| | | | | mental health | | | | |
| | | | | and maintains | | | | |
| | | | | a feeling of | | | | |
| | | | | calm while | | | | |
| | | | | remaining alert | | | | |
| Adaptogens | Turkey | 500-1,000 | mg | Maintains | Powder | Y | Y | |
| | Tail | | | immune health | | | | |
| | | | | and promotes | | | | |
| | | | | cellular health | | | | |
| Adaptogens | Korean | 250-1,000 | mg | Supports a | Powder | Y | Y | |
| | Ginseng | | | healthy and | | | | |
| | | | | natural | | | | |
| | | | | response to | | | | |
| | | | | stress to | | | | |
| | | | | promote | | | | |
| | | | | immune health | | | | |
| Adaptogens | Eleuthero | 425-2,000 | mg | Fights stress | Powder | Y | Y | |
| | | | | and energizes | | | | |
| | | | | body and mind | | | | |
| Adaptogens | Suma | 400-2,000 | mg | Promotes | Powder | Y | Y | |
| | | | | endurance and | | | | |
| | | | | increased | | | | |
| | | | | vitality | | | | |
| Adaptogens | American | 300-2,000 | mg | Boosts mental | Powder | Y | Y | |
| | Ginseng | | | and physical | | | | |
| | | | | energy by | | | | |
| | | | | delivering | | | | |
| | | | | potent stress- | | | | |
| | | | | fighting | | | | |
| | | | | properties | | | | |
| Adaptogens | Ashwagandha | 125-500 | mg | Promotes | Powder | Y | Y | KSM 66 |
| | | | | calmness and | | | | (600 mg), |
| | | | | relaxation | | | | Sensoril |
| | | | | while | | | | 125 mg |
| | | | | supporting a | | | | |
| | | | | healthy | | | | |
| | | | | response to | | | | |
| | | | | daily stress | | | | |
| Adaptogens | Rhodiola | 100-500 | mg | Fights the | Powder | Y | Y | Rhodiola |
| | (Artic | | | physical and | | | | 3% |
| | Root) | | | mental effects | | | | |
| | | | | of stress | | | | |
| Adaptogens | Rehmannia | 500-1,000 | mg | Adrenal tonic | Powder | Y | Y | |
| | Extract | | | | | | | |

Adrenal/Corticosteroid

| Cortisol Adrenal | Proloftin | | | Phosphatidyl | Powder | Y | Y | |
|---|---|---|---|---|---|---|---|---|
| Support | | | | serine, L- | | | | |
| | | | | theanine, | | | | |
| | | | | magnolia bark, | | | | |
| | | | | rhodiola and | | | | |
| | | | | beta-sitosterol | | | | |
| Cortisol Adrenal | Relora | 250 mg | | Magnolia/ | Powder | Y | N | |
| Support | | BID | | Phaelladendron | | | | |
| | | | | Extract - | | | | |
| | | | | relaxation and | | | | |
| | | | | anxiety | | | | |
| | | | | reduction | | | | |
| Cortisol Adrenal | Licorice | 300-2,000 | mg | Supports the | Powder | Y | N | |
| Support | | | | liver and | | | | |
| | | | | respiratory | | | | |
| | | | | system; | | | | |
| | | | | cleanses colon | | | | |
| Cortisol Adrenal | Schisandra | 500-2,000 | mg | A tonic | Powder | Y | Y | |
| Support | | | | promoting | | | | |
| | | | | physical and | | | | |
| | | | | mental well- | | | | |
| | | | | being | | | | |
| Neuronal Support | Phosphatidylserine | 100-500 | mg | Supports | Oil/ | N | Y | |
| and Sleep | | | | healthy mental | Powder | | | |
| | | | | function and | | | | |
| | | | | maintains cell | | | | |
| | | | | signaling and | | | | |
| | | | | integrity of the | | | | |
| | | | | brain | | | | |
| Neuronal Support | Garum | 200 | mg | Precursors to | Powder | Y | Y | |
| and Sleep | Armoricum | | | endorphins and | | | | |
| | | | | other | | | | |
| | | | | neurotrans | | | | |
| | | | | mitters | | | | |
| Neuronal Support | Melatonin | 1-10 | mg | Encourages | Powder | Y | Y | Melatonin |
| and Sleep | | | | healthy sleep | | | | 98% |
| | | | | patterns by | | | | |
| | | | | helping to | | | | |
| | | | | regulate the | | | | |
| | | | | body's circadian | | | | |
| | | | | rhythm | | | | |
| Neuronal Support | California | 500 | mg | Promotes rest | Powder | N | Y | |
| and Sleep | Poppy | | | and relaxation | | | | |
| Neuronal Support | Saffron | | | | | | | |
| and Sleep | | | | | | | | |

Miscellaneous Methods of Action

| Neuronal | Fennel | (TBD) | | A caminative (Gas Reducing herb) Shown to reduce occasional |
|---|---|---|---|---|
| | | | | cramps in GI Tract |
| | | | | Anxiety, insufficient reliable information |
| | | | | Dyspepsia, insufficient reliable information |
| | | | | Flatulence, insufficient reliable information about the clinical |
| | | | | effects of fennel for this purpose. |
| | | | | Menopausal symptoms. Small clinical studies suggest that oral |
| | | | | fennel oil or fennel seed powder may modestly improve |
| | | | | menopausal symptoms. |
| Neuronal And | Peppermint | 5-40 drops or | | The main medicinal role of peppermint is due to its muscle |
| Immune Support | Leaf (oil) | indoses of | | relaxing properties in the stomach and intestinal tract, and |
| | | 270-1350 mg | | internal usage of peppermint appears to be able to speed up the |
| | | daily for | | early phase of digestion in the stomach while reducing colonic |
| | | up to 4 | | motility. It is known as a carminative agent (thought to relief |
| | | weeks | | flatulence), and it has a fair bit of evidence to supports its usage |
| | | | | in reducing abdominal pain in persons with irritable bowel |
| | | | | syndrome (IBS) |
| Neuronal And | Anise | Irritable | | Dyspepsia. Clinical research in adults with postprandial distress |
| Immune Support | | bowel | | syndrome shows that taking anise powder 3 grams three times |
| | | syndrome | | daily for 4 weeks improves symptoms of functional dyspepsia |
| | | (IBS): | | compared to placebo. Of the evaluated symptoms, improvement |
| | | Enteric- | | was seen in all categories when compared to placebo except for |
| | | coated | | nausea and vomiting, which were present in less than 5% of |
| | | anise oil | | patients at baseline. Additionally, the patients taking anise |
| | | 200 mg | | experienced an improvement in quality of life when compared |
| | | three | | to placebo |
| | | times | | Irritable bowel syndrome (IBS). Clinical research in adults with |
| | | daily for | | IBS shows that taking enteric-coated anise oil 200 mg three |
| | | 4 weeks | | times daily for 4 weeks eliminates IBS symptoms in 75% of |
| | | has been | | patients compared to 52.5% of patients taking peppermint oil |
| | | used | | and 35% taking placebo. The greatest symptom improvement |
| | | | | occurred with abdominal pain, bloating, and reflux, and was |
| | | | | maintained for an additional 2 weeks after treatment completion |
| | | | | Depression. Clinical research in adults with mild to moderate |
| | | | | depression and irritable bowel syndrome (IBS) shows that |
| | | | | taking enteric-coated anise oil 200 mg three times daily for 4 |
| | | | | weeks improves symptoms of depression by an additional 28% |
| | | | | compared to placebo and an additional 32% compared to |
| | | | | peppermint |
| Neuronal And | Carraway | Caraway | | Dyspepsia. Oral caraway has only been evaluated in |
| Immune Support | | oil is | | combination with other ingredients; its effect when used alone is |
| | | most | | unclear. It is unclear if topical caraway oil is beneficial in |
| | | often | | patients with IBS. |
| | | used in | | Components of the essential oil of caraway have been shown to |
| | | combination | | cause local stimulation of the gastric mucosa, which activates |
| | | with | | the vagus nerve, leading to an increase of stomach tonus and |
| | | other | | rhythmic contraction. The result of this action is an eructation of |
| | | ingredients | | air from the stomach and an increase in gastric secretion. |
| | | in doses | | Caraway may also have effects on bile flow). A combination of |
| | | of 50 mg | | caraway oil and peppermint oil seems to have a prokinetic effect |
| | | one to | | in the GI tract, and also attenuates increased sensitivity to pain |
| | | three | | seen with chronic inflammation Caraway might have |
| | | times | | antibacterial effect |
| | | daily. | | |
| | Ginger | 10 | mg | Ginger has been historically recommended to alleviate nausea |
| | | | | and seasickness and appears to be more potent at suppressing |
| | | | | sea sickness than Dimenhydrinate (Gravol). |
| | | | | It appears to exert these effects gastrically rather than |
| | | | | neurally, and can speed up gastric digestion, although the |
| | | | | increase in motility is not the mechanism by which it alleviates |
| | | | | nausea. |
| | | | | Due to interactions with the GI tract, many side-effects of taking |
| | | | | nausea occur here; usually slight gastrointestinal complications |
| | | | | after ingestion |
| | Milk Thistle | | | Milk thistle has been used for centuries as a herbal remedy for |
| | | | | liver disorders. Silymarin, which is a mixture of several |
| | | | | different plant compounds known as flavonolignans, is the |
| | | | | bioactive component of milk thistle and sold as “milk thistle |
| | | | | extract” (the most common supplemental form of milk thistle). |
| | | | | Evidence suggests that silymarin protects liver cells, reduces |
| | | | | liver-related deaths, and improves markers of liver function in |
| | | | | people with chronic liver disease. These effects are primarily |
| | | | | attributed to silymarin's role as a free radical scavenger, thus |
| | | | | reducing oxidative stress and inflammation. Silymarin also |
| | | | | seems to have antifibrotic properties. |
| | Boswellia | | | Boswellia serrata, via its active boswellic acids, appears to be a |
| | | | | novel inhibitory of a pro-inflammatory enzyme called 5- |
| | | | | Lipoxygenase and may possess other anti-inflammatory effects |
| | | | | (such as nF-kB inhibition, which are not as novel). |
| | Holy basil | | | Milk thistle has been used for centuries as a herbal remedy for |
| | | | | liver disorders. Silymarin, which is a mixture of several |
| | | | | different plant compounds known as flavonolignans, is the |
| | | | | bioactive component of milk thistle and sold as “milk thistle |
| | | | | extract” (the most common supplemental form of milk thistle). |
| | | | | Evidence suggests that silymarin protects liver cells, reduces |
| | | | | liver-related deaths, and improves markers of liver function in |
| | | | | people with chronic liver disease. These effects are primarily |
| | | | | attributed to silymarin's role as a free radical scavenger, thus |
| | | | | reducing oxidative stress and inflammation. Silymarin also |
| | | | | seems to have antifibrotic properties. |
| | Sage | | | Anxiolytic effects: In animal research, rosmarinic acid, a |
| | | | | constituent of sage, produced anxiolytic-like effects in lower |
| | | | | doses |
| | Chromium | | | Chromium regulates insulin in the body. It is sometimes |
| | Picolinate | | | supplemented to improve insulin action in the body. |
| | (Chromax) | | | Chromium's main mechanism is directly tied to chromodulin. |
| | | | | Chromodulin, a protein, normally augments the signaling of |
| | | | | insulin receptors. If this protein is impaired, insulin's |
| | | | | ability to work in the body is greatly reduced. |

Mushrooms

| | | | | | | | |
|---|---|---|---|---|---|---|---|
| Adaptogens | Reishi | 300-650 | mg | Maintains | Powder | Y | Y |
| | | | | immune health | | | |
| | | | | and supports | | | |
| | | | | liver health and | | | |
| | | | | detoxification | | | |
| Adaptogens | Lion's Mane | 500 | mg | Supports | Powder | Y | Y |
| | | | | balanced mental | | | |
| | | | | health and | | | |
| | | | | maintains a | | | |
| | | | | feeling of calm | | | |
| | | | | while remaining | | | |
| | | | | alert | | | |
| Adaptogens | Turkey Tail | 500-1,000 | mg | Maintians | Powder | Y | Y |
| | | | | immune health | | | |
| | | | | and promotes | | | |
| | | | | cellular health | | | |

Cannabinoids

| | | | | | | | | |
|---|---|---|---|---|---|---|---|---|
| Endocannabinoids | Hemp Oil | 6-1,000 | mg | Essential fatty | | N | Y | Various |
| | | | | acid supply; | | | | Grades |
| | | | | delivers omegas | | | | |
| | | | | 3, 6 and 9 | | | | |
| Endocannabinoids | CBD | 1-500 | mg | Helps promote | Oil/ | N | Y | Various |
| | | | | a healthy mood, | Powder | | | Grades |
| | | | | memory | | | | |
| | | | | function, stress | | | | |
| | | | | response, | | | | |
| | | | | immune system | | | | |
| | | | | health, sleep | | | | |
| | | | | and appetite | | | | |
| Endocannabinoids | CBG | | | Chemical | Oil/ | N | Y | |
| | | | | precursor of | Powder | | | |
| | | | | THC and CBD; | | | | |
| | | | | reduces | | | | |
| | | | | intraocular | | | | |
| | | | | pressure; | | | | |
| | | | | decreases | | | | |
| | | | | inflammation; | | | | |
| | | | | inhibits growth | | | | |
| | | | | of certain | | | | |
| | | | | cancer cells | | | | |
| Endocannabinoids | CBN | | | Aids in pain | Oil/ | N | Y | |
| | | | | relief, anti- | Powder | | | |
| | | | | insomnia, | | | | |
| | | | | promotes | | | | |
| | | | | growth of bone | | | | |
| | | | | cells, | | | | |
| | | | | antibacterial, | | | | |
| | | | | anti- | | | | |
| | | | | inflammatory, | | | | |
| | | | | anti-convulsive | | | | |
| | | | | and appetite | | | | |
| | | | | stimulant | | | | |
| Endocannabinoids | Aromatic | 200-500 | mg | Supports | Oil | N | N | |
| | Terpenes | | | cellular health | | | | |
| Endocannabinoids | Beta | | | | | | | |
| | Caryophyllene | | | | | | | |
| | (terpene) | | | | | | | |
| MOA Unclear | Lemon Balm | 400-500 | mg | Enhances | Oil/Powder | Y | Y | Cyracos |
| | | | | relaxation of the | | | | Powder |
| | | | | mind and body | | | | Extract |
| | | | | | | | | (300 mg) |
| MOA Unclear | Lavender | 200-500 | mg | Slows the | Oil | N | N | Lavender |
| | | | | activity of the | | | | Essential |
| | | | | nervous system | | | | Oil |

Dosage forms according to embodiments herein, can include one or more sensory disruptor as described above. Suitable sensory disrupters for dosage forms described herein further include, but are not limited to those shown in Table 2. Table 2 shows suitable appearances/food formats including visual tactile, flavor, sound, smell and/or touch and/or suitable flavor profiles including taste and/or aroma.

TABLE 2
Suitable Sensory Disruptors for Dosage Forms Described Herein
Sensory Disruptors

| Appearance | | | | |
|---|---|---|---|---|
| Food Format | | | | |
| | Visual, Flavor, | | Flavor Profile | |
| Visual | Sound, Smell | sound | Taste | Aroma |
| tactile | Tactile/Touch | tactile | Taste | Aroma |
| Delivery Formats | Food Format | Texture | Profiles | Aromatics/oils |
| Food Formats | | | | |
| “Tootsie roll” | granola snack | chewy | sweet | angelica |
| “Gummy” | veggie chip | crisp | salt | Australian ericifolia |
| balls | cookie | soft | savory | basil |
| 1 × 1 bites squares | brownie | creamy | nutty | bergamot |
| layered pyramid | meal | powder | sour | black pepper |
| | replacement | | | |
| sachets | kale chip | | sweet-salt | cardamom |
| tea | carrot chips | | sweet-savory | carrot seed |
| extrusion | tortilla chip | | sweet-nutty | cedarwood |
| (Cheetos ®) | | | | |
| dehydrated | potato chip | | sweet-sour | German chamomile |
| baked | sweet potato | | salt - umami | cinnamon bark |
| | chip | | | |
| raw | plantain chip | | salt-savory | clary sage |
| | cassava chip | | salt - nutty - | clove |
| | | | sweet | |
| Supplement format | | | sour - umami | eucalyptus blue |
| soft capsule | extrusion (like | chewables | sour - salt | fennel |
| | cheetos) | | | |
| hard capsule | multi- | soft melt | | frankincense |
| | compartment | | | |
| | capsule/capsulet | | | |
| tablets | powder/sachet | gummy | | geranium |

ginger
goldenrod
grapefruit
hyssop
Idaho blue spruce
Idaho grand fir
jade lemon
jasmine
juniper
lavender
lemon
lemon myrtle
lemon verbena
lemongrass
lime
manuka
marjoram
mastrante
melissa
myrtle
neroli
northern black spruce
nutmeg
orange
oregano
patchouli
pine
roman chamomile
rose
rosemary
rue
sandalwood (Hawaiian)
sandalwood (hydrosol)
sacred frankincense
spearmint
sage
thyme
vanilla
wintergreen

### Stress Busters

Stress busters are components that assist the body in down-regulating catecholamine and cortisol release in the CNS and the endocrine system. Certain mediators block receptors (i.e., competitive inhibition) or bind receptors to increase dopamine, GABA, glutamine, glycine and/or decrease norepinephrine and epinephrine. Suitable stress buster components for dosage forms according to embodiments herein include, but are not limited to L. Arginine, L. Lysine, GABA, glycine, magnesium, citi-choline, inositol, apigenin and combinations thereof.

There are many reports on various herbs and components known for their anxiolytic properties. These studies have reported relief of stress, some as good, if not better than, existing pharmacologic treatments such as benzodiazepines. Other studies have found enhanced relief by combining two or more ingredients.

Dosage forms as described herein can include any one or more of the stress busters listed above. Suitable functional food stress busters further include, but are not limited to those shown in Table 3.

TABLE 3
Functional Food Stress Busters for a Savory Dosage form
Liquid ingredients

| Unrefined, refined, virgin | raw, processed, dried | raw, processed, dried |
|---|---|---|
| Oils | Syrups/sugars | “Butters” |
| plum | maple | acorn |
| sunflower | walnut | almond |
| safflower | date syrup | apple |
| olive | honey | Brazil nut |
| sesame | manuka honey | cashew |
| coconut | raw honey | chestnut |
| dates | sugar - all forms | coconut |
| date syrup | molasses | hazelnut |
| raw honey | agave | macadamia |
| | sucralose | peanut |
| | | pecan |
| | | pine nut |
| | | pistachio |
| | | pumpkin |
| | | sunflower |
| | | walnut |
| | | mixed-nut |
| | | mixed seed |

Fresh and Dried Ingredients

| cooked, raw, | | | | |
|---|---|---|---|---|
| soaked, sprouted, | | | | |
| baked | whole, roasted, | fresh, dried | | |
| Grains/pseudo | powder, oil | spread, extract | fresh, dried, extract | |
| grains | Nuts/Seeds | Fruit | Vegetable | Mushroom |
| oats | peanut | dates | kale | cordyceps |
| hemp | cashew | goji | collard | maitake |
| buckwheat | almond | raisins | Swiss chard | lions mane |
| durum wheat | pistachio | plums | carrot | shiitake |
| sorghum | macadamia | cherry | beet | oyster |
| amaranth | brazil | cranberry | brocolli | cinnamon caps |
| barley | chestnut | dried blueberry | cauliflower | reishi |
| Bulgur | cacao | pomegranate | cassava | portabella |
| Corn Starch | Ginkgo nuts | fig | zucchini | turkey tail |
| Farro | Pili nuts | banana | seaweed | Royal Sun |
| | | | | Blazei |
| Spelt | Candle nuts | strawberry | sweet potato | chaga |
| Freekeh | Black walnuts | blueberry | potato | mesima |
| Khorasan Wheat | Palm nuts | raspberry | | |
| Quinoa | Tiger nuts | blackberry | | |
| Kañiwa | hazelnut | plantain | | |
| Rice | Filberts | tomato | | |
| Rye | chia | grape | | |
| Sorghum | flax | orange | | |
| Teff | hemp | apple | | |
| Triticale | pumpkin | peach | | |
| Wheat | sunflower | watermelon | | |
| Wild Rice | poppy | cantaloupe | | |
| Wheat berries | sesame | honey dew | | |
| Hominy | watermelon | pineapple | | |
| Spelt | pomegranate | jackfruit | | |
| Rye | quinoa | | | |
| Brown Rice | soy | | | |
| Farro/Emmer | | | | |
| Barley | | | | |
| Bran | | | | |
| Couscous | | | | |
| Farina | | | | |
| Kamut | | | | |
| Orzo | | | | |
| Semolina | | | | |
| Graham | | | | |
| Corn flour | | | | |
| Cornmeal | | | | |
| Rice | | | | |
| Montina flour | | | | |
| Sorghum | | | | |
| Malts- made from | | | | |
| wheat | | | | |
| Graham - made | | | | |
| from wheat | | | | |
| Couscous - made | | | | |
| from wheat | | | | |
| seminola | | | | |
| Polenta - made | | | | |
| from corn | | | | |
| Muesli - made | | | | |
| from oats or | | | | |
| wheat | | | | |
| Seitan - made | | | | |
| from wheat | | | | |
| Panko - made | | | | |
| from wheat | | | | |
| Millet (finger, | | | | |
| foxtail, Japanese, | | | | |
| Kodo, Pearl, | | | | |
| Adlay, & Proso) | | | | |
| Barley Malt | | | | |
| Wheat Germ | | | | |
| Enriched Bleach | | | | |
| Flour | | | | |
| Malted Barley | | | | |
| Flour | | | | |
| Granary Flour | | | | |
| Groats (wheat, | | | | |
| barley, | | | | |
| buckwheat) | | | | |
| Pastas | | | | |
| Matzo | | | | |
| Seitan | | | | |
| Tabbouleh | | | | |
| Udon (wheat | | | | |
| noodles) | | | | |
| Corn Starch | | | | |
| Wheat nuts | | | | |

| Herbs/Spices | | Acid | |
|---|---|---|---|
| fresh, dried, | | fresh, concentrated, | Excipients |
| powder, extract | | powder | binders, gums |
| Herbs | Spices | Acid | Misc. |
| Fennel | nutmeg | Lemon | aloe |
| Peppermint | cinnamon | vinegar | acacia gum |
| Leaf (oil) | | | |
| Anise | vanilla | apple cider vinegar | guar gum |
| Carraway | salt | white wine | citric acid |
| Ginger | pepper | red wine | natural preservatives |
| Milk Thistle | basil | lime | |
| Boswellia | oregano | Tomato | |
| Holy basil | thyme | tomato paste | |
| Sage | rosemary | Worcestershire | |
| Chromium | sage | | |
| Picolinate | | | |
| (Chromax) | | | |
| Fennel | garlic | | |
| Peppermint | nutritional | | |
| Leaf (oil) | Yeast | | |

### Calming Relievers

Calming relievers are components that assist in down-regulating stress mediators and receptors in the ECS. Certain mediators block receptors (i.e., competitive inhibition) or bind receptors, e.g., CB1, CB2, TRPV1 and 5HT1, to increase dopamine, GABA and glycine. Suitable calming reliever components for dosage forms according to embodiments herein include, but are not limited to one or more cannabinoids (e.g., cannabidiol, cannabinol, tetrahydrocannabinol, dronabinol, etc.), caryophyllene, lemon balm, passionflower, ashwagandha and combinations thereof.

Surprisingly, and in accordance with embodiments herein, it was found that combining stimulation of the sensory branch of the PNS together with a formulation of ingredients that target multiple stress pathways within the CNS can provide an acute response and a sustained response. It was found that this combination results in a decrease in stress, while simultaneously invoking the relaxation response mediated by the ANS (i.e., “Resetting and rebalancing the systems”). Dosage forms and kits according to embodiments herein provide a synergistic approach to decreasing stress by disrupting the stress response. The synergistic approach uses sensory distraction together with stress busters and calming relievers that ultimately provide both an acute and sustained response.

### Central Nervous System Components

Notably, some components disclosed herein have the capability of targeting more than one system within the body, that is, the CNS, the immune system and/or the endocrine system and/or can be considered one or more of a sensory disrupter, stress buster or calming reliever. Such components may be listed herein as suitable ingredients for targeting more than one system.

Central nervous system components target the central nervous system as described herein to help the body in responding to stress ultimately to rebalance the body's systems involved in a stress response to achieve allostasis. Suitable central nervous system components for dosage forms according to embodiments herein include, but are not limited to, gamma aminobutyric acid (GABA), valerian root, 5-hydroxytryptophan (5-HTP), L-Theanine, passionflower, lemon balm and combinations thereof. GABA the chief inhibitory neurotransmitter that works to regulate neuronal excitability and thereby serves as a “brake” on the neural circuitry during stress. It is the brain's natural stress reliever. GABAergics are also suitable components to support the nervous system. GABAergics are anxiolytic calming agents that influence GABA pathways. Valerian (i.e., Valeriana officinalis), or aqueous root extracts, can provide anxiolytic effects, decreased restlessness, reduced somatic arousal and improved sleep. Valerian also can be used in combination with hops (Humulus lupulus) and/or lemon balm (i.e., Melissa officinalis) to enhance its effects. Hops are also suitable components for dosage forms herein. 5-HTP and its precursor, tryptophan, can elevate brain serotonin levels and enhance mood and provide a sense of well-being. Passionflower (genus Passiflora) can reduce anxiety and insomnia. Studies in mice and rats have demonstrated reduced anxiety and stress with passionflower treatment, and a human study showed that treatment with passionflower can serve as an anxiolytic in humans.

A suitable component to support the HPA-Axis includes, but is not limited to one or more corticosteroid modulators. Any suitable corticosteroid known to those of ordinary skill in the art can be incorporated into dosage forms according to embodiments herein. Suitable corticosteroid modulators include, but are not limited to ashwagandha (which is believed to have an effect on the HPA-Axis), cordyceps extract (i.e., cordyceps sinenis), selective glucocorticoid receptor modulators (SGRMs) and combinations thereof. SGRMs are designed to engage the glucocorticoid (GC) receptor with dissociative characteristics: transactivation of genes, which is mainly responsible for unwanted effects, is less strong, while transrepression of genes, reducing inflammation, is maintained. It is expected that SGRMS, thus have a better efficacy/safety balance than GCs.

According to embodiments, adaptogens are suitable components for dosage forms according to embodiments herein to target the CNS and support a human's response to stress. Adaptogenic herbs can be helpful for adaptogenic recovery to tolerate physical stress and immune support. The can help boost physical and mental energy. Adaptogens provide balance in the face of stress.

A suitable adaptogen includes, but is not limited to standardized ashwagandha root extract. One of India's most revered herbs, ashwagandha, is useful for its ability to balance, energize, and rejuvenate. Sensoril® branded ashwagandha is supported by numerous clinical studies to validate its benefits. Another suitable adaptogen includes a Chinese tree bark extract in combination with magnolia (i.e., Magnolia officinalis) and phellodendron (i.e., Phellodendron amurense) barks. A Chinese herbal supplement, used for more than 1,500 years, has been clinically proven to support normal levels of adrenal hormones for a healthful reaction to everyday stress, and to quiet the HPA axis without causing drowsiness.

L-Theanine is another suitable adaptogen to support the body during stress. This amino acid is naturally produced by the human body and found in small amounts in green tea and certain mushrooms. L-theanine competes with the human body's excited neurotransmitters, which results in balanced mood and mental focus, without causing drowsiness. One known source of L-Theanine is TheaKalm®, pure L-Theanine supplement (i.e., green tea Extract) with a dosage of 200 mg/serving. The adaptogen eleuthero is also suitable to support the body's response to stress. Eleuthero is a powerful adaptogen that can strengthen tolerance to stress and promote stamina and overall health. Like other adaptogens, eleuthero primarily works by influencing the hypothalamus, a region of the brain that controls metabolism and energy (thyroid), the reaction to stress (adrenals), and the reproductive functions (testes/ovaries). By balancing the hypothalamic-pituitary-adrenal axis (HPA axis), eleuthero has been shown in randomized clinical trials to help strengthen tolerance to various types of stress, promote stamina, and reduce fatigue.

Another suitable adaptogen for dosage forms according to embodiments herein is Chinese skullcap extract (i.e., Scutellaria baicalensis). Scutellaria baicalensis can be a potent synergist to enhance the benefit of other herbs when consumed concurrently. Skullcap is a naturally occurring flavonoid isolated from Scutellaria baicalensis and can compete with benzodiazepines for binding to GABAa receptors expressed in Xenopus oocytes.

Reishi mushroom extract (i.e., Ganoderma Lucidum) is another suitable adaptogen as a component of dosage forms according to embodiments herein. Reishi mushroom is an adaptogenic mushroom that improves stamina, supports immune system functions, and promotes a calm state of mind. Reishi mushroom is also neuro-supportive, liver supportive, and supports aerobic physical activity. Cordyceps extract (i.e., Cordyceps sinensis) is another adaptogenic mushroom suitable as a central nervous system component. Cordyceps extract promotes stress resistance, supports immune function, supports adrenal function and improves aerobic activity.

Another adaptogen suitable as a central nervous system component is rehmannia extract (Rehmannia glutinosa). Rehmannia extract is an herb in traditional Chinese medicine useful as an adrenal tonic. This adaptogenic root supports adrenal function and supports a relaxed state of mind. Chamomile (i.e., Matricaria recutita) is another suitable adaptogen as a central nervous system component. Aqueous extracts of German chamomile (i.e., Matricaria recutita) and hops (Humulus lupulus) can increase GABA levels in rat brain homogenate by inhibiting GABA transaminase.

Components that target serotonin/5HT pathways are suitable central nervous system components that can provide a sense of calm. Griffonia simplicifolia is suitable as a central nervous system component. Seeds from this woody shrub are rich in 5-HTP, an amino acid dietary supplement which can elevate the levels of the neurotransmitter, serotonin in humans.

Magnolia bark/extract and Phellondendron bark/extract are also suitable central nervous system components. These barks/extracts have been shown to be anxiolytic in humans in one clinical study which recommends use in premenopausal women. Another suitable central nervous system component is St. John's Wort. St. John's Wort can provide similar effects as the prescription drug Prozac. Other suitable central nervous system components include Proloftin™, which contains phosphatidyl serine, L-theanine, magnolia bark, rhodiola and beta-sitosterol, Seditol™, a proprietary blend of Magnolia officinalis and Ziziphus spinose in pill form that can be taken for relaxation, and Relarian™, a blend of aqueous valerian root extract, L-theanine, 5-HTP and GABA.

Suitable central nervous system components that target the endocannabinoid system (ECS) are hemp seed oil, natural cannabinoids (e.g., CBD, CBG, CBN, THC, THCV, CBDV), synthetic cannabinoids (e.g., dronabinol), plant terpenes, flavonoids and combinations thereof. According to embodiments, dosage forms as described herein can include cannabidiol as a central nervous system component, alone or in combination with one or more other cannabinoid, for example, tetrahydrocannabinol, which may provide a synergistic effect in balancing the ECS. In embodiments, dosage forms according to embodiments herein can comprise dronabinol as a central nervous system component.

### Immune System Components

Immune system components target the body's immune system as described herein to help the body respond to stress and ultimately rebalance the body's systems involved in a stress response to achieve allostasis. Suitable immune system components for dosage forms according to embodiments herein include, but are not limited to, Ahi flower oil, MCT oil, any other single sourced plant-based omega-3 oils, fish oil (e.g., containing omega-3 oils), structured lipids in the form of docosahexaenoic acid (DHA) and/or eicosapentaenoic acid (EPA), vitamin D3, limonene (e.g., from lemon balm), beta caryophyllene and combinations thereof.

Ahi flower oil is an omega-3 polyunsaturated fatty acid (PUFAs) known to play critical roles in neuronal cell function as well as inflammatory and immune reactions involved in neuropsychiatric disease states. Omega-3 oils are useful to modulate inflammation and support a strong immune system. MCT Oil is a medium chain triglyceride that can be taken for weight loss, appetite control, extra energy for exercise and inflammation.

Vitamin D3 supports antioxidant and anti-inflammatory activity, which is known to preserve the function of immune cells against homeostatic disturbances caused by oxidative stress and inflammation. While the amount of vitamin D3 included in dosage forms according to embodiments herein can be less than the recommended daily allowance (RDA) and serving sizes used in clinical trials, the combinatory effect of vitamin D3 and other ingredients may support immune function, for example, when taken with a healthy diet and exercise.

Beta caryophyllene is a phytochemical naturally found in many edible plants such as basil, lemon balm, clove and hemp. Through selective binding to CB1 and CB2 receptors, beta-caryophyllene may exert anti-inflammatory and stress-balancing activity. Though the amount of beta-caryophyllene include in dosage forms according to embodiments herein may be higher (e.g., slightly higher or 1%, 2%, 5%, 10% higher) than amounts in various studies, scientific evidence is supportive of its safe consumption in healthy adults.

Lemon balm is a lemon scented herb containing limonene and is useful to reduce anxiety, stress and to aid in sleep. Luteolin, a flavonoid of lemon balm, has calming and anti-inflammatory effects when administered both topically and orally, although the exact mechanism of action is uncertain. Recent in vitro research suggests that low amounts of lemon balm treatment (e.g., 100 mg) may modulate the central nervous system through interacting with GABA receptors to enhance mood states. A small amount of lemon balm in dosage forms according to embodiments herein is safe and may elicit calming and immune-enhancing effects.

### Endocrine System Components

Endocrine system components target the body's endocrine system as described herein to help the body respond to stress and ultimately rebalance the body's systems involved in a stress response to achieve allostasis. Suitable endocrine system components for dosage forms according to embodiments herein include, but are not limited to, magnolia bark extract, Phellodendron amurense bark extract, ashwagandha and combinations thereof.

Magnolia bark extract, Phellodendron amurense bark extract have shown anxiety-reducing properties in animal models. The bark of M. officinalis is useful as an antioxidant and detoxifier and has relaxing potential. One to two servings, daily, may be effective in reducing stress and supporting relaxation in healthy individuals with anxiety, for example, when taken along with a healthy diet and exercise.

Ashwagandha, native to India and the Middle East, is useful in Ayurvedic medicine for its calming, antidepressant, and sleep promoting effects. Also classified as an adaptogen, which is a substance that helps the body withstand environmental stressors, thereby promotes resilience to stress. The phytochemicals in ashwagandha counteract the negative effects of stress by increasing levels of GABA signaling and preventing overstimulation of the brain, similar to the activity of L-Theanine. Clinical evidence supports the use of ashwagandha extracts for a variety of stress-related symptoms, even at low amounts of 125 mg, for example, as included in dosage forms as described herein.

### Functional Foods

The link between diet and human health status has been repeatedly proven by strong scientific evidence, and developed societies demand food products with an added value beyond the satisfaction of hunger and the provision of nutrients. Functional foods, food supplements and nutraceuticals are at the interface between nutrition and pharma and opens the doors for seeking new therapeutic alternatives for the prevention of nutrition-related diseases.

Functional foods, food supplements and nutraceuticals exert health-promoting properties and could be considered as potential candidates in the management of chronic diseases in combination with prescribed medication. Further research is essential for establishing which nutrition-pharma combinations are most favorable and suitable for each chronic disease. Table 4 shows the role of functional foods in the healthcare continuum.

TABLE 4
Role of Functional Foods in Health Care Continuum

| | |
|---|---|
| Delivery | Foods [symbol] Fortified/Enhanced Foods [symbol] |
| Options | Supplements [symbol] Medical Foods [symbol] Drugs |
| Purpose of | Reduction of Risk → Treatment of Disease |
| Therapy | |
| Health | Low → High |
| Professional | |
| Involvement | |
| Individual | High → Low |
| Participation | |
| Treatment | Low → High |
| Cost | |

According to one or more embodiments, dosage forms as described herein include one or more functional foods. Suitable functional foods include, but are not limited to: Adaptogenics: Ashwagandha and others considered to have an adaptogenic effect on stress; Phytochemicals: Carotenoids, Flavonoids, phenolic acids, isothiocyanates, prebiotics, probiotics; Botanicals: known to provide a positive effect on down regulating stress response (ashwagandha, rhodiola, etc.); Herbs: known to provide a positive effect on down regulating stress response (Lemon Balm, holy basil, lavender, etc.); Spices: black pepper (beta caryophyllene, red pepper, capsaicin, etc.); Fruit: powder, or certain chemical compounds derived therefrom; Vegetable: powder, or certain chemical compounds derived therefrom; Flavonoids: such as catechins from green tea, curcumin from turmeric and grape seed procyanidins that exert their anti-inflammatory and antioxidant effects through the activation of Nrf2, inducing the antioxidant enzyme's transcription, and the inhibition of NF-kB, key transcription factors in inflammatory responses; Other bioactive Flavonoids: bioactive phytochemicals like triterpenes, centella saponin, asiaticoside, and sceffoleoside, asiatic acid, madecassic acid, phenolic acid avenanthramides and others can affect Nrf2 and/or NF-κB pathways; Fermented foods: foods, and/or beneficial extracts thereof: It is increasingly understood that fermented foods can also have enhanced nutritional and functional properties due to transformation of substrates and formation of bioactive or bioavailable end-products. Many fermented foods also contain living microorganisms of which some are genetically similar to strains used as probiotics; Edible mushrooms including the following non-limiting non-psychoactive examples; lion's mane, cordyceps, oyster, maitake, reishi, turkey tail, chaga, shiitake, royal sun blazei, that provide a wide spectrum of constituents: polysaccharides (beta glucans, arabinoxylane, glucose, xylose, galactose and cordycepic acid), glycoproteins, ergosterols, triterpenoids and other myco-nutrients, in the form of mycelium, and/or fruiting bodies, whole or in part, as a novel protein source for functional foods as well as their effects on the immune, nervous, endocrine and endocannabinoids; additionally, psychoactive mushrooms such Psilocybin mushrooms, commonly known as magic mushrooms, a polyphyletic group of fungi that contain psilocybin which turns into psilocin upon ingestion; biological genera containing psilocybin mushrooms include Copelandia, Gymnopilus, Inocybe, Panaeolus, Pholiotina, Pluteus, Cubenisis and Psilocybe; Antioxidants: Vitamin C, pomegranate, blueberries, etc.; Lipids: Short chain triglycerides, medium chain triglycerides (MCT's); long-chain ex: omega-3 rich forms high in Docosahexaenoic acid (DHA) and Eicosapentaenoic acid EPA, derived from fish, seaweed, several species of plants such as Ahiflower; Biogenics: are biologically active peptides, including immunopotentiators (biological response modifier: BRM), plant flavonoids, etc.; Seeds: sprouted and/or unsprouted chia, flax, sunflower, pumpkin, etc; Hemp: hearts, hemp powder, hemp protein; Non-wheat based flour including but not limited to; oat, lupin, chickpea, Einkorn, potato, buckwheat, Tapioca, Masa Harina, Brown Rice, Mochiko, Light Rye, Light Rye, Barley, Farro, Kamut®, Seven-Grain Flour, Spelt, Teff, Triticale.

As depicted in Tables 5 and 6 below, carotenoids may be used as stress-busters, immune enhancing ingredients, and also have effects on the endocrine system. Flavonoids can be used as calming relievers and/or stress-busting ingredients due to their effects on the cardiovascular system (e.g., down regulates sympathetic input thus increasing parasympathetic activity via vasodilation). Phenolic acids, Isothiocyanates, Prebiotics and Probiotics (not listed in Table 5 and 6, but included here) are useful as immune enhancing ingredients. Examples of some functional food components are shown in Table 7. Table 8 shows the benefits versus risks of certain foods.

TABLE 5
Examples of Phytochemicals

| Class/Bioactive Food | | |
|---|---|---|
| Components | Food Sources | Potential Benefit |
| Cartenoids | Carrots, pumpkin, sweet | Neutralizes free radicals that |
| Beta-carotene | potato, cantaloupe. | may damage cells; bolsters |
| | | cellular antioxidants |
| | | defenses; can be made into |
| | | vitamin A in the body. |
| Flavonoids | Cranberries, cocoa, apples, | May contribute to |
| Proanthocyanidins | strawberries, grapes, wine, | maintenance of urinary tract |
| | peanuts, cinnamon. | health and heart health. |
| Phenolic acids | Apples, pears, citrus fruits, | May bolster cellular |
| Caffeic acid, | some vegetables, coffee. | antioxidant defenses; may |
| ferulic acid | | contribute to maintenance of |
| | | healthy vision and heart |
| | | health. |
| Isothiocyanates | Cauliflowers, broccoli, | May enhance detoxification |
| Sulforaphane | broccoli sprouts, cabbage, | of undesirable compounds; |
| | kale, horseradish. | bolster cellular antioxidant |
| | | defenses. |
| Prebiotics | Whole grains, onions, garlic, | May improve |
| Inulin, | honey, leeks. | gastrointestinal health; may |
| fructooligosaccharides, | | improve calcium absorption. |
| polydextrose | | |

TABLE 6
Examples of Other Phytochemicals

| | [symbol] | | | | | |
|---|---|---|---|---|---|---|
| [symbol] | [symbol] | [symbol] | [symbol] 4 weeks | [symbol] | [symbol] | [symbol] |
| | | 8 | | | | |
| | | [symbol] | | | | |
| | | 9 | | | | |
| [symbol] (extract) | [symbol] | [symbol] | [symbol] 6 months | [symbol] | [symbol] | [symbol] |
| | (600-755 mg [symbol] | | | | | |
| [symbol] (extract) | 2 capsules [symbol] | [symbol] | [symbol] 8 weeks | [symbol] | [symbol] | [symbol] |
| | acid) | 55 | | | | |
| [symbol] (extract) | [symbol] | [symbol] | [symbol] 30 days | [symbol] | [symbol] | [symbol] |
| | | 42 | | | | |
| [symbol] (extract) | [symbol] | [symbol] | [symbol] | [symbol] | [symbol] | [symbol] |
| | | 20 | 4 weeks juice | | | |
| | | | followed by | | | |
| | | | 4 weeks | | | |
| | | | [symbol] | | | |
| | | | each dialysis | | | |
| | | | treatment | | | |
| [symbol] (juice) | 100 ml | [symbol] | [symbol] | [symbol] | [symbol] | [symbol] |
| | [symbol] | | | ↓ | ↓ | |
| [symbol] (juice) | 100 cc | [symbol] | Parallel, during | [symbol] | [symbol] | [symbol] |
| | [symbol] | 49 | each dialysis | ↓ | ↓ | |
| | | | ( [symbol] ), 1 year | | | |
| Red grape | 100 ml | [symbol] | Parallel, 2 weeks | [symbol] ↑ | [symbol] | [symbol] |
| ( [symbol] juice) | [symbol] | 38 | | [symbol] ↓ | | |
| | | [symbol] | | [symbol] ↑ | | |
| | | 15 | | [symbol] ↓ | | |
| [symbol] | 100 ml | [symbol] | Parallel, 2 weeks | [symbol] ↓ | [symbol] | [symbol] |
| juice) | [symbol] | 16 | | | ↓ | |
| [symbol] grapefruit | [symbol] | [symbol] | Parallel, 6 weeks | [symbol] | [symbol] | [symbol] |
| | | 74 | | | | |
| | | [symbol] | | | | |
| | | 29 | | | | |

[symbol]

[symbol]

indicates data missing or illegible when filed

TABLE 7
Examples of Functional Food Components

| Functional Component | Health Benefits | U.S. Regulatory Status of Claims |
|---|---|---|
| Soluble oat fiber | Coronary heart disease | FDA approved health claim |
| Soy protein | Coronary heart disease | FDA approved health claim |
| Phytosterol/ | Coronary heart disease | FDA approved health claim |
| stariol esters | | (interim final rule) |
| Calcium | Osteoporosis | FDA approved health claim |
| Folate-enriched | Neural tube defects | FDA approved health claim |
| foods | | |

TABLE 8
Benefits and Risks of Foods vs. Drugs

| Feed and Feed Components | Drugs |
|---|---|
| Energy/nutrition/necsssary for life | Treatment of disease |
| Life long use and benefits | Immediate effect |
| All populations | Target population |
| Safe^{a} | Benefit > risk |
| Consumer selects | Health provider prescribes |

Adapted from Yelley, 1998.
^{a}Safe when consumed as a food, but with a potential increase in risk as the component levels increase. Safety evaluation will be conducted to identify the limits.

### Embodiments of Dosage Forms and Foods

It should be noted that stress eating dosage forms, stress eating foods and stressed gut dosage forms and foods according to embodiments herein can include any of the above-listed ingredients in a variety of combinations to help relieve one or more symptoms as described herein related to stress eating and stressed gut. In some embodiments, stress eating and stressed gut dosage forms or foods as described herein, include at least one sensory disrupter comprising an aromatic oil; and at least one functional food, comprising one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof.

The aromatic oil can include, but is not limited to, one or more of angelica, Australian ericifolia, basil, bergamot, black pepper, cardamom, carrot seed, cedarwood, German chamomile, cinnamon bark, clary sage, clove, eucalyptus blue, fennel, frankincense, geranium, ginger, goldenrod, grapefruit, hyssop, Idaho blue spruce, Idaho grand fir, jade lemon, jasmine, juniper, lavender, lemon, lemon myrtle, lemon verbena, lemongrass, lime, manuka, marjoram, mastrante, melissa, myrtle, meroli, northern black spruce, nutmeg, orange, oregano, patchouli, pine, Roman chamomile, rose, rosemary, rue, Hawaiian sandalwood, sandalwood (hydrosol), sacred frankincense, spearmint, sage, thyme, vanilla, wintergreen, dried plant portions or matter thereof, extracts thereof, or combinations thereof.

The vegetable can include, but is not limited to, one or more of kale, collard, Swiss chard, carrot, beet, broccoli, cauliflower, cassava, zucchini, seaweed, sweet potato, potato, dried plant parts or matter thereof, extracts thereof, or combinations thereof. The herb can include, but is not limited to, one or more of hops, gotu kola, Ginkgo biloba, citicoline, yerba mate, sage, chamomile, valerian root, skullcap, lavender, licorice, saffron, fennel, peppermint leaf, anise, caraway, ginger, milk thistle, boswellia, holy basil, dried plant parts and matter thereof, extracts thereof, or combinations thereof.

The spice can include, but is not limited to, one or more of a powder or granulation of nutmeg, cinnamon, vanilla, salt, pepper, basil, oregano, thyme, rosemary, sage, garlic, nutritional yeast, or combinations thereof. The acid can include, but is not limited to, one or more of lemon, lemon juice, vinegar, apple cider vinegar, wine, white wine, red wine, lime, lime juice, tomato, tomato paste, Worcestershire, extracts thereof, dried forms thereof, or combinations thereof.

In some embodiments, the fruit can include, but is not limited to, one or more of dates, goji berry, raisins, plums, cherry, cranberry, blueberry, pomegranate, fig, banana, strawberry, blueberry, raspberry, blackberry, plantain, tomato, grape, orange, apple, peach, watermelon, cantaloupe, honey dew, pineapple, jackfruit, dried plant portions or matter thereof, extracts thereof, or combinations thereof. The vegetable can include, but is not limited to, one or more of kale, collard, Swiss chard, carrot, beet, broccoli, cauliflower, cassava, zucchini, seaweed, sweet potato, potato, dried plant portions or matter thereof, extracts thereof, or combinations thereof.

According to various embodiments, the nut can include, but is not limited to, one or more of almond, chestnut, cacao nut, ginkgo nut, pili nut, candle nut, palm nut, tiger nut, filbert nut, soy nut, coconut, walnut, black walnut, peanut, Brazil nut, cashew nut, hazelnut, macadamia nut, pine nut, pecan nut or pistachio. The seed can include, but is not limited to, one or more of chia seed, flax seed, hemp seed, pumpkin seed, sunflower seed, poppy seed, sesame seed, watermelon seed, pomegranate seed or quinoa seed.

In some embodiments, the plant-based oil can include, but is not limited to, one or more of plum oil, sunflower, safflower, olive oil, avocado oil, date oil, date syrup, extracts thereof or combinations thereof. The nut oil can include, but is not limited to, one or more of almond oil, chestnut oil, cacao nut oil, ginkgo nut oil, pili nut oil, candle nut oil, palm nut oil, tiger nut oil, filbert nut oil, soy nut oil, coconut oil, walnut oil, black walnut oil, peanut oil, Brazil nut oil, cashew nut oil, hazelnut oil, macadamia nut oil, pine nut oil, pecan nut oil, pistachio oil, extracts thereof or combinations thereof. The seed oil can include, but is not limited to, one or more of sesame seed oil, sunflower seed oil, cottonseed oil, safflower seed oil, canola seed oil, grape seed oil, extracts thereof or combinations thereof.

In some embodiments, the syrup can include, but is not limited to, one or more of maple, walnut, date, honey, manuka honey, raw honey, a sugar, molasses, agave, sucralose, extracts thereof or combinations thereof. The butter can include, but is not limited to, one or more of acorn, almond, apple, Brazil nut, cashew, chestnut, coconut, hazelnut, macadamia, peanut, pecan, pine nut, pistachio, pumpkin, sunflower, walnut, mixed-nut, mixed seed or combinations thereof.

In some embodiments, the grain or pseudo grain can include, but is not limited to, one or more of oat, hemp, wheat, buckwheat, durum wheat, sorghum, amaranth, barley, bulgur, corn starch, farro, spelt, freekeh, khorasan wheat, quinoa, kañiwa, rice, rye, sorghum, teff, triticale, wild rice, wheat berries, hominy, spelt, rye, brown rice, farro/emmer, barley, bran, couscous, farina, kamut, orzo, semolina, graham, corn flour, cornmeal, rice, montina flour, sorghum, or combinations thereof. The pseudo grain can include, but is not limited to, one or more of malts made from wheat, graham made from wheat, couscous made from wheat seminola, polenta made from corn, muesli made from oats or wheat, seitan made from wheat, panko made from wheat, millet (finger, foxtail, Japanese, Kodo, Pearl, Adlay, and/or Proso), barley malt, wheat germ, enriched bleach flour, malted barley flour, granary flour, groats (wheat, barley, buckwheat), pasta, matzo, seitan, tabbouleh, udon (wheat noodles), corn starch, wheat nuts.

In some embodiments, the mushroom can include, but is not limited to, one or more of cordyceps, maitake, lions mane, shiitake, oyster, cinnamon caps, reishi, portabello, turkey tail, Royal Sun Blazei, chaga, mesima, dried plant parts or matter thereof, extracts thereof or combinations thereof.

Dosage forms can further include at least one stress-buster, comprising one or more of a botanical, an herb, a vitamin, a mineral, extracts thereof, dried plant parts or matter thereof, or combinations thereof. The botanical can include, but is not limited to, one or more of aromatic terpenes, lactium, pregnenolone, bacopa, Griffonia simplicifolia, kanna, reishi, lion's mane, turkey tail, Korean Ginseng, eleuthero, suma, American ginseng, rhodiola (Artic Root), rehmannia, roloftin, relora, schisandra, California poppy, dried plant parts or matter thereof, extracts thereof, or combinations thereof. The herb can include, but is not limited to, one or more of hops, gotu kola, Ginkgo biloba, citicoline, yerba mate, sage, chamomile, valerian root, skullcap, lavender, licorice, saffron, fennel, peppermint leaf, anise, caraway, ginger, milk thistle, boswellia, holy basil, dried plant parts and matter thereof, extracts thereof, or combinations thereof. The vitamin can include, but is not limited to, one or more of Vitamin B1 (Thiamine), Vitamin B3 (Niacin), Vitamin B5 (Pantothenic Acid), Vitamin B6 (Pyridoxine), Vitamin B9 (Folic Acid), Vitamin B12 (Cyanocobalamin), Vitamin H (Biotin), Vitamin C (Ascorbic Acid), Vitamin D3, Inositol (myo-inositol), gammaaminobutyric acid (GABA), L-phenylalanine, L-tyrosine, 5-hydroxytryptophan (5-HTP), L-theanine (Theanine), pure L-Theanine (Green Tea Extract), L-Glutamine (Glutamine), L-Glycine (Glycine), L-Taurine (Taurine), L-Threonine (Threonine), dimethylaminoethanol (DMAE), phosphatidylserine, melatonin, garum armoricum, chromium picolinate, proloftin, salts thereof, or combinations thereof. The mineral can include, but is not limited to, one or more of calcium, magnesium, salts thereof, or combinations thereof.

In various embodiments, the dosage forms can include at least one calming reliever. The at least one calming reliever can include, but is not limited to, one or more of hemp, a cannabinoid, cannabidiol, cannabinol, cannabigerol, tetrahydrocannabinol, dronabinol, caryophyllene, lemon balm, passionflower, ashwagandha or combinations thereof.

In some embodiments, the aromatic oil in the dosage forms or foods can include, but is not limited to, one or more of cinnamon bark oil or nutmeg oil. The functional food can include, but is not limited to, one or more of plum oil, date oil, date syrup, Manuka honey, raw honey, apple butter, mixed-nut butter, mixed seed butter, oats, hemp, buckwheat, cashew nut, almond, pistachio, black walnut, chia seed, flax seed, hemp seed, dates, goji berry, raisin, cranberry, fig, jackfruit, maitake mushroom, lions mane mushroom, reishi mushroom, turkey tail mushroom, chaga mushroom, nutmeg spice, cinnamon spice, vanilla extract, vanilla bean, salt, extracts thereof, or combinations thereof.

In some embodiments, the aromatic oil in the dosage forms and food can include, but is not limited to, one or more of sage oil or thyme oil. The functional food can include, but is not limited to, one or more of safflower oil, olive oil, date syrup, cashew butter, hemp, spelt, freekeh, quinoa, chia seed, flax seed, pumpkin seed, maitake mushroom, lions mane mushroom, reishi mushroom, chaga mushroom, salt spice, pepper spice, nutritional yeast, lemon, extracts thereof, or combinations thereof.

In some embodiments, the dosage forms and foods further include an excipient. Suitable excipients include, but are not limited to, one or more of aloe, acacia gum, guar gum, citric acid, a natural preservative, extracts thereof, or combinations thereof.

In some embodiments, the dosage forms are in the form of a tablet, troche, lozenge, plurality of units, hard capsule, soft capsule, buccal tablet, buccal film, sublingual tablet, sublingual film, transdermal patch, topical gel, cream, oil or ointment, liquid or combinations thereof. In some embodiments, the dosage form is a solid oral dosage form.

The above-mentioned components may be present in the dosage form in a therapeutic amount. In some embodiments, the individual components are present in the dosage form amounts of about 1 mg to about 1000 mg, about 2 mg to about 500 mg, about 5 mg to about 250 mg, about 20 mg to about 100 mg, or any individual value or sub-range within these ranges.

Stress eating and stressed gut dosage forms as described herein can include a liquid phase and a solid phase. In some embodiments, the liquid phase includes one or more of the oil, syrup, sugar, butter, acid, extracts thereof, or combinations thereof. The liquid phase may be present in an amount of about 1 g to about 100 g, about 2 g to about 50 g, about 5 g to about 25 g, or any individual value or sub-range within these ranges.

In some embodiments, the solid phase includes one or more of the grain, pseudo grain, nut, seed, fruit, vegetable, mushroom, herb, spice, dried plant parts or matter, or combinations thereof. In various embodiments, the dosage form comprises at least one of the grain, pseudo grain, nut, seed, fruit, dried plant parts or matter thereof, or combinations thereof in the solid phase in an amount of about 1 g to about 75 g, about 2 g to about 50 g, about 5 g to about 25 g, or any individual value or sub-range within these ranges. In some embodiments, the dosage form includes at least one of the vegetable, spice, mushroom, dried plant parts or matter thereof, or combinations thereof in the solid phase in an amount of about 1 g to about 20 g, about 2 g to about 15 g, about 5 g to about 10 g, or any individual value or sub-range within these ranges.

In some embodiments, the liquid phase or the solid phase is encapsulated within a capsule shell. In various embodiments, the dosage form is a multi-part capsule comprising the liquid phase in a first part of the multi-part capsule and the solid phase in a second part of the multi-part capsule.

According to various embodiments, the dosage form contains a coating on a surface thereof, for example, on an external surface of the dosage form. In some embodiments, the coating comprises the at least one sensory disrupter, for example, one or more aromatic oil as described herein.

Embodiments of stress eating foods can include at least one sensory disrupter comprising an aromatic oil; and at least one functional food, comprising one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof. Stress eating foods can be in the form of at least one of a taffy, granulation, gummy, chip, ball, cookie, square, brownie, layered pyramid, meal replacement shake or bar, sachet, tea, extrusion, or combination thereof.

Embodiments of stressed gut multi-part capsule dosage forms, can include a liquid phase comprising at least one of beta caryophyllene, peppermint oil, flaxseed oil, organic grape seed oil, extracts thereof, or combinations thereof; and a solid phase comprising at least one of valerian root extract, licorice extract, mushrooms as described herein, ginger root extract, microcrystalline cellulose, magnesium stearate, extracts thereof, or combinations thereof. In some embodiments, the mushroom comprises a blend of Ganoderma lucidum, Trametes versicolor, Inonotus obliquus and Lentinula edodes.

### Kits

According to various embodiments, disclosed herein are kits comprising dosage forms and foods in accordance with embodiments herein. The kit can include a container and at least one dosage form removably positioned within the container. In accordance with various embodiments, the dosage form comprises at least one sensory disrupter, at least one stress-buster and at least one calming reliever as described herein. In embodiments, the dosage form comprises at least one central nervous system component, at least one immune system component and at least one endocrine system component as described herein.

According to embodiments, the container can be formed of a material that targets the sympathetic nervous system and the container itself can be a sensory disrupter. In embodiments the container can be formed of and/or contain at least one of a textured material, a smooth material, a soft material, a wood material, a bamboo material and a calming color that, upon touch, sight or both, provides a sensory disruption to a human. By focusing on the soothing container, the human can begin to reset and balance the stress response.

In embodiments, the kit further comprises an aromatic oil as described herein. The aromatic oil can be contained within a canister, sachet, film or any other suitable device that is positioned within, on and/or near the container. In embodiments, the aromatic oil can be coated on an inner surface of the container, coated on an outer surface of the container, coated on an outer surface of the dosage form, contained within the dosage form (e.g., in a capsule shell material), or a combination thereof.

Example embodiments of kit 310 are shown in FIG. 3B. As shown in FIG. 3B, each kit 310 contains at least one dosage form 300. In these embodiments, an aromatic oil (e.g., cinnamon oil and/or apple oil, etc.) is coated onto and/or formulated within the material of the capsule shell 302. The at least one dosage form 300 is as shown and described in FIG. 3A. Kit 310 further includes a container 312 having a lid 314 enabling the at least one dosage form 300 to be removably contained therein. The container can include at least one color 316, for example, that matches at least one color of the dosage form 300. The color can provide sensory disruption to a human viewing the kit 310.

According to embodiments, the kit further includes external packaging (not shown) such that the container 312 with the at least one dosage form 300, respectively, is removably positioned within the external packaging. Like the container 312, the external packaging can include at least one of a textured material, a smooth material, a soft material, a wood material, a bamboo material and a calming color that, upon touch, sight or both, provides a sensory disruption to a human. The external packaging may include an aromatic oil as described herein. The aromatic oil can be contained within a canister, sachet, film or any other suitable device that is positioned within and/or on the external packaging. In embodiments, the aromatic oil can be coated on an inner or outer (or both) surface of the external packaging, coated on an outer surface of the container.

According to embodiments, the kit includes instructions for using the kit to reduce at least one of stress and anxiety, for example, by supporting the body's response to stress and for reducing stress eating. The instructions can direct a human to combine sensory disruption together with administering the at least one dosage form to achieve a synergistic effect that assists the body's response to stress and to achieve allostasis. In embodiments, the kit comprises instructions to a human to open the container and hold the container under the person's nose. In embodiments the instructions can direct the human to exhale then breathe in through the nose drawing breath all the way into belly—optionally, to pause for about 1 second to about 10 seconds, and then optionally to exhale from the chest, for example, to imagine the belly button touching the spine. In embodiments, the instructions can direct the human to repeat the breathing and exhaling as desired and/or optionally for a particular number of times, for example, 5, 6, 7, 8, 9, 10, 15 or 20 times. In embodiments, the instructions can direct the human to insert one dosage form into his or her mouth and/or to taste the dosage form while swallowing.

### Methods of Preparation

Dosage forms according to various embodiments described herein can be prepared using any known method known to those of ordinary skill in the art. Such methods include, but are not limited to wet granulation, dry granulation, compression, extrusion, encapsulation, and any other suitable methods known to those of ordinary skill in the art to prepare dosage forms as described herein (i.e., including gummies, topical formulations, liquids, etc.). According to embodiments, one or more ingredients of the dosage forms can be prepared in a matrix in the form of particles, a powder, granules, beads, microspheres and combinations thereof. For example, in one embodiment, granules can be formed from at least one stress buster component and at least one calming reliever component. The granules of each component can be combined into a matrix. Additional ingredients can be added to the matrix as desired. In embodiments, the matrix can be compressed and shaped to form a tablet or a micro-tablet. In further embodiments, the matrix can be converted into an extrudable form and then extruded to form extrudates.

The granules can be formed by any procedure known to those of ordinary skill in the art. For example, the granules may be formed by wet granulation with water or dry granulation. In an embodiment of a wet granulation process, at least one stress buster component and at least one calming reliever component are weighed, sifted and mixed (excluding a lubricant), optionally with one or more excipient such as a bulking agent, filler, diluent and disintegrant, in a powder mixer. The ingredients can be mixed using a planetary bowl mixer, ribbon/trough mixer, rotating drum mixer or high-speed mixer until a uniform powder mix (i.e., a matrix) is achieved. The mixing efficiency can be enhanced by the use of powders that have similar average particle size, although this is often not the case in many mixing operations.

Suitable diluents include, but are not limited to lactose, microcrystalline cellulose, starch, powdered sucrose, mannitol, fructose, sorbitol, calcium phosphate and calcium sulphate. Diluents are usually selected based on the manufacturer's experience with the material, its relative cost, and its compatibility with the drug and other excipients. Suitable disintegrants include, but are not limited to croscarmellose, sodium starch glycolate, sodium carboxymethylcellulose, polyvinylpyrrolidone (PVP), crospovidone, cation exchange resins, corn and potato starches, alginic acid and other materials that counteract the effect of binders and the physical forces of compression used in forming the tablets.

The wet granulation method can further include preparing a damp mass. In embodiments, the amount of water added during the wet granulation can be about 1.5 to about 0.5 times, or about 1.7.5 to about 3.5 times the dry weight of the matrix. The binder solution can be mixed with the powder mixture to form an adhesive mass, which can be granulated. The amount of binding agent used as well as the quantity of fluid required to form a damp and coherent mass is known to those of ordinary skill in the art. The resulting binder-powder mixture should compact when squeezed in the hand. The use of insufficient binder tends to poor adhesion, capping and soft tablets. Excessive binder solution yields hard tablets with slow disintegrating properties. Suitable granulating agents are solutions of povidone, an aqueous preparation of cornstarch, molasses, methylcellulose, hydroxypropyl methylcellulose, carboxymethylcellulose, glucose solution and microcrystalline cellulose. Suitable dry binders or nonaqueous solution can be used for substances that are adversely affected by aqueous solution. Colorants or flavoring agents can he added to the binding agent to prepare a granulation with an added feature.

The dampened powder can be wet screened into pellets or granules. The wet massed powder blend can be screened using a 6- to 12-mesh screen to prepare wet granules. This may he done by hand or with suitable equipment that prepares the granules by extrusion through perforations in the apparatus. The granules formed are spread evenly on trays and dried in an oven.

The screened moist granules are then dried in an oven at a controlled temperature not exceeding 55° C. to a consistent weight or constant moisture content. The drying temperature and the duration of drying process depend on the nature of the active ingredient and the level of moisture required for the successful production of satisfactory tablets. Shelf or tray drier and fluidized-bed drier can be used for this purpose.

The dried granules are passed through a screen of smaller size than that used to prepare the moist granules. The size of the final granules is dependent on the size of the punches (and hence the final tablet size). Screens of 14- to 20-mesh size are generally used for this purpose.

After dry screening, the dried and screened granules can be separated into coarse and fine granules by shaking them on a 250-mesh sieve. An appropriate quantity of lubricant is passed through a 200—mesh sieve. This is mixed with Me fine granules before the coarse granules are incorporated. The quantity of lubricant used varies from one formulation scientist to another but usually ranges from about 0.1% to 5% of the weight of the granulation.

Suitable lubricants for use in wet granulation include, but are not limited to magnesium stearate, calcium stearate, stearic acid, wax, hydrogenated vegetable oil, talc, and starch.

A suitable dry granulation process includes weighing formulation ingredients in appropriate quantities. The excipients and active ingredient(s) should be in finch divided form, otherwise, particle size reduction should be carried out.

The weighed formulation ingredients are mixed in a powder mixer until a uniform powder mix is achieved. In embodiments, half the lubricant in the formula can be added at this stage to enhance powder flow during slugging and to prevent sticking of compressed powder on the die during precompression.

The mixed ingredients can then be compressed into flat large tablets or pellets, referred to as precompression (a.k.a, slugging) and the compacts made in the process typically have a sides of about 25 mm diameter by about 10-45 mm thick. Compression of mixed powders into slugs can be achieved by slugging technique or roller compaction. The pressure used to produce the slugs is usually less than that used in the final compression.

Following slugging, the slugs are broken into smaller pieces using a hammer mill or other conventional milling equipment. The milled slugs are screened to produce uniform granules. After screening, the remaining lubricant and other extragranular excipients such as disintegrant, glidant etc. as described herein, can he added to the granulation and mixed gently to achieve a uniform blend. The mixed granules can be compressed into tablets using either a single or rotary tablet press fitted with appropriate punches and dies. Similar to wet granulation, tablets manufactured by dry granulation method may be coated if the need arises. The disintegrant can be added to the weighed formulation at the beginning of the process (intragraular) or to the screened milled slugs (extragranular) and sometimes in both steps (intragranular extragranular). The formed granules can then be compressed into tablets or micro-tablets.

In certain embodiments, matrices can be formed using a melt-granulation or melt-extrusion technique. Generally, melt-granulation techniques involve inciting a normally solid binder material, e.g. a wax, and incorporating a powder therein. Other ingredients can be added, for example, release modifying agents, diluents, lubricants; binders; granulating aids; colorants, flavorants and glidants that are conventional in the pharmaceutical art in amounts up to about 50% by weight of the particulate if desired. The quantities of these additional materials will be sufficient to provide the desired effect to the desired formulation.

According to embodiments, methods of preparing dosage forms as described herein can include a number of pharmaceutically acceptable preparation techniques (e.g., granulation, extrusion, compression, coating, encapsulation, etc. as discussed above) known to those of ordinary skill in the art. In embodiments, methods of preparation include granulating one or more components (e.g., at least one stress buster and at least one calming reliever) to form a matrix. Compressing (and optionally shaping) the matrix to form one or more micro-tablets using, for example, a tablet press. For example, the matrix can be compressed into tablets in a single rotary tablet press with a plurality of punch pairs. The punches can have a diameter of about 1 mm to about 10 mm and a hard chromium coated surface and can form cylindrical micro-tablets as shown in FIGS. 3A and 3B. In embodiments, the micro-tablets are coated with a coating comprising one or more aromatic oil (e.g., a mixture of mint oil and citrus oil, a mixture of mint oil and lavender oil, etc.). In embodiments, the micro-tablets may then be encapsulated within a pharmaceutically acceptable capsule (e.g., a soft gelatin capsule) known to those of ordinary skill in the art.

Suitable ingredient forms for savory stress eating dosage forms according to various embodiments herein include, but are not limited to, raw ingredients, dehydrated ingredients, baked ingredients extruded components, fried components, poached components, steamed components and sous vide components. Dosage forms according to embodiments herein can be prepared with a combination of ingredients as described herein in amounts of about 1 mg to about 1000 mg, more for the use of the reported effective dose for supplements/herbal ingredients. Liquid phase ingredients can include, but are not limited to, oils, butters, syrups, acid each or all in combination in an amount of about 1 g to about 100 g. The dry phase ingredients can include, but are not limited to grains, nuts, seeds, fruit in an amount of about 1 g to about 75 g. Dry ingredients can further include, but are not limited to, vegetables, spices and/or mushrooms in an amount of about 1 g to about 20 g.

### Methods of Use

Further described herein are methods of using dosage forms, foods and kits according to embodiments herein. In embodiments, disclosed are methods of supporting a human body's response to stress and reducing stress eating that include administering to a human a dosage form, which may be a part of a kit, according to embodiments herein. In embodiments, the dosage form can be administered daily and/or by the human as needed when the human anticipates stress and/or stress eating. In embodiments, the dosage form can be administered daily in the afternoon and/or with a water and/or a meal. According to various embodiments, the human can be administered any safe and suitable amount known to those of ordinary skill in the art. In embodiments, the human can be administered up to 1 serving, up to 2 servings, up to 3 servings, up to 4 servings, up to 5 servings, up to 6 servings, up to 7 servings, up to 8 servings, up to 9 servings, or up to 10 servings daily of the dosage form where each serving is, for example, 1 or 2 capsules, 1 or 2 tablets, 1 or 2 shots, etc.

According to embodiments, further disclosed are methods of supporting a human's response to anxiety disorder, comprising: administering to a human a dosage form according to embodiments described herein. The dosage form can be administered by the human as needed when the human anticipates stress, anxiety or both. In embodiments, the dosage form is administered by the human in the afternoon or evening. According to various embodiments, the human can be administered any safe and suitable amount known to those of ordinary skill in the art. In embodiments, the human can be administered up to 1 serving, up to 2 servings, up to 3 servings, up to 4 servings, up to 5 servings, up to 6 servings, up to 7 servings, up to 8 servings, up to 9 servings, or up to 10 servings daily of the dosage form where each serving is, for example, 1 capsule, 1 tablet, 1 shot, etc.

According to further embodiments, disclosed herein are methods of supporting a human's response to stress, comprising inducing a sensory stimulation invoking a sensory nervous system response, the sensory stimulation causing an acute reduction in stress in a human. In embodiments, the method includes delivering ingredients to target key receptors or other targets within the central nervous system, the ingredients indirectly driving an autonomic nervous system response causing a longer term reduction in stress of the human, wherein the inducing sensory stimulation and delivering ingredients causes a dual stimulation. In further embodiments, method includes providing, based on the dual stimulation induced by the sensory stimulation and delivered ingredients, a synergistic relaxation response modulated by the autonomic nervous system. In embodiments, the sensory stimulation provides a sensory distraction.

According to embodiments, disclosed herein are methods of supporting a human's response to anxiety, comprising inducing a sensory stimulation invoking a sensory nervous system response, the sensory stimulation causing an acute reduction in anxiety in a human. In embodiments, the method includes delivering ingredients to target key receptors or other targets within the central nervous system, the ingredients indirectly driving an autonomic nervous system response causing a longer term reduction in anxiety of the human, wherein the inducing sensory stimulation and delivering ingredients causes a dual stimulation. In embodiments the method includes providing, based on the dual stimulation induced by the sensory stimulation and delivered ingredients, a synergistic relaxation response modulated by the autonomic nervous system.

According to embodiments, disclosed herein is a method of treating anxiety disorder or depression, comprising: administering to a patient in need thereof a dosage form according to embodiments herein. In embodiments, he dosage form can include at least one additional active agent, for example, an anti-anxiety drug or an anti-depressant drug.

In yet further embodiments, disclosed herein is a method of using a kit to combine sensory disruption together with administering at least one dosage form to achieve a synergistic effect that assists the body's response to stress and to achieve allostasis and reduced stress eating. In some embodiments, the method includes opening and holding a container housing the dosage forms under a person's nose. Exhaling then breathing in through the nose to draw breath into the belly. Optionally, the method includes pausing for about 1 second to about 10 seconds, and then optionally exhaling from the chest while imagining the belly button touching the spine. In embodiments, the method can include repeating the breathing and exhaling as desired and/or optionally for a particular number of times, for example, 5, 6, 7, 8, 9, 10, 15 or 20 times. In embodiments, the method includes orally administering the dosage form and tasting the dosage form while swallowing.

FIG. 4 is a flowchart showing the mediation of stress in the body 400 upon administration of a dosage form and/or kit according to embodiments herein. At block 402 a dosage form and/or kit is administered to a human in daily in the afternoon to reduce stress and stress eating. At block 406 the sympathetic adrenomedullary axis is triggered to release “stress mediators” including catecholamines (e.g., dopamine, epinephrine, norepinephrine) into the bloodstream. At block 408 the sympathetic adrenomedullary axis also is triggered to release cortisol into the bloodstream via the corticosteroid pathway.

At block 410 the “stress mediators” (e.g., the catecholamines) are released into the bloodstream to neuroreceptor sites (e.g., CB1, CB2, TRPV1, 5HT1). The components of the dosage form that are absorbed into the blood stream decrease the negative energy, which results in a decrease in stress.

At block 412 the endocannabinoid system becomes imbalanced. At block 414, “mood mediators” (e.g., GABA, glutamine, dopamine, endocannabinoids) are activated/inhibited to help rebalance the body's systems. At block 416 there is increased DMN activity (e.g., “I'm late,” “I can't deal with this,” “I need to relax,” “I will never finish this”). At block 418 there is a decrease in signals that affect mood; thus, breaking the negative feedback loop between emotions and physiology

At block 404, upon experiencing stress, the hypothalamus activates the SNS in response to a potential threat or negative situation (“fight or flight”).

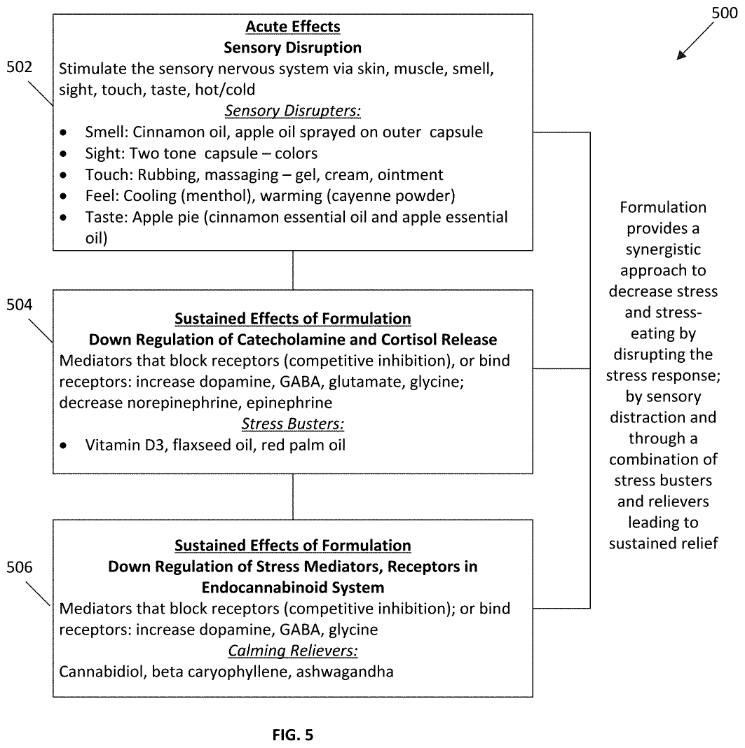

FIG. 5 is a flowchart showing the synergistic combination of effects 500 from dosage forms and kits according to embodiments herein. At block 502 the acute effects of the sensory disruption that stimulates the sensory nervous system via skin, muscle, smell, sight, touch, taste, hot/cold, etc. Sensory disrupters targeting smell include, but are not limited to, aromatic oils such as linalool, limonene and caryophyllene. Sensory disrupters targeting sight including, but are not limited to the look of the dosage form (e.g., mini-tablet within a capsule, colors, etc.). Sensory disrupters targeting touch including, but are not limited to rubbing, massaging—gel, cream, ointment—feel of the container, etc. Sensory disrupters targeting feel include, but are not limited to components that provide cooling and warming sensations. Sensory disrupters targeting taste include, but are not limited to cool (menthol-like), warm (caryophyllene), lemon (limonene), lavender (linalool) and combinations thereof.

At block 504, the sustained effects of dosage forms according to embodiments herein include the down regulation of catecholamines and cortisol release. Mediators that block receptors (competitive inhibition), or bind receptors can increase dopamine, GABA, glutamate, glycine and/or decrease norepinephrine, epinephrine. Stress busters suitable to provide sustained effects include, but are not limited to arginine, lysine, GABA, glycine, magnesium, citi-choline, inositol, apigenin, valerian and combinations thereof.

At block 506, the sustained effects of dosage forms according to embodiments herein include the down regulation of stress mediators and receptors in the endocannabinoid system. Mediators that block receptors (competitive inhibition) or bind receptors can increase dopamine, GABA and glycine. Calming relievers suitable to provide sustained effects include, but are not limited to cannabinoids (e.g., cannabidiol), caryophyllene, lemon balm, passion flower, ashwagandha and combinations thereof.

Formulations according to embodiments herein provide a synergistic approach to decrease stress by disrupting the stress response. By sensory distraction and through a combination of sensory disrupters, stress busters and calming relievers, the body can achieve sustained relief and ultimately allostasis.

In embodiments, methods of use can include administering dosage forms and kits according to embodiments herein daily for a period of 1 Day to 90 days, or 2 Days to 60 Days, or 5 Days to 45 Days, or 7 Days to 30 Days, or 7 Days, or 14 Days, or 28 Days and so on.

### EXAMPLES

### Example 1—Formulation for Stress-Eating

A stress-eating formulation was prepared as a dietary supplement to help the body's stress response and reduce stress-eating. As shown in Table 9, a liquid fill and a powder were prepared and encapsulated a pharmaceutically acceptable soft shell capsule (e.g., glycerin). The liquid fill ingredients were combined and dispensed into a first capsule shell part. The powder fill ingredients were granulated and combined to form a matrix. The powder ingredients were dispensed into a second capsule shell part.

The resulting dosage form is shown in FIG. 3A. The dosage form was formulated to provide a controlled release of the components within the micro-tablets.

TABLE 9
Ingredients for Stress-Eating Formulation
Active Ingredients in Stress-Eating Formulation

| | | | |
|---|---|---|---|
| | | | Mass Range |
| Ingredient | Description | Effects | (Exemplary Mass) |

Liquid Fill

| | | | |
|---|---|---|---|
| Beta | A | Through selective | about 1 mg to |
| Caryophyllene | phytochemical | binding to CB1 and | about 10 mg |
| | naturally found | CB2 receptors, Beta- | (5.55 mg) |
| | in many edible | Caryophyllene may | |
| | plants such as | exert anti- | |
| | basil, lemon | inflammatory and | |
| | balm, clove, | stress-balancing | |
| | and hemp. | activity. | |
| Vitamin D3 as | Vitamin D3 is a | Shown to support | about 100.00 IU |
| Cholecalciterol | fat-soluble | antioxidant and anti- | to about 20000.00 IU |
| from Lichen | nutrient. It is | inflammatory | (800.00 IU) |
| | one of 24 | activity, which is | |
| | micronutrients | known to preserve | |
| | critical for | the function of | |
| | human | immune cells against | |
| | survival. | homeostatic | |
| | | disturbances caused | |
| | | by oxidative stress | |
| | | and inflammation. | |
| Flaxseed Oil | Flaxseed oil is | Shown to have anti- | about 50 mg |
| (a.k.a. Linseed | a source of the | inflammatory | to about 600 mg |
| Oil) | heart healthy | activity and reduces | (303.00 mg) |
| | omega-3 fatty | glucocorticoid (e.g. | |
| | acid alpha- | cortisol) | |
| | linolenic acid. | concentrations under | |
| | | stress. | |
| Red Palm Oil | A source of | Replenishes | about 0.5 mg |
| | carotenoids and | antioxidants depleted | to about 10 mg |
| | vitamin E. | during stress. | (3.15 mg) |

Powder Fill

| | | | |
|---|---|---|---|
| CHROMAX ® | Believed to | Reduces cortisol. | about 0.1 mg |
| chromium as | improve | | to about 5.00 mg |
| chromium | nutrient | | (1.00 mg) |
| picolinate | metabolism and | | |
| | promote weight | | |
| | loss. | | |
| Sensoril ® | Native to India | Also classified as an | about 50.00 mg |
| (Ashwagandha) | and Middle | adaptogen, which is | to about 300.00 mg |
| | East, is useful | a substance that | (150.00 mg) |
| | in Ayurvedic | helps the body | |
| | medicine for its | withstand | |
| | calming, | environmental | |
| | antidepressant, | stressors and | |
| | sleep | thereby, promote | |
| | promoting, | resilience to | |
| | effects. | stress. The | |
| | | phytochemicals in | |
| | | ashwagandha | |
| | | counteract negative | |
| | | effects of stress by | |
| | | increasing levels of | |
| | | GABA signaling and | |
| | | preventing | |
| | | overstimulation of | |
| | | the brain, similar to | |
| | | the activity of L- | |
| | | Theanine. | |
| Apple Cider | Dried | Provides flavor; may | about 1.00 mg |
| Vinegar Powder | fermented | reduce | to about 100.00 mg |
| | apple. | inflammation, | (30.00 mg) |
| | | facilitate weight loss | |
| | | and enhance mood. | |
| Cayenne Powder | Ground | Provides flavor; may | about 1.00 mg |
| Extract | cayenne | increase metabolism. | to about 50.00 mg |
| | pepper. | | (10.00 mg) |
| L-Theanine | L-Theanine is | L-Theanine has | about 1.00 mg |
| | one of the | various effects on | to about 100.00 mg |
| | predominant | the brain, such as | (56.12 mg) |
| | amino acids | neuroprotective | |
| | ordinarily | activity, mood- | |
| | found in green | enhancement, and | |
| | tea and is | relaxation. Studies | |
| | useful as a | suggest it impacts | |
| | relaxing agent. | the formation of the | |
| | | inhibitory | |
| | | neurotransmitter | |
| | | GABA in the central | |
| | | nervous system. | |
| | | GABA blocks | |
| | | excessive | |
| | | stimulation of | |
| | | neuronal cells and | |
| | | may, therefore, have | |
| | | a key role in | |
| | | producing a | |
| | | relaxation | |
| | | effect. Testing shows | |
| | | L-Theanine | |
| | | increases brain alpha | |
| | | wave activity; a | |
| | | well-recognized | |
| | | index for relaxation. | |
| Magnesium | Mg₂. | A flow agent | about 1.00 mg |
| stearate | | additive for solid | to about 50.00 mg |
| | | dosage forms. | (10.00 mg) |
| Microcrystalline | Refined wood | An bulking agent | about 1.00 mg |
| cellulose (MCC) | pulp. | additive for solid | to about 100.00 mg |
| | | dosage forms. | (38.33 mg) |

| | | | |
|---|---|---|---|
| | | | Mass Range |
| Ingredient | Description | Liquid or Solid | (Exemplary Mass) |

Inactive Ingredients

| | | | |
|---|---|---|---|
| Hydroxypropyl | Capsule | Solid | |
| Methylcellulose | | | |
| (HPMC) | | | |
| Flaxseed Oil | Oil derived | Carrier Liquid | about 1.00 mg |
| | from flaxseed | | to about 100.00 mg |
| Microcrystalline | | Blending agent | about 1.00 mg |
| Cellulose (MCC) | | | to about 100.00 mg |
| Magnesium | Saturated | Flow Agent | about 1.00 mg |
| Stearate | fat called | | to about 100.00 mg |
| | stearic acid and | | |
| | the mineral | | |
| | magnesium | | |
| Red Palm Oil | Oil extracted | Colorant | about 1.00 mg |
| | from palm trees | | to about 10.00 mg |
| Natural Apple Pie | Natural oils | Aroma/Taste | about 0.01 mg |
| Flavor (apple oil | | | to about 0.10 mg |
| and cinnamon oil) | | | |

Membrane Information and Filling Weights

| | |
|---|---|
| Membranes | 8.5, 10.5, 11.5 |
| Liquid/Oil | 315.00 mg |

### Example 2—Stress Eating Formulation with at Least One Additional Active (Prophetic)

An oral dosage form is prepared as a capsule including the powder fill ingredients from Example 1 combined with the anti-anxiety drug buspirone. The powder fill ingredients and buspirone are formed into granules to provide a matrix, which is received in a first capsule shell part of a pharmaceutically acceptable softgel capsule. The liquid fill ingredients were encapsulated in a second capsule shell part.

### Example 3—Topical Formulation (Prophetic)

A topical formulation is prepared that produces a warming sensation or a cooling sensation upon application. The powder fill ingredients from Table 1 are granulated and combined to form a matrix. The matrix is combined with a lotion and the liquid fill ingredients. In the warming formulation, the lotion is combined with, for example, cinnamon essential oil. In the cooling formulation, the lotion is combined with, for example, menthol.

### Example 4—Topical Patch Formulation (Prophetic)

A topical patch is prepared according to any suitable method known to those of ordinary skill in the art. The topical patch contains the ingredients from Table 1. The ingredients are further combined with cinnamon essential oil for a warming patch or menthol for a cooling patch. The topical patch initiates either/or a warming or a cooling sensation upon application. The topical patch includes additional ingredients that optimize penetration into the skin resulting in mid-long term relief.

### Example 5—Oral Formulation (Prophetic)

An oral dosage form can include a formulation prepared using spray-drying or similar technology to form granules for a sachet packet as the dosage form. The finished dosage form is ingested directly via the oral cavity. The sachet could incorporate various ingredients that would invoke one or more of the following sensations: a cooling or heating sensation, bitter, sour or sweet taste upon ingestion via mouth. Another option would employ ingredients to invoke a mild “popping” tingling sensation (similar to “Pop Rocks”).

### Example 6—Functional Food (Prophetic)

A savory combination of food ingredients is selected from one or more of the ingredients disclosed above, to form a dosage of food in the form of a single dose (e.g., as a “good for you gummy”). The resulting functional food delivers a nutritionally dense, great tasting and satisfying experience. Examples are provided in the tables below.

TABLE 10
“Nature's Medicine Cabinet ®” - Featured Ingredients

[symbol]

[symbol]

[symbol]

[symbol]

[symbol]

[symbol]

indicates data missing or illegible when filed

TABLE 9
“Nature's Pantry ™” - Featured Ingredients

[symbol]

[symbol]

[symbol]

[symbol]

[symbol]

[symbol]

[symbol]

[symbol]

[symbol]

[symbol]

[symbol]

indicates data missing or illegible when filed

### Example 7: Functional Food—ChipAway Tortilla Style Chips

A plant based gluten free protein chip for stress eaters. ChipAway protein chips are prepared via dehydration (no bake) and includes for example: Ashwaghanda, L-Theanine, Relora® (Magnolia officinalis and Phellodendron amurense)

and plant-based ingredients, sprouted sunflower seeds and chia seeds.

### Example 8: Functional Food—Supplement Formulation

A functional food supplement formulation was prepared to treat stress eating. The supplement formulation included “sensory disrupters”, “stress-busters” and “calming relievers” as well as “stress-fighting foods” also referred to as functional foods as shown in Table 10. The supplement may be formulated in amounts of 1 mg-1000 mg, more specifically, use of the reported effective dose for supplements/herbal ingredients. Wet ingredients included oils, butters, syrups, acid in amounts of 1 g-100 g. Dry ingredients included grains, nuts, seeds, fruit in amounts of about 1 g-75 g. Dry ingredients also included vegetables, spices and mushrooms in amounts of 1 g-20 g.

TABLE 10
Functional Food Supplement Formulation
“Sensory disrupters”

Appearance Food Format

Visual

| tactile | Visual, Flavor, | | Flavor Profile | |
|---|---|---|---|---|
| Delivery | Sound, Smell | sound | Taste | Aroma |
| Formats | Tactile/Touch | tactile | Taste | Aroma |
| food formats | Food Format | Texture | Profiles | Aromatics/oils |
| “Tootsie roll” | Granola snack | chewy | Sweet | Angelica |
| “Gummy” | Veggie Chip | crisp | Salt | Australian Ericifolia |
| Balls | cookie | soft | Savory | Basil |
| 1 × 1 bites squares | brownie | creamy | Nutty | Bergamot |
| layered pyramid | meal | powder | Sour | Black Pepper |
| | replacement | | | |
| Sachets | kale chip | | Sweet-Salt | Cardamom |
| Tea | carrot chips | | Sweet- | Carrot Seed |
| | | | Savory | |
| Extrusion | Tortilla Chip | | Sweet-nutty | Cedarwood |
| (cheetos) | | | | |
| Dehydrated | Potato Chip | | Sweet-sour | German Chamomile |
| Baked | Sweet Potato | | Salt - umami | Cinnamon Bark |
| | chip | | | |
| raw | Plantain chip | | Salt-Savory | Clary Sage |
| | cassava chip | | Salt - nutty - | Clove |
| | | | sweet | |
| Supplement | Extrusion | | Sour - umami | Eucalyptus Blue |
| format | (Think | | | |
| | Cheetos) | | | |
| soft capsule | | | Sour - Salt | Fennel |
| hard capsule | | | | Frankincense |
| multi- | | | | Geranium |
| compartment | | | | |
| capsulet | | | | |
| chewables | | | | Ginger |
| soft melt | | | | Goldenrod |
| tablets | | | | Grapefruit |
| powder/sachet | | | | Hyssop |
| gummy | | | | Idaho Blue Spruce |
| | | | | Idaho Grand Fir |
| | | | | Jade Lemon |
| | | | | Jasmine |
| | | | | Juniper |
| | | | | Lavender |
| | | | | Lemon |
| | | | | Lemon Myrtle |
| | | | | Lemon Verbena |
| | | | | Lemongrass |
| | | | | Lime |
| | | | | Manuka |
| | | | | Marjoram |
| | | | | Mastrante |
| | | | | Melissa |
| | | | | Myrtle |
| | | | | Neroli |
| | | | | Northern Black Spruce |
| | | | | Nutmeg |
| | | | | Orange |
| | | | | Oregano |
| | | | | Patchouli |
| | | | | Pine |
| | | | | Roman Chamomile |
| | | | | Rose |
| | | | | Rosemary |
| | | | | Rue |
| | | | | Sandalwood(Hawaiian). |
| | | | | Sandalwood (Hydrosol) |
| | | | | Sacred Frankincense |
| | | | | Spearmint |
| | | | | Sage |
| | | | | Thyme |
| | | | | Vanilla |
| | | | | Wintergreen |

Functional Food - Stress Fighting Foods
Liquid ingredients

| Unrefined, refined, | | raw, processed, |
|---|---|---|
| virgin | raw, processed, dried | dried |
| Oils | Syrups/sugars | “Butters” |
| Plum | maple | Acorn |
| sunflower | walnut | Almond |
| safflower | date | Apple |
| olive | honey | Brazil Nut |
| sesame | manuka honey | cashew |
| coconut | raw honey | Chestnut |
| | sugar - all forms | Coconut |
| Dates | molasses | hazelnut |
| Date Syrup | agave | macadamia |
| Raw honey | sucralose | peanut |
| | | Pecan |
| | | Pine Nut |
| | | Pistachio |
| | | pumpkin |
| | | sunflower |
| | | Walnut |
| | | Mixed-Nut |
| | | mixed seed |

Functional Food - Stress Fighting Foods
Fresh and Dried Ingredients

| | | |
|---|---|---|
| | whole, | |
| cooked, raw, soaked, | roasted, | fresh, dried |

| | | | |
|---|---|---|---|
| sprouted, baked | powder, oil | spread, extract | fresh, dried, extract |

| Grains/pseudo grains | Nuts/Seeds | Fruit | Vegetable | Mushroom |
|---|---|---|---|---|
| Oats | peanut | dates | kale | cordyceps |
| hemp | cashew | goji | collard | maitake |
| buckwheat | almond | raisins | Swiss | lions mane |
| | | | chard | |
| Durum Wheat | pistachio | plums | carrot | shiitake |
| sorghum | macadamia | cherry | beet | oyster |
| Amaranth | brazil | cranberry | broccoli | cinnamon |
| | | | | caps |
| Barley | chestnut | dried blueberry | cauliflower | reishi |
| Bulgur | cacao | pomegranate | cassava | portabella |
| Corn Starch | Ginkgo nuts | fig | zucchini | turkey tail |
| Farro | Pili nuts | banana | seaweed | Royal Sun |
| | | | | Blazei |
| Spelt | Candle nuts | strawberry | sweet | chaga |
| | | | potato | |
| Freekeh | Black | blueberry | potato | mesima |
| | walnuts | | | |
| Khorasan Wheat | Palm nuts | raspberry | | |
| Quinoa | Tiger nuts | blackberry | | |
| Kañiwa | hazelnut | plantain | | |
| Rice | Filberts | tomato | | |
| Rye | chia | grape | | |
| Sorghum | flax | orange | | |
| Teff | hemp | apple | | |
| Triticale | pumpkin | peach | | |
| Wheat | sunflower | watermelon | | |
| Wild Rice | poppy | cantaloupe | | |
| Wheat berries | sesame | honey dew | | |
| Hominy | watermelon | pineapple | | |
| Spelt | pomegranate | jackfruit | | |
| Rye | quinoa | | | |
| Brown Rice | soy | | | |
| Farro/Emmer | | | | |
| Barley | | | | |
| Bran | | | | |
| Couscous | | | | |
| Farina | | | | |
| Kamut | | | | |
| Orzo | | | | |
| Semolina | | | | |
| Graham | | | | |
| Cornflour | | | | |
| Cornmeal | | | | |
| Rice | | | | |
| Montina flour | | | | |
| Sorghum | | | | |
| Malts- made from wheat | | | | |
| Graham - made from | | | | |
| wheat | | | | |
| Couscous - made from | | | | |
| wheat seminola | | | | |
| Polenta - made from com | | | | |
| Muesli - made from oats | | | | |
| or wheat | | | | |
| Seitan - made from | | | | |
| wheat | | | | |
| Panko - made from | | | | |
| wheat | | | | |
| Millet (finger, foxtail, | | | | |
| Japanese, Kodo, Pearl, | | | | |
| Adlay, & Proso) | | | | |
| Barley Malt | | | | |
| Wheat Germ | | | | |
| Enriched Bleach Flour | | | | |
| Malted Barley Flour | | | | |
| Granary Flour | | | | |
| Groats (wheat, barley, | | | | |
| buckwheat) | | | | |
| Pastas | | | | |
| Matzo | | | | |
| Seitan | | | | |
| Tabbouleh | | | | |
| Udon (wheat noodles) | | | | |
| Corn Starch | | | | |
| Wheat nuts | | | | |

Functional Food - Stress Fighting Foods

| | | Acid | |
|---|---|---|---|
| Herbs/Spices | | fresh, | Excipients |
| fresh, dried, powder, | | concentrated, | binders, |
| extract | | powder | gums |
| Herbs | Spices | Acid | Misc. |
| Fennel | nutmeg | Lemon | aloe |
| Peppermint | cinnamon | vinegar | acacia gum |
| Leaf (oil) | | | |
| Anise | vanilla | apple cider | guar gum |
| | | vinegar | |
| Carraway | salt | white wine | citric acid |
| Ginger | pepper | red wine | natural |
| | | | preservatives |
| Milk | basil | lime | |
| Thistle | | | |
| Boswellia | oregano | Tomato | |
| Holy basil | thyme | tomato paste | |
| Sage | rosemary | Worcestershire | |
| Chromium | sage | | |
| Picolinate | | | |
| (Chromax) | | | |
| Fennel | garlic | | |
| Peppermint | nutritional | | |
| Leaf (oil) | Yeast | | |

### Example 9: Functional Food—Naturally Sweet Granular Formulation

A naturally sweet functional food granular formulation (e.g., granola-like) was prepared to treat stress eating. The naturally sweet granular formulation included “sensory disrupters”, “stress-busters” and “calming relievers” and “stress-fighting foods” as shown in Table 11. The bolded and underlined components were specifically used to formulate this granular formulation although the other listed ingredients may be used additionally or alternatively as suitable to achieve a desired taste, texture or therapeutic effect. The granular format may be formulated in amounts of 1 mg-1000 mg, more specifically, use of the reported effective dose for supplements/herbal ingredients. Wet ingredients included oils, butters, syrups and acids in amounts of 1 g-100 g. Dry ingredients included grains, nuts, seeds and fruit in amounts of about 1 g-75 g. Dry ingredients also included spices and mushrooms in amounts of 1 g-20 g. The dry ingredients were prepared through a dehydration process.

TABLE 11
Naturally Sweet Granular Functional Food Formulation
“Sensory disrupters”

| Appearance | | | | |
|---|---|---|---|---|
| Food Format | | | | |
| | Visual, | | | |
| Visual | Flavor, | | | |
| tactile | Sound, Smell | | Flavor Profile | |
| Delivery | Tactile/Touch | sound | Taste | Aroma |
| Formats | Food | tactile | Taste | Aroma |
| food formats | Format | Texture | Profiles | Aromatics/oils |
| “Tootsie roll” | Granola | chewy | Sweet | Angelica |
| | snack | | | |
| “Gummy” | Veggie Chip | crisp | Salt | Ericifolia |
| Balls | cookie | soft | Savory | Basil |
| 1 × 1 bites | brownie | creamy | Nutty | Bergamot |
| squares | | | | |
| layered | meal | powder | Sour | Black Pepper |
| pyramid | replacement | | | |
| Sachets | kale chip | | Sweet-Salt | Cardamom |
| Tea | carrot chips | | Sweet-Savory | Carrot Seed |
| Extrusion | Tortilla Chip | | Sweet-nutty | Cedarwood |
| (cheetos) | | | | |
| Dehydrated | Potato Chip | | Sweet-sour | Chamomile |
| Baked | Sweet Potato | | Salt - umami | Cinnamon Bark |
| | chip | | | |
| raw | Plantain chip | | Salt-Savory | Clary Sage |
| Supplement | cassava chip | | Salt - nutty - | Clove |
| format | | | sweet | |
| | Extrusion | | Sour - umami | Eucalyptus Blue |
| | (Think | | | |
| | Cheetos) | | | |
| soft capsule | | | Sour - Salt | Fennel |
| hard capsule | | | | Frankincense |
| multi- | | | | Geranium |
| compartment | | | | |
| capsulet | | | | |
| chewables | | | | Ginger |
| soft melt | | | | Goldenrod |
| tablets | | | | Grapefruit |
| powder/sachet | | | | Hyssop |
| gummy | | | | Idaho Blue Spruce |
| | | | | Idaho Grand Fir |
| | | | | Jade Lemon |
| | | | | Jasmine |
| | | | | Juniper |
| | | | | Lavender |
| | | | | Lemon |
| | | | | Lemon Myrtle |
| | | | | Lemon Verbena |
| | | | | Lemongrass |
| | | | | Lime |
| | | | | Manuka |
| | | | | Marjoram |
| | | | | Mastrante |
| | | | | Melissa |
| | | | | Myrtle |
| | | | | Neroli |
| | | | | Northern Black |
| | | | | Spruce |
| | | | | Nutmeg |
| | | | | Orange |
| | | | | Oregano |
| | | | | Patchouli |
| | | | | Pine |
| | | | | Roman Chamomile |
| | | | | Rose |
| | | | | Rosemary |
| | | | | Rue |
| | | | | Sandalwood |
| | | | | (Hawaiian) |
| | | | | Sandalwood |
| | | | | (Hydrosol) |
| | | | | Sacred Frankincense |
| | | | | Spearmint |
| | | | | Sage |
| | | | | Thyme |
| | | | | Vanilla |
| | | | | Wintergreen |

“Stress busters”
Botanicals, herbs,
vitamins minerals
3 systems coverage:
Nervous, Endo,
Immune
Ashwagandha
valerian root
L-theanine
(Theanine)
Magnesium
Licorice
Black Penner
(beta caryophyllene)
Passion Flower
Saffron

Functional Food - “Stress Fighting Foods”
Liquid ingredients

| Unrefined, refined, | | raw, processed, |
|---|---|---|
| virgin | raw, processed, dried | dried |
| Oils | Syrups/sugars | “Butters” |
| Plum | maple syrup | Acorn |
| sunflower | walnut syrup | Almond |
| safflower | date sugar | Apple |
| olive | honey | Brazil Nut |
| sesame | manuka honey | cashew |
| coconut | raw honey | Chestnut |
| Dates | sugar - all forms | Coconut |
| Date Syrup | Molasses | hazelnut |
| | Agave syrup | macadamia |
| | Sucralose | peanut |
| | Other Sweeteners | Pecan |
| | | Pine Nut |
| | | Pistachio |
| | | pumpkin |
| | | sunflower |
| | | Walnut |
| | | Mixed-Nut |
| | | Mixed Seed |

Functional Food - “Stress Fighting Foods”
Fresh and Dried Ingredients

| | whole, | fresh, dried | | |
|---|---|---|---|---|
| cooked, raw, soaked, | roasted, | spread, | fresh, dried, extract | |
| sprouted, baked | powder, oil | extract | fruiting body/mycellium | |
| grains/pseudo grains | Nuts/Seeds | fruit | vegetable | mushroom |
| Oats | peanut | dates | kale | cordyceps |
| hemp | cashew | goji | collard | maitake |
| buckwheat | almond | raisins | Swiss | lions mane |
| | | | chard | |
| Durum Wheat | pistachio | plums | carrot | shiitake |
| sorghum | macadamia | cherry | beet | oyster |
| Amaranth | brazil | cranberry | broccoli | cinnamon caps |
| Barley | chestnut | blueberry | cauliflower | reishi |
| Bulgur | cacao | pomegranate | cassava | portabella |
| Corn Starch | Ginkgo nuts | fig | zucchini | turkey tail |
| Farro | Pili nuts | banana | seaweed | Royal Sun |
| | | | | Blazei |
| Spelt | Candle nuts | strawberry | sweet | chaga |
| | | | potato | |
| Freekeh | Black | blueberry | potato | mesima |
| | walnuts | | | |
| Khorasan Wheat | Palm nuts | raspberry | | |
| Quinoa | Tiger nuts | blackberry | | |
| Kañiwa | hazelnut | plantain | | |
| Rice | Filberts | tomato | | |
| Rye | chia | grape | | |
| Sorghum | flax | orange | | |
| Teff | hemp | apple | | |
| Triticale | pumpkin | peach | | |
| Wheat | sunflower | watermelon | | |
| Wild Rice | poppy | cantaloupe | | |
| Wheat berries | sesame | honey dew | | |
| Hominy | watermelon | pineapple | | |
| Spelt | pomegranate | jackfruit | | |
| Rye | quinoa | | | |
| Brown Rice | soy | | | |
| Farro/Emmer | | | | |
| Barley | | | | |
| Bran | | | | |
| Couscous | | | | |
| Farina | | | | |
| Kamut | | | | |
| Orzo | | | | |
| Semolina | | | | |
| Graham | | | | |
| Cornflour | | | | |
| Cornmeal | | | | |
| Rice | | | | |
| Montina flour | | | | |
| Sorghum | | | | |
| Malts- made from wheat | | | | |
| Graham - made from | | | | |
| wheat | | | | |
| Couscous - made from | | | | |
| wheat seminola | | | | |
| Polenta - made from com | | | | |
| Muesli - made from oats | | | | |
| or wheat | | | | |
| Seitan - made from | | | | |
| wheat | | | | |
| Panko - made from | | | | |
| wheat | | | | |
| Millet (finger, foxtail, | | | | |
| Japanese, Kodo, Pearl, | | | | |
| Adlay, & Proso) | | | | |
| Barley Malt | | | | |
| Wheat Germ | | | | |
| Enriched Bleach Flour | | | | |
| Malted Barley Flour | | | | |
| Granary Flour | | | | |
| Groats (wheat, barley, | | | | |
| buckwheat) | | | | |
| Pastas | | | | |
| Matzo | | | | |
| Seitan | | | | |
| Tabbouleh | | | | |
| Udon (wheat noodles) | | | | |
| Corn Starch | | | | |
| Wheat nuts | | | | |

Functional Food - “Stress Fighting Foods”

| | | Acid | |
|---|---|---|---|
| Herbs/Spices | | fresh, | |
| fresh, dried, powder, | | concentrated, | Excipients |
| extract | | powder | binders, gums |
| Herbs | Spices | Acid | Miscellaneous |
| Fennel | nutmeg | Lemon | aloe |
| Peppermint | cinnamon | vinegar | acacia gum |
| Leaf (oil) | | | |
| Anise | vanilla | apple cider | guar gum |
| | | vinegar | |
| Carraway | salt | white wine | citric acid |
| Ginger | pepper | red wine | natural |
| | | | preservatives |
| Milk Thistle | basil | lime | |
| Boswellia | oregano | Tomato | |
| Holy basil | thyme | tomato paste | |
| Sage | rosemary | Worcestershire | |
| Chromium | sage | | |
| Picolinate | | | |
| Fennel | garlic | | |
| Peppermint | nutritional | | |
| Leaf (oil) | Yeast | | |

### Example 10: Functional Food—Naturally Savory Granular Formulation (Chip-Based Format)

A naturally savory functional food chip formulation was prepared to treat stress eating. The naturally savory chip formulation included “sensory disrupters”, “stress-busters” and “calming relievers” and “stress-fighting foods” as shown in Table 12. The bolded and underlined components were specifically used to formulate this chip although the other listed ingredients may be used additionally or alternatively as suitable to achieve a desired taste, texture or therapeutic effect. The chip may be formulated in amounts of 1 mg-1000 mg, more specifically, use of the reported effective dose for supplements/herbal ingredients. Wet ingredients included oils, butters, syrups and acids in amounts of 1 g-100 g. Dry ingredients included grains, nuts and seeds in amounts of about 1 g-75 g. Dry ingredients also included spices and mushrooms in amounts of 1 g-20 g. The dry ingredients were prepared through a dehydration process.

TABLE 12
Naturally Savory Chip Based Formulation
“Sensory Disruptors”

Appearance
Food Format

Visual

| tactile | Visual, Flavor, | | Flavor Profile | |
|---|---|---|---|---|
| Delivery | Sound, Smell | sound | Taste | Aroma |
| Formats | Tactile/Touch | tactile | Taste | Aroma |
| food formats | Food Format | Texture | Profiles | Aromatics/oils |
| “Tootsie roll” | Granola snack | chewy | Sweet | Angelica |
| “Gummy” | Veggie Chip | crisp | Salt | Australian |
| | | | | Ericifolia |
| Balls | cookie | soft | Savory | Basil |
| 1 × 1 bites squares | brownie | creamy | Nutty | Bergamot |
| layered pyramid | meal | powder | Sour | Black Pepper |
| | replacement | | | |
| Sachets | kale chip | | Sweet-Salt | Cardamom |
| Tea | carrot chips | | Sweet- | Carrot Seed |
| | | | Savory | |
| Extrusion | Tortilla Chip | | Sweet-nutty | Cedarwood |
| (Cheetos ®) | | | | |
| Dehydrated | Potato Chip | | Sweet-sour | German Chamomile |
| Baked | Sweet Potato | | Salt - umami | Cinnamon Bark |
| | chip | | | |
| raw | Plantain chip | | Salt-Savory | Clary Sage |
| | cassava chip | | Salt - nutty - | Clove |
| | | | sweet | |
| Supplement | Extrusion | | Sour - umami | Eucalyptus Blue |
| format | (Think | | | |
| | Cheetos) | | | |
| soft capsule | | | Sour - Salt | Fennel |
| hard capsule | | | | Frankincense |
| multi- | | | | Geranium |
| compartment | | | | |
| capsulet | | | | |
| chewables | | | | Ginger |
| soft melt | | | | Goldenrod |
| tablets | | | | Grapefruit |
| powder/sachet | | | | Hyssop |
| gummy | | | | Idaho Blue Spruce |
| | | | | Idaho Grand Fir |
| | | | | Jade Lemon |
| | | | | Jasmine |
| | | | | Juniper |
| | | | | Lavender |
| | | | | Lemon |
| | | | | Lemon Myrtle |
| | | | | Lemon Verbena |
| | | | | Lemongrass |
| | | | | Lime |
| | | | | Manuka |
| | | | | Marjoram |
| | | | | Mastrante |
| | | | | Melissa |
| | | | | Myrtle |
| | | | | Neroli |
| | | | | Northern Black |
| | | | | Spruce |
| | | | | Nutmeg |
| | | | | Orange |
| | | | | Oregano |
| | | | | Patchouli |
| | | | | Pine |
| | | | | Roman Chamomile |
| | | | | Rose |
| | | | | Rosemary |
| | | | | Rue |
| | | | | Sandalwood |
| | | | | (Hawaiian) |
| | | | | Sandalwood |
| | | | | (Hydrosol) |
| | | | | Sacred |
| | | | | Frankincense |
| | | | | Spearmint |
| | | | | Sage |
| | | | | Thyme |
| | | | | Vanilla |
| | | | | Wintergreen |

“Stress busters”
“Calming Relievers” as
described herein
Botanicals, herbs,
vitamins minerals
As described in Example
8 herein

Functional Food - Stress Fighting Foods
Liquid ingredients

| Unrefined, refined, | | raw, processed, |
|---|---|---|
| virgin | raw, processed, dried | dried |
| Oils | Syrups/sugars | “Butters” |
| Plum | maple | Acorn |
| sunflower | walnut | Almond |
| safflower | date syrup | Apple |
| olive | honey | Brazil Nut |
| sesame | manuka honey | cashew |
| coconut | raw honey | Chestnut |
| | sugar - all forms | Coconut |
| Dates | molasses | hazelnut |
| Date Syrup | agave | macadamia |
| Raw honey | sucralose | peanut |
| | | Pecan |
| | | Pine Nut |
| | | Pistachio |
| | | pumpkin |
| | | sunflower |
| | | Walnut |
| | | Mixed-Nut |
| | | mixed seed |

Functional Food - Stress Fighting Foods
Fresh and Dried Ingredients

| | whole, | | | |
|---|---|---|---|---|
| cooked, raw, soaked, | roasted, | fresh, dried | | |
| sprouted, baked | powder, oil | spread, extract | fresh, dried, extract | |
| Grains/pseudo grains | Nuts/Seeds | Fruit | Vegetable | Mushroom |
| Oats | peanut | dates | kale | cordyceps |
| hemp | cashew | goji | collard | maitake |
| buckwheat | almond | raisins | Swiss | lions mane |
| | | | chard | |
| Durum Wheat | pistachio | plums | carrot | shiitake |
| sorghum | macadamia | cherry | beet | oyster |
| Amaranth | brazil | cranberry | broccoli | cinnamon |
| | | | | caps |
| Barley | chestnut | dried blueberry | cauliflower | reishi |
| Bulgur | cacao | pomegranate | cassava | portabella |
| Corn Starch | Ginkgo nuts | fig | zucchini | turkey tail |
| Farro | Pili nuts | banana | seaweed | Royal Sun |
| | | | | Blazei |
| Spelt | Candle nuts | strawberry | sweet | chaga |
| | | | potato | |
| Freekeh | Black | blueberry | potato | mesima |
| | walnuts | | | |
| Khorasan Wheat | Palm nuts | raspberry | | |
| Quinoa | Tiger nuts | blackberry | | |
| Kañiwa | hazelnut | plantain | | |
| Rice | Filberts | tomato | | |
| Rye | chia | grape | | |
| Sorghum | flax | orange | | |
| Teff | hemp | apple | | |
| Triticale | pumpkin | peach | | |
| Wheat | sunflower | watermelon | | |
| Wild Rice | poppy | cantelope | | |
| Wheat berries | sesame | honey dew | | |
| Hominy | watermelon | pineapple | | |
| Spelt | pomegranate | jackfruit | | |
| Rye | quinoa | | | |
| Brown Rice | soy | | | |
| Farro/Emmer | | | | |
| Barley | | | | |
| Bran | | | | |
| Couscous | | | | |
| Farina | | | | |
| Kamut | | | | |
| Orzo | | | | |
| Semolina | | | | |
| Graham | | | | |
| Cornflour | | | | |
| Cornmeal | | | | |
| Rice | | | | |
| Montina flour | | | | |
| Sorghum | | | | |
| Malts- made from wheat | | | | |
| Graham - made from | | | | |
| wheat | | | | |
| Couscous - made from | | | | |
| wheat seminola | | | | |
| Polenta - made from corn | | | | |
| Muesli - made from oats | | | | |
| or wheat | | | | |
| Seitan - made from | | | | |
| wheat | | | | |
| Panko - made from | | | | |
| wheat | | | | |
| Millet (finger, foxtail, | | | | |
| Japanese, Kodo, Pearl, | | | | |
| Adlay, & Proso) | | | | |
| Barley Malt | | | | |
| Wheat Germ | | | | |
| Enriched Bleach Flour | | | | |
| Malted Barley Flour | | | | |
| Granary Flour | | | | |
| Groats (wheat, barley, | | | | |
| buckwheat) | | | | |
| Pastas | | | | |
| Matzo | | | | |
| Seitan | | | | |
| Tabbouleh | | | | |
| Udon (wheat noodles) | | | | |
| Corn Starch | | | | |
| Wheat nuts | | | | |

Functional Food - Stress Fighting Foods

| | | Acid | |
|---|---|---|---|
| | | fresh, | Excipients |
| Herbs/Spices | | concentrated, | binders, |
| fresh, dried, powder, extract | | powder | gums |
| Herbs | Spices | Acid | Misc. |
| Fennel | nutmeg | Lemon | aloe |
| Peppermint | cinnamon | vinegar | acacia gum |
| Leaf (oil) | | | |
| Anise | vanilla | apple cider | guar gum |
| | | vinegar | |
| Carraway | salt | white wine | citric acid |
| Ginger | pepper | red wine | natural |
| | | | preservatives |
| Milk Thistle | basil | lime | |
| Boswellia | oregano | Tomato | |
| Holy basil | thyme | tomato paste | |
| Sage | rosemary | Worcestershire | |
| Chromium | sage | | |
| Picolinate | | | |
| Fennel | garlic | | |
| Peppermint | nutritional | | |
| Leaf (oil) | yeast | | |

### Example 11: Functional Food—Stressed Gut Formulation

A functional food stressed gut formulation was prepared to treat a “stressed gut” as a result of stress eating or general GI discomfort. The ingredients are shown in Table 13.

TABLE 13
Functional Food Stressed Gut Formulation

| Capsules per serving: | 1 |
|---|---|
| Capsule and Membrane Material: | Vcap Plus 00 Capsugel |
| Liquid Fill: | Label Claim: |
| Beta-Caryophyllene Natural | 10.00 mg |
| Peppermint oil, Mentha arvensis | 20.00 mg |
| Flaxseed Oil, Linum usitatissium | 31.50 mg |
| Organic Grape seed oil, Vitis vinifera | 251.00 mg |
| Powder Fill: | Label Claim: |
| Valerian Root extract, | 300.00 mg plant equivalent |
| Valeriana Officinalis | (30.00 mg extract) |
| GutGard ® Liquorice extract, | 150.00 mg |
| Glycyrrhiza glabra | |
| OrMiū-Gut Health ™ Organic functional | 75.00 mg |
| mushroom blend (Ganoderma lucidum, | (15.00 mg Beta-Glucan) |
| Trametes versicolor, | |
| Inonotus obliquus, Lentinula edodes) | |
| Ginger root extract, Zingiber officinale | 500 mg plant equivalent |
| | (50.00 mg extract) |
| Microcrystalline cellulose (MCC) | 10.00 mg |
| Magnesium Stearate | 6.00 mg |

The use of headings and sections in the application is not meant to limit the disclosure; each section can apply to any aspect, embodiment, or feature of the disclosure. Only those claims which use the words “means for” are intended to be interpreted under 35 USC § 112, sixth paragraph. Absent a recital of “means for” in the claims, such claims should not be construed under 35 USC § 112. Limitations from the specification are not intended to be read into any claims, unless such limitations are expressly included in the claims.

When values or ranges of values are given, each value and the end points of a given range and the values there between may be increased or decreased by 20%, while still staying within the teachings of the disclosure, unless some different range is specifically mentioned.

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

It is to be understood that the figures and descriptions of the disclosure have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the disclosure, a single component may be replaced by multiple components, and multiple components may be replaced by a single component, to provide an element or structure or to perform a given function or functions. Except where such substitution would not be operative to practice certain embodiments of the disclosure, such substitution is considered within the scope of the disclosure.

The examples presented herein are intended to illustrate potential and specific implementations of the disclosure. It can be appreciated that the examples are intended primarily for purposes of illustration of the disclosure for those skilled in the art. There may be variations to these diagrams or the operations described herein without departing from the spirit of the disclosure. For instance, in certain cases, method steps or operations may be performed or executed in differing order, or operations may be added, deleted or modified.

I/We claim:

1. A stress eating dosage form, comprising:
at least one sensory disrupter comprising an aromatic oil; and
at least one functional food, comprising one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof.

2. The stress eating dosage form of claim 1, wherein the aromatic oil comprises one or more of angelica, Australian ericifolia, basil, bergamot, black pepper, cardamom, carrot seed, cedarwood, German chamomile, cinnamon bark, clary sage, clove, eucalyptus blue, fennel, frankincense, geranium, ginger, goldenrod, grapefruit, hyssop, Idaho blue spruce, Idaho grand fir, jade lemon, jasmine, juniper, lavender, lemon, lemon myrtle, lemon verbena, lemongrass, lime, manuka, marjoram, mastrante, melissa, myrtle, meroli, northern black spruce, nutmeg, orange, oregano, patchouli, pine, Roman chamomile, rose, rosemary, rue, Hawaiian sandalwood, sandalwood (hydrosol), sacred frankincense, spearmint, sage, thyme, vanilla, wintergreen, dried plant portions or matter thereof, extracts thereof, or combinations thereof.

3. The stress eating dosage form of claim 1, wherein the vegetable comprises one or more of kale, collard, Swiss chard, carrot, beet, broccoli, cauliflower, cassava, zucchini, seaweed, sweet potato, potato, dried plant parts or matter thereof, extracts thereof, or combinations thereof and/or
wherein the herb comprises one or more of hops, gotu kola, Ginkgo biloba, citicoline, yerba mate, sage, chamomile, valerian root, skullcap, lavender, licorice, saffron, fennel, peppermint leaf, anise, caraway, ginger, milk thistle, boswellia, holy basil, dried plant parts and matter thereof, extracts thereof, or combinations thereof and/or
wherein the spice comprises one or more of a powder or granulation of nutmeg, cinnamon, vanilla, salt, pepper, basil, oregano, thyme, rosemary, sage, garlic, nutritional yeast, or combinations thereof; and/or
wherein the acid comprises one or more of lemon, lemon juice, vinegar, apple cider vinegar, wine, white wine, red wine, lime, lime juice, tomato, tomato paste, Worcestershire, extracts thereof, dried forms thereof, or combinations thereof.

4. The stress eating dosage form of claim 1, wherein the fruit comprises one or more of dates, goji berry, raisins, plums, cherry, cranberry, blueberry, pomegranate, fig, banana, strawberry, blueberry, raspberry, blackberry, plantain, tomato, grape, orange, apple, peach, watermelon, cantaloupe, honey dew, pineapple, jackfruit, dried plant portions or matter thereof, extracts thereof, or combinations thereof and/or
wherein the vegetable comprises one or more of kale, collard, Swiss chard, carrot, beet, broccoli, cauliflower, cassava, zucchini, seaweed, sweet potato, potato, dried plant portions or matter thereof, extracts thereof, or combinations thereof and/or
wherein the nut comprises one or more of almond, chestnut, cacao nut, ginkgo nut, pili nut, candle nut, palm nut, tiger nut, filbert nut, soy nut, coconut, walnut, black walnut, peanut, Brazil nut, cashew nut, hazelnut, macadamia nut, pine nut, pecan nut or pistachio; and/or
wherein the seed comprises one or more of chia seed, flax seed, hemp seed, pumpkin seed, sunflower seed, poppy seed, sesame seed, watermelon seed, pomegranate seed or quinoa seed.

5. The stress eating dosage form of claim 1, wherein the plant-based oil comprises one or more of plum oil, sunflower, safflower, olive oil, avocado oil, date oil, date syrup, extracts thereof or combinations thereof and/or
wherein the nut oil comprises one or more of almond oil, chestnut oil, cacao nut oil, ginkgo nut oil, pili nut oil, candle nut oil, palm nut oil, tiger nut oil, filbert nut oil, soy nut oil, coconut oil, walnut oil, black walnut oil, peanut oil, Brazil nut oil, cashew nut oil, hazelnut oil, macadamia nut oil, pine nut oil, pecan nut oil, pistachio oil, extracts thereof or combinations thereof and/or
wherein the seed oil comprises one or more of sesame seed oil, sunflower seed oil, cottonseed oil, safflower seed oil, canola seed oil, grape seed oil, extracts thereof or combinations thereof.

6. The stress eating dosage form of claim 1, the syrup comprises one or more of maple, walnut, date, honey, manuka honey, raw honey, a sugar, molasses, agave, sucralose, extracts thereof or combinations thereof and/or
wherein the butter comprises one or more of acorn, almond, apple, Brazil nut, cashew, chestnut, coconut, hazelnut, macadamia, peanut, pecan, pine nut, pistachio, pumpkin, sunflower, walnut, mixed-nut, mixed seed or combinations thereof, and/or
wherein the grain or pseudo grain comprises one or more of oat, hemp, wheat, buckwheat, durum wheat, sorghum, amaranth, barley, bulgur, corn starch, farro, spelt, freekeh, khorasan wheat, quinoa, kañiwa, rice, rye, sorghum, teff, triticale, wild rice, wheat berries, hominy, spelt, rye, brown rice, farro/emmer, barley, bran, couscous, farina, kamut, orzo, semolina, graham, corn flour, cornmeal, rice, montina flour, sorghum, or combinations thereof; and/or
wherein the pseudo grain comprises one or more of malts made from wheat, graham made from wheat, couscous made from wheat seminola, polenta made from corn, muesli made from oats or wheat, seitan made from wheat, panko made from wheat, millet (finger, foxtail, Japanese, Kodo, Pearl, Adlay, and/or Proso), barley malt, wheat germ, enriched bleach flour, malted barley flour, granary flour, groats (wheat, barley, buckwheat), pasta, matzo, seitan, tabbouleh, udon (wheat noodles), corn starch, wheat nuts; and/or
wherein the mushroom comprises one or more of cordyceps, maitake, lions mane, shiitake, oyster, cinnamon caps, reishi, portabello, turkey tail, Royal Sun Blazei, chaga, mesima, dried plant parts or matter thereof, extracts thereof or combinations thereof.

7. The stress eating dosage form of claim 1, further comprising at least one stress-buster, comprising one or more of a botanical, an herb, a vitamin, a mineral, extracts thereof, dried plant parts or matter thereof, or combinations thereof.

8. The stress eating dosage form of claim 7, wherein the botanical comprises one or more of aromatic terpenes, lactium, pregnenolone, bacopa, Griffonia simplicifolia, kanna, reishi, lion's mane, turkey tail, Korean Ginseng, eleuthero, suma, American ginseng, rhodiola (Artic Root), rehmannia, roloftin, relora, schisandra, California poppy, dried plant parts or matter thereof, extracts thereof, or combinations thereof; and/or
wherein the herb comprises one or more of hops, gotu kola, Ginkgo biloba, citicoline, yerba mate, sage, chamomile, valerian root, skullcap, lavender, licorice, saffron, fennel, peppermint leaf, anise, caraway, ginger, milk thistle, boswellia, holy basil, dried plant parts and matter thereof, extracts thereof, or combinations thereof, and/or
wherein the vitamin comprises one or more of Vitamin B1 (Thiamine), Vitamin B3 (Niacin), Vitamin B5 (Pantothenic Acid), Vitamin B6 (Pyridoxine), Vitamin B9 (Folic Acid), Vitamin B12 (Cyanocobalamin), Vitamin H (Biotin), Vitamin C (Ascorbic Acid), Vitamin D3, Inositol (myo-inositol), gammaaminobutyric acid (GABA), L-phenylalanine, L-tyrosine, 5-hydroxytryptophan (5-HTP), L-theanine (Theanine), pure L-Theanine (Green Tea Extract), L-Glutamine (Glutamine), L-Glycine (Glycine), L-Taurine (Taurine), L-Threonine (Threonine), dimethylaminoethanol (DMAE), phosphatidylserine, melatonin, garum armoricum, chromium picolinate, proloftin, salts thereof, or combinations thereof and/or
wherein the mineral comprises one or more of calcium, magnesium, salts thereof, or combinations thereof.

9. The stress eating dosage form of claim 1, further comprising at least one calming reliever, wherein the at least one calming reliever comprises one or more of hemp, a cannabinoid, cannabidiol, cannabinol, cannabigerol, tetrahydrocannabinol, dronabinol, caryophyllene, lemon balm, passionflower, ashwagandha and combinations thereof.

10. The stress eating dosage form of claim 1, wherein the aromatic oil comprises one or more of cinnamon bark oil or nutmeg oil; and
wherein functional food comprises one or more of plum oil, date oil, date syrup, Manuka honey, raw honey, apple butter, mixed-nut butter, mixed seed butter, oats, hemp, buckwheat, cashew nut, almond, pistachio, black walnut, chia seed, flax seed, hemp seed, dates, goji berry, raisin, cranberry, fig, jackfruit, maitake mushroom, lions mane mushroom, reishi mushroom, turkey tail mushroom, chaga mushroom, nutmeg spice, cinnamon spice, vanilla extract, vanilla bean, salt, extracts thereof, or combinations thereof.

11. The stress eating dosage form of claim 1, wherein the aromatic oil comprises one or more of sage oil or thyme oil; and
wherein functional food comprises one or more of safflower oil, olive oil, date syrup, cashew butter, hemp, spelt, freekeh, quinoa, chia seed, flax seed, pumpkin seed, maitake mushroom, lions mane mushroom, reishi mushroom, chaga mushroom, salt spice, pepper spice, nutritional yeast, lemon, extracts thereof, or combinations thereof.

12. The stress eating dosage form of claim 1, further comprising an excipient, wherein the excipient comprises one or more of aloe, acacia gum, guar gum, citric acid, a natural preservative, extracts thereof, or combinations thereof.

13. The stress eating dosage form of claim 1, wherein the dosage form is in the form of a tablet, troche, lozenge, plurality of units, hard capsule, soft capsule, buccal tablet, buccal film, sublingual tablet, sublingual film, transdermal patch, topical gel, cream, oil or ointment, liquid or combinations thereof,
optionally wherein the dosage form is a solid oral dosage form.

14. The stress eating dosage form of claim 1, comprising a liquid phase and a solid phase,
optionally, wherein the liquid phase comprises one or more of the oil, syrup, sugar, butter, acid, extracts thereof, or combinations thereof,
optionally, wherein the dosage form comprises the liquid phase in an amount of about 1 g-100 g.

15. The stress eating dosage form of claim 14, wherein the solid phase comprises one or more of the grain, pseudo grain, nut, seed, fruit, vegetable, mushroom, herb, spice, dried plant parts or matter, or combinations thereof,
optionally, wherein the dosage form comprises at least one of the grain, pseudo grain, nut, seed, fruit, dried plant parts or matter thereof, or combinations thereof in the solid phase in an amount of about 1 g to about 75 g,
optionally, wherein the dosage form comprises at least one of the vegetable, spice, mushroom, dried plant parts or matter thereof, or combinations thereof in the solid phase in an amount of about 1 g to about 20 g.

16. The stress eating dosage form of 1, comprising a liquid phase and a solid phase, wherein at least one of the liquid phase or the solid phase is encapsulated within a capsule shell.

17. The stress eating dosage form of claim 1, wherein the dosage form is a multi-part capsule comprising the liquid phase in a first part of the multi-part capsule and the solid phase in a second part of the multi-part capsule.

18. The stress eating dosage form of claim 17, further comprising a coating on a surface of the dosage form, wherein the coating comprises the at least one sensory disrupter.

19. A stress eating food, comprising:
at least one sensory disrupter comprising an aromatic oil; and
at least one functional food, comprising one or more of a fruit, vegetable, plant-based oil, nut, nut oil, seed, seed oil, syrup, sugar, butter, grain, pseudo grain, mushroom, herb, spice, acid, plant portions or matter thereof, extracts thereof, or combinations thereof,
wherein the stress eating food is in the form of at least one of a taffy, granulation, gummy, chip, ball, cookie, square, brownie, layered pyramid, meal replacement shake or bar, sachet, tea, extrusion, or combination thereof.

20. A stressed gut multi-part capsule dosage form, comprising:
a liquid phase comprising at least one of beta caryophyllene, peppermint oil, flaxseed oil, organic grape seed oil, extracts thereof, or combinations thereof; and
a solid phase comprising at least one of valerian root extract, licorice extract, mushroom, ginger root extract, microcrystalline cellulose, magnesium stearate, extracts thereof, or combinations thereof,
optionally, wherein the mushroom comprises a blend of Ganoderma lucidum, Trametes versicolor, Inonotus obliquus and Lentinula edodes.
